(19) United States
(12) Patent Application Publication
(10) Pub. No.: US 2007/0146231 A1
(43) Pub. Date: Jun. 28, 2007

(54) Display drive device, display signal transfer device, and display device

(76) Inventors: Yoshihisa Hamahashi, Osaka (JP); Yasuyuki Doi, Kyoto (JP); Tooru Suyama, Kyoto (JP); Makoto Hattori, Kyoto (JP); Tomoya Ishikawa, Osaka (JP)

Correspondence Address: MCDERMOTT WILL & EMERY LLP, 600 13TH STREET, N.W., WASHINGTON, DC, 20005-3096, US

(21) Appl. No.: 11/641,875

(22) Filed: Dec. 20, 2006

(30) Foreign Application Priority Data
Dec. 22, 2005 (JP) 2005-369655

(51) Int. Cl. G09G 5/00

(52) U.S. Cl. 345/1.2

(57) ABSTRACT

A receiving circuit receives one or plural first signals involving display from the outside through an input unit. A first transmitting circuit transmits one or plural second signals relevant to the first signal from the first output unit. A second transmitting circuit transmits the second signal from the second output unit.

### BACKGROUND OF THE INVENTION

1. Field of the Invention

The present invention relates to a display drive device, and display signal transfer device in which the plurality of display drive devices is connected in cascade to transmit a signal sequentially and more particularly, to a display device that displays data by applying an electric signal corresponding to display data to a display element with each pixel consisting of a plurality of pixels.

2. Description of the Related Art

Recently, in a display device such as a flat panel display comprising a plurality of pixels like a liquid crystal display device, development have been advanced to commercialize a product with a larger screen, higher precision, thinner and lighter in weight and lower cost. According to a general liquid crystal display device, display drive devices are mounted on an upper part of a panel glass in the horizontal direction. It is done based on a purpose that a voltage signal corresponding to display data is applied to a liquid crystal element that constitutes a plurality of pixels. In order to control the display drive device by a control device of the liquid crystal display device, the wirings of the signal transfer path of a control signal and a power source transfer path for power source supply are formed on a PCB (Printed Circuit Board) or a FPC (Flexible Printed Circuit) and then, the PCB or FPC is further connected to the panel glass by a FPC.

In this circumstance, as shown in FIG. 21, in order to reduce a mounting area or simplify a mounting operation, there is provided a display signal transfer device in which a plurality of display drive devices are connected in cascade and a signal such as display data is sequentially transferred via the inside of the display drive devices. According to the display signal transfer device, a transfer path for transferring the signal such as the display data is formed on a panel glass between the respective display drive devices. Thus, it is not necessary to form the transfer path for the display data in the PCB and the FPC, so that a substrate area for the PCB and the FPC can be reduced and connection mounting between the panel glass and the PCB to the FPC can be simplified, thereby efficiency of connection for mounting is improved. As a result, the weight and cost can be reduced.

Although data is transferred in one direction of the cascade-connection in the display signal transfer devices in normal use, it is desired that data is transferred in both directions instead of one direction in the cascade-connection in the display drive device and the display signal transfer device comprising the plurality of the display drive devices in view of convenience for being applied to another panel device.

FIGS. 17 to 20 show the constitutions of a conventional display drive device and a display signal transfer device. According to the constitution in which the display signal transfer device comprises a first (first-stage) display drive device to (M)th (last-stage) display drive device, a cascade-connected k-th (k and M are positive integers satisfying 1≦k<M) display drive device D901 (k) has the following constitution.

In the k-th display drive device D901, an first output/input unit Z91 comprises input/output terminals Z91 (k, 1) to Z91 (k, n) (n is a positive integer) and a second input/output unit Z92 (k) comprises input/output terminals Z92 (k, 1) to Z92 (k, n). The display drive device D901 (k) comprises transmitting circuits TX911 (k, 1) to TX911 (k, n) and receiving circuits RX911 (k, 1) to RX911 (k, n) corresponding to the input/output terminals Z91 (k, 1) to Z91 (k, n) interiorly. The display drive device D901 (k) comprises transmitting circuits TX912 (k, 1) to TX912 (k, n) and receiving circuits RX912 (k, 1) to RX912 (k, n) corresponding to the input/output terminals Z92 (k, 1) to Z92 (k, n) interiorly. Also, the display drive device 901 (k) comprises a control circuit C920 (k) used for controlling the display drive device D901 (k), processing the transfer signal and latching process interiorly.

The transmitting circuits TX911 (k, 1) to TX911 (k, n) and the receiving circuits RX911 (k, 1) to RX911 (k, n) are connected by the internal wirings of the display drive device D901 (k), respectively. Similarly, the transmitting circuits TX912 (k, 1) to TX912 (k, n) and the receiving circuits RX912 (k, 1) to RX912 (k, n), and the control circuit C920 (k) are connected by the internal wirings of the display drive device D901 (k), respectively.

The transmitting circuits TX911 (k, 1) to TX911 (k, n) and the receiving circuits RX911 (k, 1) to RX911 (k, n) are physically arranged close to each other, respectively. Also, the transmitting circuits TX912 (k, 1) to TX912 (k, n) and the receiving circuits RX912 (k, 1) to RX912 (k, n) are physically arranged close to each other, respectively.

The (k+1)th display drive device D901 (k+1) has the same constitution as that of the k-th display drive device D901 (k). Transmitting circuits TX911 (k+1, 1) to TX911 (k+1,

n) correspond to the transmitting circuits TX911 (k, 1) to TX911 (k, n) of the k-th display drive device D901 (k), respectively. Similarly, transmitting circuits TX912 (k+1, 1) to TX912 (k+1, n), receiving circuits RX911 (k+1, 1) to RX911 (k+1, n) and RX912 (k+1, 1) to RX912 (k+1, n), a control circuit C920 (k+1), input/output terminals Z91 (k+1, 1) to Z91 (k+1, n) and Z92 (k+1, 1) to Z92 (k+1, n) in the (k+1)th display drive device D901 (k+1) correspond to the transmitting circuits TX912 (k, 1) to TX912 (k, n), the receiving circuits RX911 (k, 1) to RX911 (k, n) and RX912 (k, 1) to RX912 (k, n), the control circuit C920 (k), the input/output terminals Z91 (k, 1) to Z91 (k, n) and Z92 (k, 1) to Z92 (k, n) in the k-th display drive device D901 (k), respectively.

The input/output terminals Z91 (k, 1) to Z91 (k, n) of the first input/output unit Z91 (k) of the k-th display drive device D901 (k) are connected to the second input/output unit of the (k−1) th display drive device, the input/output terminals Z92 (k, 1) to Z92 (k, n) of the first input/output unit Z92 (k) of the k-th display drive device D901 (k) are connected to the input/output terminals Z91 (k+1, 1) to Z91 (k+1, n) of the first input/output unit Z91 (k+1) of the (k+1)th display drive device D901 (k+1), respectively. Similarly, the input/output terminals Z92 (k+1, 1) to Z92 (k+1, n) of the second input/output unit Z92 (k+1) of the (k+1)th display drive device D901 (k+1) are connected to the first input/output unit of the (k+2)th display drive device. Similarly, the display drive devices are connected until the last-stage (M)th display drive device.

FIGS. 38 to 40 show the constitution examples of the general receiving circuit. FIG. 38 shows a comparator type of receiving circuit that sends a single-end signal Vout to the control circuit in response to the inputted differential signals Vin+ and Vin−. FIGS. 39 and 40 show a buffer type of receiving circuit that sends the single-end signal Vout to the control circuit in response to the inputted the single-end signal Vin. Each receiving circuit has a function to control the receiving operation and reception stopping operation based on the enable signal and the output of the receiving circuit becomes a high impedance signal or a fixed signal.

FIGS. 41 to 43 show the constitution examples of the general transmitting circuit. FIG. 41 shows a transmitting circuit that outputs differential signals Vout+ and Vout− in response to an inputted single-end signal Vin+ and its reversed-phase signal Vin−. FIGS. 42 and 43 show a transmitting circuit that outputs a single-end Vout in response to an inputted single-end signal Vin. Each transmitting circuit has a function to perform the transmitting operation and the transmission stopping operation based on the enable signal. The output of the transmitting circuit becomes a high-impedance signal or a fixed signal.

As shown in FIG. 21, the conventional display device comprises a display drive device such as a source driver or a gate driver and a display signal transfer device cascade-connected to them. The gate driver for driving the gate side of the TFT and the source driver for driving the source side (drain) of the TFT constituted on a glass in a liquid crystal panel are mounted on a liquid crystal panel, and a PCB mounting a control device (controller LSI and the like) for the liquid crystal panel and a power source device is connected to the liquid crystal panel glass by an FPC. A control signal, a clock signal and a power source are supplied to the gate driver through the FPC close to the control device and the power source device. In addition, a control signal, a clock signal, a display data and a reference voltage for driving a liquid crystal element are supplied to the source driver through the FPC close to the control device and the power source device. The power source is supplied from the PCB to the source driver through the FPC close to the source driver.

<Conventional Operation>

Next, a description will be given to the operations of a display drive devices D901 (k−1), D901 (k), and D901 (k+1) in a display signal transfer device S900-A shown in FIG. 17. When transfer signals N1 to Nn are inputted from an external device (a display device controller LSI, for example) to the input/output terminals Z91 (1, 1) to Z91 (1, n) of the first input/output unit Z91 (1) of the first display drive device D901 (1), the transfer signals N1 to Nn transmitted from the (k−1) th display drive device D901 (k−1) are received by the receiving circuits RX911 (k, 1) to RX911 (k, n) in the display drive device D901 (k). The control circuit C920 (k) generates transfer signals N1 to Nn to be processed in the (k+1) th and following display drive devices D901 after treating control of the display drive device D901 (k), latching process by a clock and the signal processing of N1 to Nn for transferring to the next-stage (k+1) display drive device D901 (k+1). In addition, the control circuit C920 (k) transmits the transfer signals N1 to Nn through the transmitting circuits TX912 (k, 1) to TX912 (k, n).

The transmitted transfer signals N1 to Nn are received by the receiving circuits RX911 (k+1, 1) to RX911 (k+1, n) of the (k+1) th display drive device D901 (k+1). A control circuit C920 (k+1) executes control of the received transfer signals N1 to Nn, control of the display drive device D901 (k+1), latch processing of the display data, and signal processing of the transfer signals N1 to Nn (to transfer them to the next-stage display drive device D901 (k+2)). Furthermore, the control circuit C901 (k+2) transmits the transfer signals N1 to Nn to be processed in the (k+2)th display drive device D902 (k+2) and following display drive devices (not shown) through the transmitting circuits TX912 (k+1, 1) to TX912 (k+1, n). The same operations are sequentially performed in on and after (k+2) th display drive devices.

Next, the operations of a display signal transfer device S900-B, and the display drive devices D901 (k) and D901 (k+1) shown in FIG. 18 will be descried. FIG. 18 shows the direction opposite to the direction of the transfer signals in FIG. 17. Transfer signals N1 to Nn are inputted from an external device (display device controller LSI, for example) to the input/output terminals Z92 (M, 1) to Z92 (M, n) of the second input/output unit Z92 (M) of the (M) th display drive device D901 (M) over the second-stage. The receiving circuits RX912 (k+1, 1) to RX912 (k+1, n) of the (k+1) th display drive device D901 (k+1) receive the transfer signals N1 to Nn outputted from the (k+2)th display drive device cascade-connected.

A control circuit C920 (k+1) generates transfer signals N1 to Nn to be processed in the k-th and following display drive devices D901 by performing control of the display drive device D901 (k+1), latch processing of the display data and the signal processing for transferring them to the next-stage (k) display drive device D901 (k). The generated transfer signals N1 to Nn are transmitted from the transmitting circuits TX911 (k+1, 1) to TX911 (k+1, n).

The transmitted transfer signals N1 to Nn are received by the receiving circuits RX912 (k, 1) to RX912 (k, n) in the k-th display drive device D901 (k). The control circuit C 920 (k) generates transfer signals N1 to Nn to be processed in the (k−1) th and following display drive devices D901 by performing control of the display drive device D901 (k), latch processing of the display data and the signals processing for transferring them to the next-stage the display drive device D901 (k−1). The generated transfer signals N1 to Nn are transmitted from the transmitting circuits TX911 (k, 1) to TX 911 (k, n). The same operations are performed in the (k−1)th and following display drive devices.

In the display device comprising the display signal transfer device shown in FIG. 21, the electric signal generated from the display data sequentially treated with latching by the clock in each display drive device is applied to the liquid crystal element of the display device shown in FIG. 22 as a source driver output voltage so as to display data. At this time, the voltage value of the electric signal applied to the liquid crystal element is determined by the reference voltage value of the source driver of the display drive device, and the reference voltage corresponding to 64 gradations is outputted in a case where the source driver is compliant with 6 bits and the reference voltage corresponding to 256 gradations is outputted in a case where the source driver is compliant with 8 bits.

According to the conventional display drive device and display signal transfer device, in order to correspond to the bidirectional signal transfer operations, a couple of receiving circuit and transmitting circuit is provided in one input/output terminal for the transfer signal, depending on the number of input/output terminals. In normal use, the signal is transferred in one direction of the cascade-connected direction. Therefore, according to the constitution shown in FIG. 17, the transfer direction is determined by the signal that selects the signal transfer direction in the cascade-connection. At this time, in the k-th display drive device D901 (k), the transmitting circuits TX911 (k, 1) to TX911 (k, n) and the receiving circuits RX912 (k, 1) to RX912 (k, n) are not involved in the signal transfer operation. Therefore, at this moment, the transmitting circuits TX911 (k, 1) to TX911 (k, n) and the receiving circuits RX912 (k, 1) to RX912 (k, n) are not needed in the signal transfer system. Thus, the receiving circuit, and the transmitting circuit that become unnecessary depending on the signal transfer direction in the cascade-connection increases the cost (mainly caused by securing the circuit area) and the power consumption while the signals are transferred.

### SUMMARY OF THE INVENTION

It is a main object of the present invention to reduce power consumption and cost more than the conventional device.

In order to solve the above problem, according to one aspect of the present invention, a display drive device comprises an input unit to which one or more first signals regarding display are inputted from the outside, a receiving circuit for receiving the first signal from the input unit, first and second output units outputting one or more second signals regarding the first signal to the outside, a first transmitting circuit transmitting the second signal from the first output unit, and a second transmitting circuit transmitting the second signal from the second output unit.

According to this display drive device, since the number of receiving circuits in the display drive device can be reduced and the setting area of the receiving circuit can be reduced, the cost is lowered.

Preferably, the display drive device further comprises a control circuit, in which the control circuit outputs the second signal from the first output unit, and stops the transmitting operation of the second transmitting circuit and then puts the output state of the second transmitting circuit into the fixed signal output state or a high-impedance output state, or the control circuit outputs the second signal from the second output unit, and stops the transmitting operation of the first transmitting circuit and then puts the output state of the first transmitting circuit into the fixed signal output state or the high-impedance output state.

According to the above constitution, the power consumption can be reduced through controlling the operation of the transmitting circuit that becomes unnecessary depending on the external output.

According to another aspect of the present invention, a display drive device comprises an input unit to which one or more first signals regarding display are inputted from outside, a receiving circuit for receiving the first signal from the input unit, first and second output units for outputting one or more second signals regarding the first signal in parallel to each other, a transmitting circuit for transmitting the second signal from the first output unit or the second output unit, and an output selection switchover circuit for connecting the first output unit or the second output unit to the transmitting circuit.

According to this display drive device, the first signal inputted from the outside of the display drive device to the input unit is received with the receiving circuit. The second signal regarding the first signal is outputted from the first output unit or the second output unit to the outside by the transmitting circuit. Here, the output selection switchover circuit selects the output target of the second signal from the first output unit or the second output unit.

According to this constitution, since the transmitting circuit corresponding to the two output units is commonly used, the setting area of the transmitting circuit can be reduced and the cost can be also lowered.

Furthermore, in this display drive device, it is preferable that the input unit and the first and second output units are provided at the periphery of the display drive device, the input unit is provided between the first output unit and the second output unit, the physical distance between the first output unit and the second output unit is larger than the physical distance between the input unit and the first output unit and the physical distance between the input unit and the second output unit.

Thus, since the two output units are symmetrically provided with respect to the one input unit, the connection between the adjacent display drive devices can be done in the same layer, so that the cost can be lowered.

In addition, it is preferable that the input unit comprises a plurality of input terminals, the first output unit comprises a plurality of first output terminals, the second output unit comprises a plurality of second output terminals, wherein the input terminals and the first output terminals and the second output terminals are arranged along the periphery of the display drive device respectively, and the arrangement order of the input terminals and the arrangement order of the first and second output terminals are opposed to each other.

According to this constitution, when the plurality of display drive devices corresponding to the plurality of transfer signal wirings are cascade-connected, the transfer signal wirings can be connected without intersecting with each other. In addition, the transfer signal wirings can be connected in the same single layer among the plurality of display drive devices. Thus, the cost can be lowered.

Furthermore, it is preferable that a first power source unit for supplying a power source to the display drive device is provided between the input unit and the first output unit, and a second power source unit for supplying a power source to the display drive device is provided between the input unit and the second output unit.

According to this constitution, since there are two power source units, when the plurality of display drive devices are cascade-connected, the power source unit can be connected to the display drive device without intersecting with the connection wiring of the transfer signal. In addition, since the cascade-connected wiring among the display drive devices and the power source supplying wiring can be formed in the single layer, the wiring structure can be simplified so as to be able to lower the cost.

According to yet another aspect of the present invention, a display drive device comprises a first input/output unit through which one or more first signals regarding display are inputted or outputted between the outside, a second input/output unit through which the first signal is inputted or outputted between the outside, a receiving circuit for receiving the first signal from the first input/output unit or the second input/output unit, a first transmitting circuit for outputting one or more second signals regarding the first signal from the first input/output unit, a second transmitting circuit for outputting the second signal from the second input/output unit, a reception selection switchover circuit for connecting the first input/output unit or the second input/output unit to the receiving circuit, a first transmission selection switchover circuit for connecting the first input/output unit to the first transmitting circuit in conjunction with the connection operation of the reception selection switchover circuit, and a second transmission selection switchover circuit for connecting the second input/output unit to the second transmitting circuit in conjunction with the connection operation of the reception selection switchover circuit.

The first reception selection switchover circuit and the first and second transmission selection switchover circuits have a first selection-switching mode and a second selection-switching mode. In the first selection switching mode, the first input/output unit and the receiving circuit are connected by the reception selection switchover circuit, and the second input/output unit and the second transmitting circuit are connected by the second transmission selection switchover circuit. Meanwhile, in the second selection switching mode, the second input/output unit and the receiving circuit are connected by the first reception selection switchover circuit, and the first input/output unit and the first transmitting circuit are connected by the first transmission selection switchover circuit.

By taking this constitution, one receiving circuit can be eliminated and the setting area of the receiving circuit can be reduced, so that the cost can be further lowered.

According to yet another aspect of the present invention, a display drive device comprises a first input/output unit through which one or more first signals regarding display are inputted or outputted, a second input/output unit through which the first signal is inputted or outputted, a receiving circuit for receiving the first signal from one of the first input/output unit and the second input/output unit, a transmitting circuit for outputting one or more second signals regarding the first signal from the other of the first input/output unit and the second input/output unit, a reception selection switchover circuit for connecting one of the first input/output unit and the second input/output unit to the receiving circuit, and a transmission selection switchover circuit for connecting the other of the first input/output unit and the second input/output unit to the transmitting circuit in synchronization with the connection operation of the first reception selection switchover circuit.

A plurality of the first reception selection switchover circuits and the first transmission selection switchover circuits are provided according to the number of the input/output terminals. The first reception selection switchover circuit and the first transmission selection switchover circuit have a first selection-switching mode and a second selection-switching mode. In the first selection switching mode, the first input/output unit and the receiving circuit are connected by the reception selection switchover circuit, and the second input/output unit and the second transmitting circuit are connected by the transmission selection switch over circuit. Meanwhile, in the second selection switching mode, the second input/output unit and the receiving circuit are connected by the reception selection switchover circuit, and the first input/output unit and the transmitting circuit are connected by the transmission selection switchover circuit.

By taking this constitution, one receiving circuit and one transmitting circuit can be eliminated and the setting areas of the receiving circuit and transmitting circuit can be reduced, so that the cost can be further lowered.

In this constitution, it is preferable that a power source unit for supplying a power source to the display drive device is provided between the first input/output unit and the second input/output unit.

According to this constitution, when the plurality of display drive devices are cascade-connected, the plurality of display drive devices can be connected to the power source unit without intersecting with the transfer signal wiring. In addition, since the cascade-connected wirings among the display drive devices and the power source supplying wiring can be formed in the same single layer, the wiring structure can be simplified and the cost is lowered.

According to yet another aspect of the present invention, a display signal transfer device has a plurality of display drive devices cascade-connected to each other, in which each of the display drive devices comprises a transmitting circuit for receiving one or more first signals regarding display from the previous-stage display drive device, a transmitting circuit for transmitting one or more second signals regarding the first signal to the next-stage display drive device, and a control circuit, wherein the control circuit makes the receiving circuit operate or stop in synchronization with the switching between the transmitting operation and the transmission stopping operation of the transmitting circuit, and makes the receiving circuit operate or stop in synchronization with the switching between the receiving operation and the reception stopping operation of the transmitting circuit.

By taking this constitution, when the plurality of the display drive devices are cascade-connected, the unnecessary signal transfer in each display drive device is controlled by controlling the receiving operation of the receiving circuit and the transmitting operation of the transmitting circuit, so that the power consumption can be reduced.

In this display signal transfer device, the first signal and the second signal comprise a control signal and a clock, the control circuit of the last-stage display drive device constantly stops the transmitting operation of the transmitting circuit in the last-stage display drive device, and the control circuit included in the another display drive device except for the display drive devices to which at least one of the control signal and the clock that is used in the plurality of display drive devices in common is received or transmitted, stops the receiving circuit and the transmitting circuit in the relevant display drive device.

By taking this constitution, the plurality of display drive devices from the first stage to the last stage can be collectively controlled by the control device and the unnecessary transfer signal operation of the display signal transfer device can be controlled. Thus, the power consumption can be effectively reduced and a stable signal transfer device can be provided.

In addition, according to yet another aspect of the present invention, a display device having a plurality of pixels and displaying by applying an electric signal regarding the display data to a display element that constitutes each pixel, comprises a plurality of display drive devices provided corresponding to the pixels, wherein the display drive device includes an input unit to which a transfer signal containing the display data is inputted from another display drive device, an output unit for outputting the transfer signal to another display drive device, a power source unit for supplying a power source to the display drive device, and a reference voltage input unit to which a reference voltage that drives the display element is inputted, wherein the input unit and the output unit and the power source unit are provided on one side at the periphery of the display drive device, the reference voltage input unit is provided on at least one of the first another side at the periphery except for the above one side and the second another side faced to the first another side, and the input unit, the output unit, the power source unit and the reference voltage input unit are cascade-connected in the same layer between the plurality of display drive devices.

By taking this constitution, in a structure of the transfer signal wiring and the power source wiring in the display drive device comprising less receiving circuits and transmitting circuits than the conventional device, and in the cascade-connected structure between the plurality of display drive devices, the transfer signal wiring and the power source wiring can be configured by wiring formed in the same signal layer on the panel glass. Therefore, they do not intersect with each other and can correspond to the bi-directional transfer signal, so that the power consumption can be reduced and the cost can be lowered. In addition, since the reference voltage input unit is provided on another side (the first another side or the second another side) at the periphery of the display drive device which is different from that of the other signal terminal, the connection wiring connected to the reference voltage input unit is prevented from being affected by other wirings.

As described above, according to the display signal transfer device in which the display drive devices are cascade-connected in the present invention, the circuit area and the setting area of the transfer device can be reduced and the power consumption and cost can be reduced as compared to the conventional device, while the signal can be transferred in both directions similar to the conventional device.

The display drive device and display signal transfer device and display device according to the present invention is useful for display drive devices and display signal transfer device corresponding to a cascade-connection and particularly to a display device comprising those devices.

### BRIEF DESCRIPTION OF THE DRAWINGS

Other objects of the present invention will be clear by understanding embodiments as will be described below and specified in the appended claims. Implementation of the present invention reminds those skilled in the art of many advantages that are not described in this specification.

FIG. 1 is a view showing a whole constitution example of a display drive device and a constitution example of a part of a display signal transfer device in a forward connection mode according to a first embodiment of the present invention;

FIG. 2 is a view showing a whole constitution example of the display drive device and a constitution example of a part of the display signal transfer device in a backward connection mode according to the first embodiment of the present invention;

FIG. 3 is a view showing a modified constitution example of the display drive device and a constitution example of a part of the display signal transfer device in the forward connection mode according to the first embodiment of the present invention;

FIG. 4 is a view showing a modified constitution example of the display drive device and a constitution example of a part of the display signal transfer device in the backward connection mode according to the first embodiment of the present invention;

FIG. 5 is a view showing a power source supply example and a reference voltage supply example to the display drive device and a part of the display signal transfer device in the forward connection mode according to the first embodiment of the present invention;

FIG. 6 is a view showing a power source supply example and a reference voltage supply example to the display drive device and a part of the display signal transfer device in the backward connection mode according to the first embodiment of the present invention;

FIG. 7 is a view showing a whole constitution example of a display drive device and a constitution example of a part of a display signal transfer device in the forward connection mode according to another embodiment of the first embodiment of the present invention;

FIG. 8 is a view showing a whole constitution example of the display drive device and a constitution example of a part of the display signal transfer device in the backward connection mode according to another embodiment of the first embodiment of the present invention;

FIG. 9 is a view showing a modified constitution example of the display drive device and a constitution example of a part of the display signal transfer device in the forward connection mode according to another embodiment of the first embodiment of the present invention;

FIG. 10 is a view showing a modified constitution example of the display drive device and a constitution example of a part of the display signal transfer device in the backward connection mode according to another embodiment of the first embodiment of the present invention;

FIG. 11 is a view showing a power source supply example and a reference voltage supply example to the display drive device and a part of the display signal transfer device in the forward connection mode according to another embodiment of the first embodiment of the present invention;

FIG. 12 is a view showing a power source supply example and a reference voltage supply example to the display drive device and a part of the display signal transfer device in the backward connection mode according to another embodiment the first embodiment of the present invention;

FIG. 13 is a view showing a whole constitution example of a display drive device and a constitution example of a part of a display signal transfer device according to a third embodiment of the present invention;

FIG. 14 is a view showing a power source supply example and a reference voltage supply example according to the third embodiment of the present invention;

FIG. 15 is a view showing a constitution example of a display device in a forward connection mode according to a fourth embodiment of the present invention;

FIG. 16 is a view showing a constitution example of a display device in a backward connection mode according to the fourth embodiment of the present invention;

FIG. 17 is a view showing a constitution example of a conventional display signal transfer device in the forward connection mode;

FIG. 18 is a view showing a constitution example of the conventional display signal transfer device in the backward connection mode;

FIG. 19 is a view showing a constitution example of a part of the conventional display signal transfer device in the forward connection mode and a whole constitution example of the conventional display drive device;

FIG. 20 is a view showing a constitution example of a part of the conventional display signal transfer device in the backward connection mode and a whole constitution example of the conventional display drive device;

FIG. 21 is a view showing a constitution example of a convention liquid crystal device;

FIG. 22 is a view showing a constitution example of a TFT and a liquid crystal element in the conventional liquid crystal display device;

FIG. 23 is a view showing a constitution example of a control circuit inside the display drive device according to the first embodiment of the present invention;

FIG. 24 is a view showing another constitution example of the control circuit inside the display drive device according to the first embodiment of the present invention;

FIG. 25 is a view showing a circuit constitution example of an output selection switchover circuit in the control circuit according to the present invention;

FIG. 26 is a view showing another circuit constitution example of the output selection switchover circuit in the control circuit according to the present invention;

FIG. 27 is a view showing yet another circuit constitution example of the output selection switchover circuit in the control circuit according to the present invention;

FIG. 28 is a view showing a circuit constitution example of an output selection switchover circuit according to the present invention;

FIG. 29 is a view showing another circuit constitution example of the output selection switchover circuit according to the present invention;

FIG. 30 is a view showing yet another circuit constitution example of the output selection switchover circuit according to the present invention;

FIG. 31 is a view showing a constitution example of a control circuit inside the display drive device according to another embodiment of the first embodiment of the present invention;

FIG. 32 is a view showing another constitution example of the control circuit inside the display drive device according to another embodiment of the first embodiment of the present invention;

FIG. 33 is a view showing a circuit constitution example of an input selection switchover circuit in the control circuit according to the present invention;

FIG. 34 is a view showing another circuit constitution example of the input selection switchover circuit in the control circuit according to the present invention;

FIG. 35 is a view showing a circuit constitution example of an input selection switchover circuit according to the present invention;

FIG. 36 is a view showing another circuit constitution example of the input selection switchover circuit according to the present invention;

FIG. 37 is a view showing a constitution example of a reference voltage generation circuit;

FIG. 38 is a view showing a constitution example of a receiving circuit;

FIG. 39 is a view showing another constitution example of the receiving circuit;

FIG. 40 is a view showing yet another constitution example of the receiving circuit;

FIG. 41 is a view showing a constitution example of a transmitting circuit;

FIG. 42 is a view showing another constitution example of the transmitting circuit;

FIG. 43 is a view showing yet another constitution example of the transmitting circuit;

FIG. 44 is a view showing a constitution example of a reception selection switchover circuit and a transmission selection switchover circuit according to the present invention;

FIG. 45 is a view showing another constitution example of the reception selection switchover circuit and transmission selection switchover circuit according to the present invention;

FIG. 46 is a view showing a power source supply example and a reference voltage supply example to a display drive device and apart of a display signal transfer device according to a second embodiment of the present invention;

FIG. 47 is a view showing a power source supply example and a reference voltage supply example to a display drive device and a part of a display signal transfer device according to another embodiment of the second embodiment of the present invention;

FIG. 48 is a view showing a constitution example of a reception selection switchover circuit according to the second embodiment of the present invention;

FIG. 49 is a view showing a constitution example of a transmission selection switchover circuit according to the second embodiment of the present invention;

FIG. 50 is a view showing a connection example of a reference voltage unit according to a fourth embodiment of the present invention;

FIG. 51 is a view showing another connection example of the reference voltage unit according to the fourth embodiment of the present invention; and

FIG. 52 is a view showing a constitution example of a differential amplifier circuit of a reference voltage generation circuit.

### DETAILED DESCRIPTION OF THE INVENTION

Hereinafter, embodiments of the present invention will be described in detail referring to the drawings. In addition, the same reference signs are allotted to the same or corresponding components and descriptions thereof will not be repeated.

### First Embodiment

Constitution>

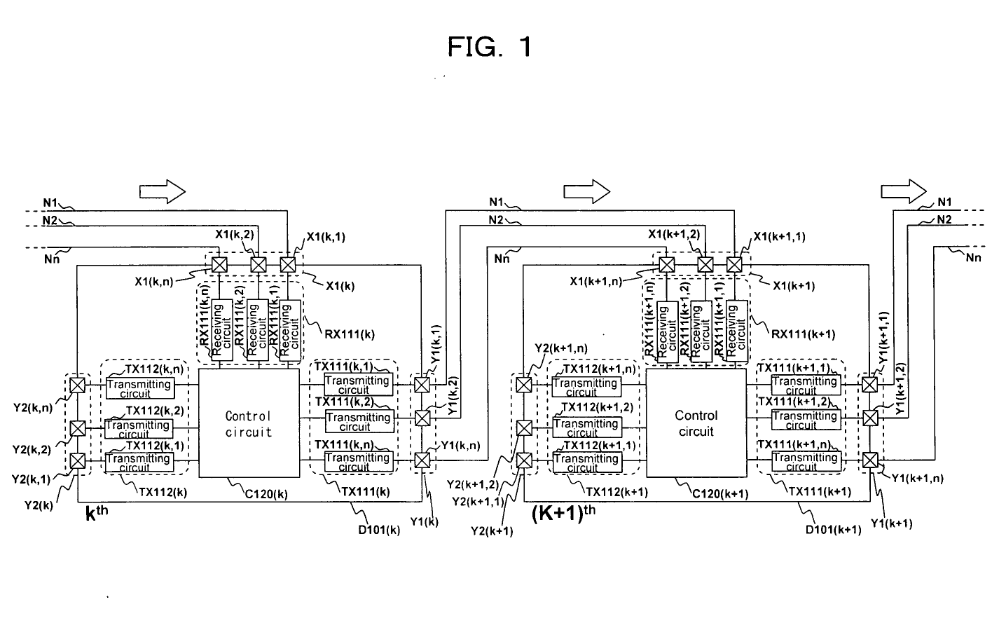

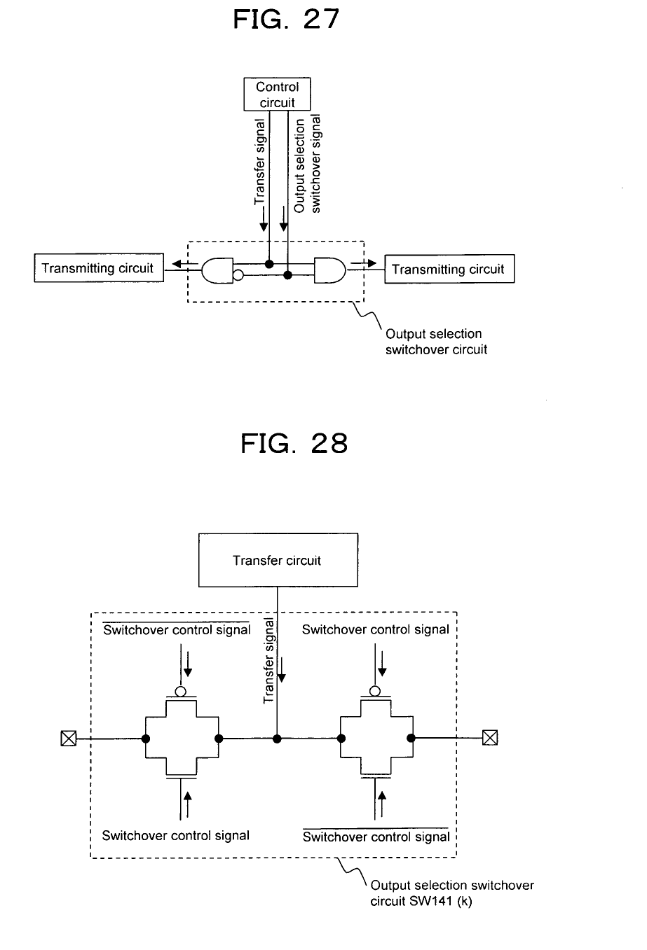

FIGS. 1 to 6 show connection constitution between a display signal transfer device, and k-th and (k+1) th display drive devices according to a first embodiment. FIGS. 23 to 30 show the constitution of an output selection switchover circuit.

The display signal transfer device according to this embodiment comprises M pieces of display drive devices. Each of the k-th display drive devices D101 (k) and D201 (k) comprises an input unit X1 (k), an output unit Y1 (k) and Y2 (k), a receiving circuit unit RX111 (k) corresponding to the input unit X1 (k), and a control circuit C120 (k) or C220 (k). The input unit X1 (k) comprises n pieces of input terminals X1 (k, 1) to X1 (k, n). The output unit Y1 (k) comprises n pieces of output terminals Y1 (k, 1) to Y1 (k, n). The output unit Y2 (k) comprises n output terminals Y2 (k, 1) to Y2 (k, n). The receiving circuit unit RX111 (k) comprises n pieces of receiving circuits RX111 (k, 1) to RX111 (k, n). The display signal transfer device comprises a power source units P131 (k) and P132 (k) to supply the electricity of the power source and a fixed control signal to the receiving circuit, a transmitting circuit and the control circuit constituting the display drive device.

The power source unit P131 (k) is arranged between the input unit X1 (k) and the output unit Y1 (k) at the periphery of the k-th display drive device D101 (k) and D201 (k). The power source unit P132 (k) is arranged between the input unit X1 (k) and the output unit Y2 (k).

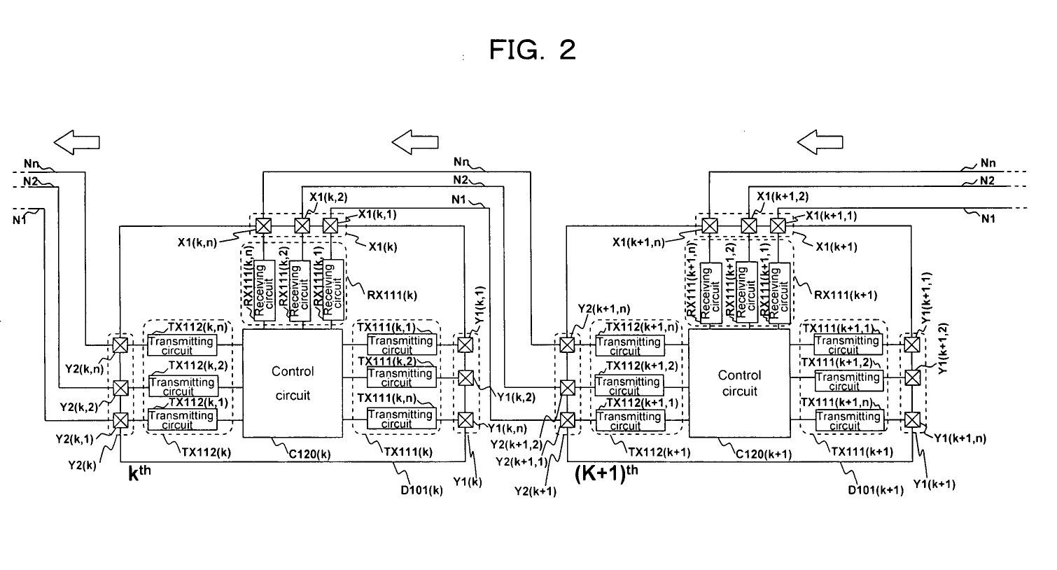

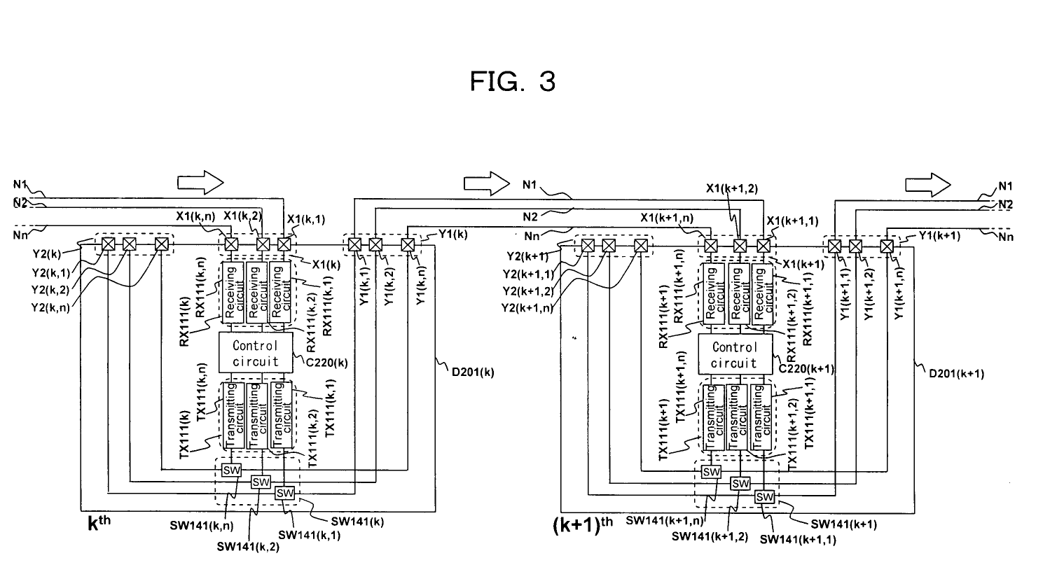

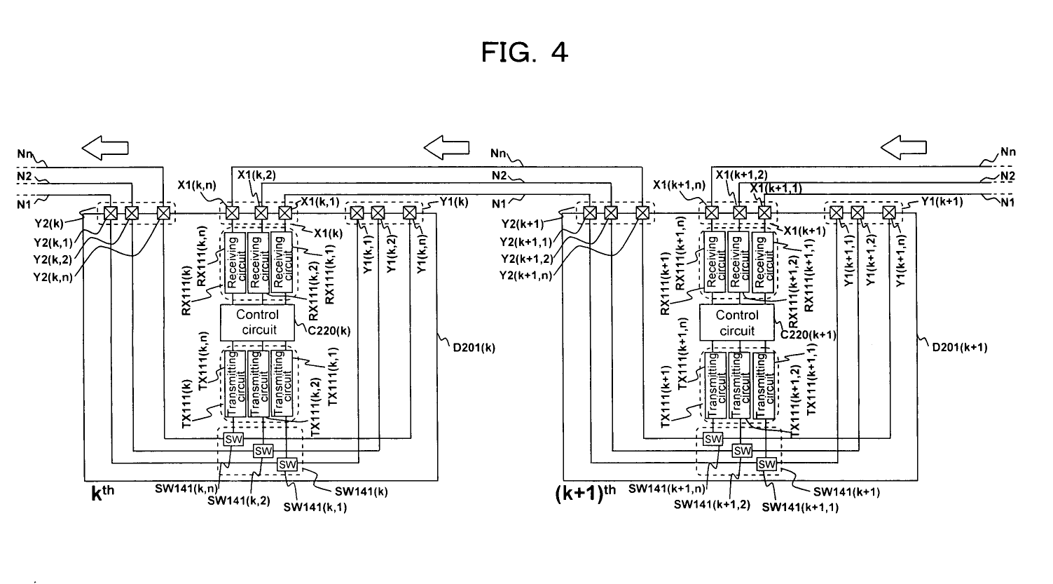

In the k-th display drive devices D101 (k) and D201 (k), the input unit X1 (k) and the receiving circuit unit RX111 (k) are connected, so that the input terminal X1 (k, 1) and the receiving circuit RX111 (k, 1) are connected, the input terminal X1 (k, 2) and the receiving circuit RX111 (k, 2) are connected, and the input terminal X1 (k, n) and the receiving circuit RX111 (k, n) are connected. The receiving circuit unit RX111 (k) and the control circuit C120 (k) or the C220 (k) are connected. The k-th display drive devices D101 (k) and D201 (k) have an individual constitution of a transmitting circuit or a common constitution of a transmitting circuit as transmitting circuits corresponding to the output units Y1 (k) and Y2 (k). FIGS. 1 and 2 show the display drive device D101 (k) having an individual constitution of the transmitting circuit and FIGS. 3 and 4 show the display drive device D201 (k) having the a common constitution of transmitting circuit.

<An Individual Constitution of Transmitting Circuit>

An individual constitution of transmitting circuit comprises a transmitting circuit unit TX111 (k) corresponding to the output unit Y1 (k), and a transmitting circuit unit TX112 (k) corresponding to the output unit Y2 (k) as shown in FIGS. 1 and 2. Each of the transmitting circuit units TX111 (k) and the TX112 (k) are connected to the control circuit C120 (k). The transmitting circuit unit TX111 (k) and the output unit Y1 (k) are connected. The output terminal Y1 (k, 1) of the output unit Y1 (k) and the transmitting circuit TX111 (k, 1) are connected. The output terminal Y1 (k, 2) and the transmitting circuit TX111 (k, 2) are connected. The output terminal Y1 (k, n) and the transmitting circuit TX111 (k, n) are connected. The transmitting circuit unit TX112 (k) and the output unit Y2 (k) are connected. The output terminal Y2 (k, 1) of the output unit Y2 (k) and the transmitting circuit TX112 (k, 1) are connected. The output terminal Y2 (k, 2) and the transmitting circuit TX112 (k, 2) are connected. The output terminal Y2 (k, n) and the transmitting circuit TX112 (k, n) are connected.

<A Common Constitution of Transmitting Circuit>

A common constitution of transmitting circuit comprises a transmitting circuit unit TX111 (k) corresponding to the output units Y1 (k) and Y2 (k) as shown in FIGS. 3 and 4. A common constitution of transmitting circuit further comprises an output selection switchover circuit unit SZ9141 (k) connecting the transmitting circuit unit TX111 (k) to the output unit Y1 (k) or the Y2 (k). The transmitting circuit unit TX111 (k) is connected to the control circuit C220 (k). The output selection switchover circuit unit SZ9141 (k) has a forward connection mode and a backward connection mode as its connection configuration. In the forward connection mode, the transmitting circuit unit TX111 (k) and the output unit Y1 (k) are related and connected, and in the backward connection mode, the transmitting circuit unit TX111 (k) and the output unit Y2 (k) are related and connected.

A transmitting circuit TX111 (k, 1) is connected to an output selection switch over circuit SZ9141 (k, 1), the output selection switchover circuit SZ9141 (k, 1) is connected to the output terminals Y1 (k,1) and Y2 (k, 1). The transmitting circuit TX111 (k,2) is connected to an output selection switchover circuit SZ9141 (k,2), and the output selection switchover circuit SZ9141 (k,2) is connected to the output terminals Y1 (k, 2) and Y2 (k,2). The transmitting circuit TX111 (k, n) is connected to an output selection switchover circuit SZ9141 (k, n), and the output selection switchover circuit SZ9141 (k, n) is connected to output terminals Y1 (k, n) and Y2 (k, n).

To n pieces of input terminals X1 (k, 1) to X1 (k, n) in the input unit X1 (k), n pieces of transfer signals N1 to Nn are inputted from the outside (for example, the display drive device D101 (k−1) of a previous stage), respectively. The k-th display drive device D101 (k) outputs the n pieces of transfer signals N1 to Nn from the output units Y1 (k) and Y2 (k) to the (k+1) th display drive device D101 (k+1).

The input unit X1 (k+1) of the (k+1)th display drive device D101 (k+1) or D201 (k+1) corresponds to the input unit X1 (k) of the k-th display drive device D101 (k) or D201 (k). Output units Y1 (k+1) and Y2 (k+1), a receiving circuit unit RX111 (k+1), a transmitting circuit unit TX111 (k+1) or TX112 (k+1), a control circuit C120 (k+1) or C220 (k+1), and a power source units P131 (k+1) and P132 (k+1) in the (k+1)th display drive device D101 (k+1) or D201 (k+1) correspond to the output units Y1 (k) and Y2 (k), the receiving circuit unit RX111 (k), the transmitting circuit unit TX111 (k) or TX112 (k), the control circuit C120 (k) or C220 (k), and the power source units P131 (k) and P132 (k) in the k-th display drive device D101 (k) or D201 (k), respectively. An output selection control circuit SZ9141 (k+1) in the (k+1) th display drive device 201 (k+1) corresponds to the output selection control circuit unit SZ9141 (k) in the k-th display drive device D201 (k).

<Receiving Circuit>

The receiving circuit unit RX111 (k) receives the transfer signals N1 to Nn inputted to the input terminals X1 (k, 1) to X1 (k, n) of the input unit X1 (k). The transfer signals N1 to Nn are received by the receiving circuits RX111 (k, 1) to RX111 (k, n) of the receiving circuit unit RX111 (k) corresponding to the input terminals X1 (k, 1) to X1 (k, n), respectively. The transfer signals N1 to Nn are sent to the control circuit C120 (k) or C220 (k) respectively.

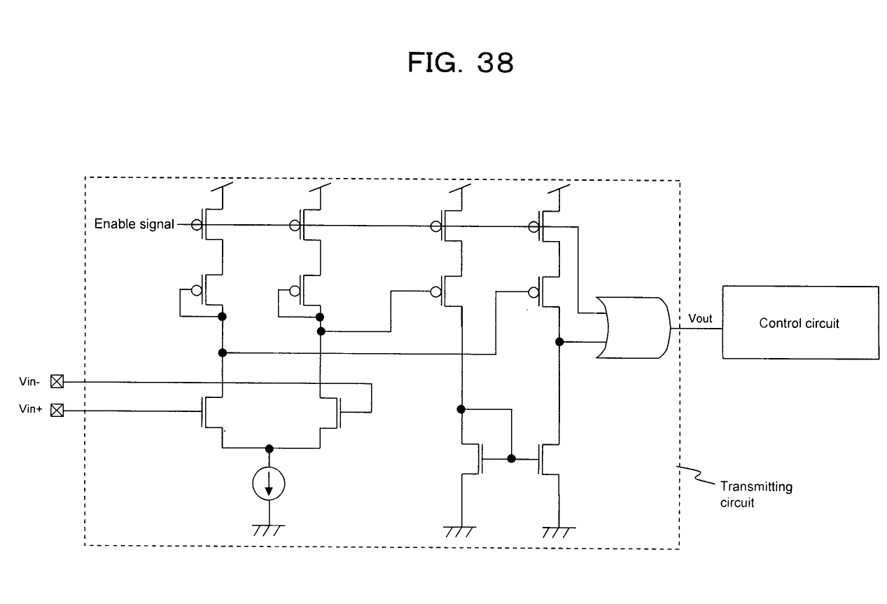

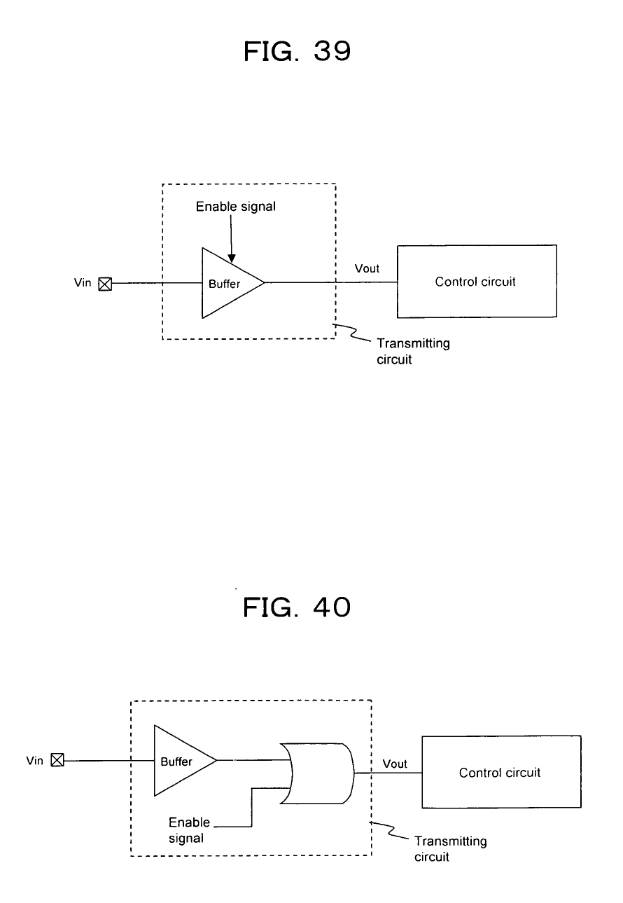

The receiving circuits RX111 (k, 1) to RX111 (k, n) perform receiving operations and reception stopping operations based on a control signal. FIGS. 38 to 40 show the constitution example of the receiving circuit. FIG. 38 shows a comparator type of receiving circuit that sends a single-end signal Vout to the control circuit in response to the inputted differential signals Vin+ and Vin−. FIGS. 39 and 40 show buffer type of receiving circuits that send a single-end signal Vout to the control circuit in response to an inputted single-end signal Vin. Each receiving circuit performs a receiving operation or a reception stopping operation based on an enable signal. The output of the receiving circuit becomes a high-impedance signal or a fixed signal. As shown in FIGS. 1 to 4, it is preferable that the receiving circuits are arranged in the middle part of a longitudinal side at the periphery or in the vicinity of the input unit of the display drive device.

<Control Circuit>

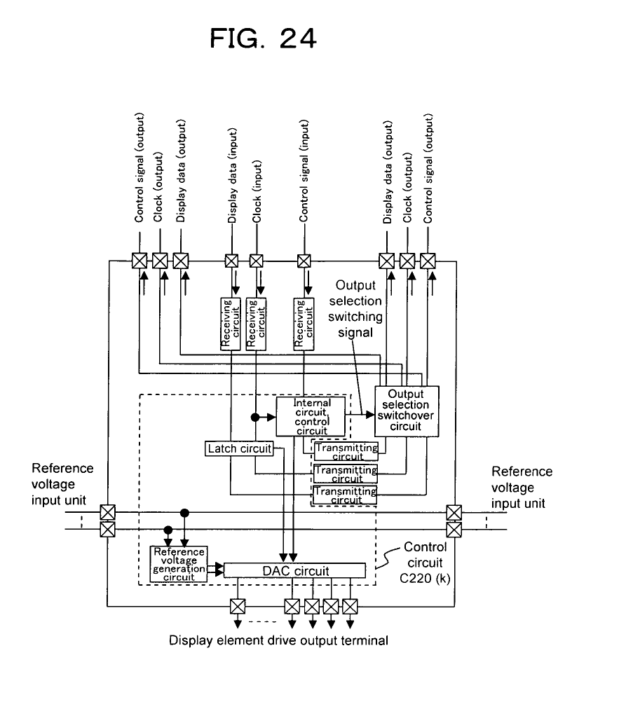

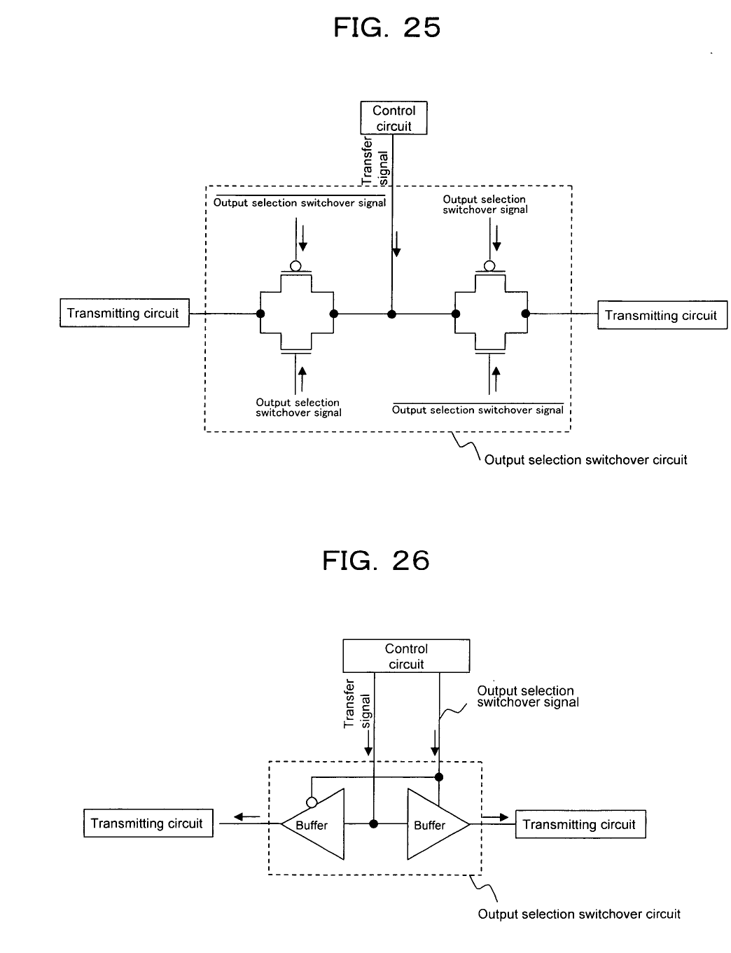

The transfer signals N1 to Nn received by the receiving circuit unit RX111 (k) are inputted to the control circuit C120 (k) or C220 (k). The control circuit C120 (k) sends the transfer signals N1 to Nn to the transmitting circuit unit TX111 (k) and TX112 (k) in order to output them to the outside. According to the constitution in which the transfer signals N1 to Nn are sent to the transmitting circuits TX111 (k) and TX112 (k), an output selection switchover circuit is provided inside the control circuit C120 (k) as shown in FIG. 23. FIGS. 25 to 27 show the constitution examples of the output selection switchover circuit. The transfer signals sent from the control circuit N1 to Nn are sent to the transmitting circuit TX111 (k) or TX112 (k) based on an output selection switchover signal. There are a forward connection mode and a backward connection mode in a signal transmission configuration at this time. According to the forward connection mode, the transfer signals N1 to Nn are sent from the control circuit C120 (k) to the transmitting circuit unit TX111 (k) and according to the backward connection mode, the transfer signals N1 to Nn are sent from the control circuit C120 (k) to the transmission circuit unit TX112 (k). The control circuit C220 (k) sends the transfer signals N1 to Nn to the transmitting circuit unit TX111 (k) even in each mode.

<Transmitting Circuit>

The transmitting circuit has an individual constitution of a transmitting circuit or a common constitution of transmitting circuit.

<An Individual Constitution of Transmitting Circuit>

An individual constitution of transmitting circuit comprises the transmitting circuit unit TX111 (k) so as to correspond to the output unit Y1 (k), and the transmitting circuit unit TX112 (k) so as to correspond to the output unit Y2 (k). According to the individual constitution of transmitting circuit, n pieces of transfer signals N1 to Nn sent from the control circuit C120 (k) are inputted to the transmitting circuit unit TX111 (k) or TX112 (k). The transfer signals N1 to Nn inputted to the transmitting circuit unit TX111 (k) are transmitted to the output terminals Y1 (k, 1) to Y1 (k, n) of the output unit Y1 (k) through the transmitting circuits TX111 (k, 1) to TX111 (k, n). The transfer signals N1 to Nn inputted to the transmitting circuit unit TX112 (k) are transmitted to the output terminals Y2 (k, 1) to Y2 (k, n) of the output unit Y2 (k) through the transmitting circuit TX112 (k, 1) to TX112 (k, n).

The transmitting circuits TX111 (k, 1) to TX111 (k, n) or TX112 (k, 1) to TX112 (k, n) performs a transmitting operation and a transmission stopping operation based on the control signal respectively.

<A Common Constitution of Transmitting Circuit>

A common constitution of transmitting circuit comprises a transmitting circuit unit TX111 (k) so as to commonly correspond to the output units Y1 (k) and Y2 (k). According to a common constitution of transmitting circuit, the n pieces of transfer signals N1 to Nn sent from the control circuit C220 (k) are inputted to the transmitting circuit unit TX111 (k). In the transmitting circuit unit TX111 (k), the transfer signals N1 to Nn are transmitted to the output selection switchover circuit SZ9141 (k) through the transmitting circuits TX111 (k, 1) to TX111 (k, n). The transmitting circuits TX111 (k, 1) to TX111 (k, n) performs a transmitting operation and a transmission stopping operation based on the control signal respectively.

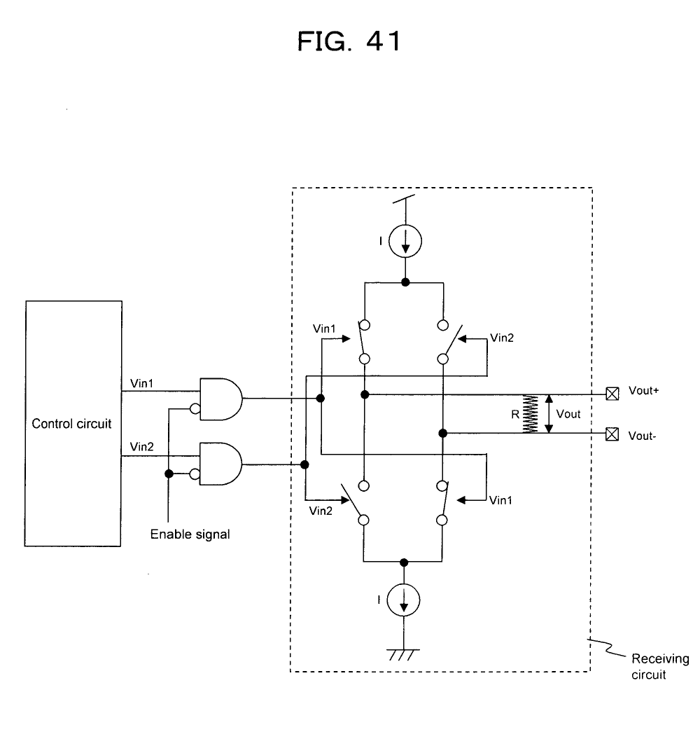

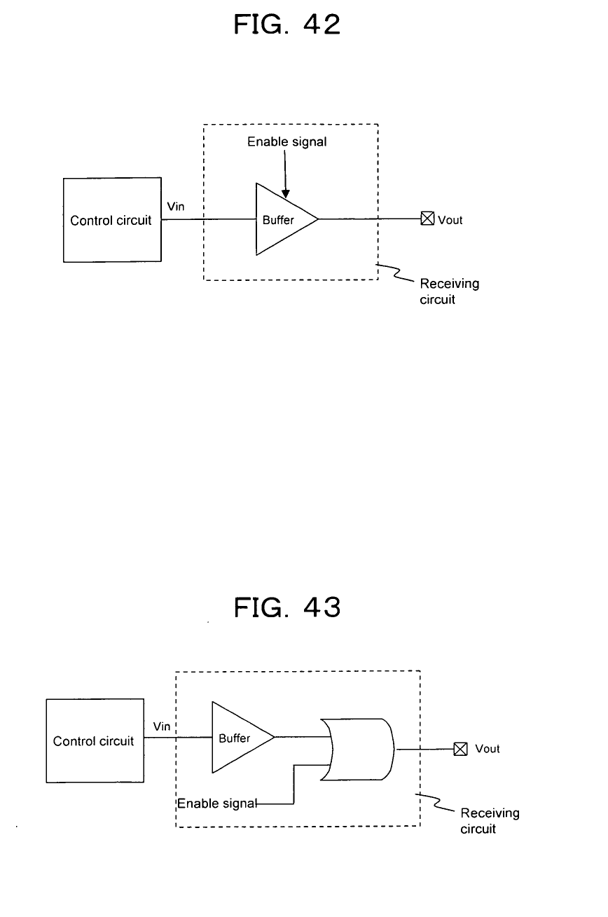

FIGS. 41 to 43 show the constitution examples of the receiving circuit. FIG. 41 shows a transmitting circuit that outputs differential signals Vout+ and Vout− in response to an inputted single-end signal Vin+ and its reversed-phase signal Vin−. FIGS. 42 and 43 show a transmitting circuit that outputs a single-end Vout in response to an inputted single-end signal Vin. Each transmitting circuit comprises a function to perform the transmitting operation and the transmission stopping operation based on the enable signal. The output of the transmitting circuit becomes a high-impedance signal or a fixed signal.

As shown in FIGS. 1 to 4, in the individual constitution of transmitting circuit in FIGS. 1 and 2, it is preferable that the transmitting circuits are arranged so as to be symmetric with respect to the receiving circuit unit and the control circuit, in the vicinity of the output units. In the common constitution of transmitting circuit in FIGS. 3 and 4, it is desirable that the transmitting circuit unit and the output selection switchover circuit are arranged at the middle position of the two output units, in the middle part on the longitudinal side at the periphery of the display drive device similar to the receiving circuit unit.

<Output Selection Switchover Circuit>

Next, the output selection switchover circuit SZ9141 (k) will be described in detail. FIGS. 28 to 30 show the constitution examples of the output selection switchover circuit. The output selection switchover circuit has a forward connection mode and a backward connection mode as a connection mode. These connection modes are set based on the control signal.

<Forward Connection Mode>

According to the display drive device D201 (k) shown in FIG. 3, when the output selection switchover circuit SZ9141 (k) is in the forward connection mode, the transmitting circuit unit TX111 (k) is connected so as to correspond to the output unit Y1 (k) so that the transmitting circuits TX111 (k, 1) to TX111 (k, n) are connected to the output terminals Y1 (k, 1) to Y1 (k, n), respectively.

<Backward Connection Mode>

According to the display drive device shown in FIG. 4, when the output selection switchover circuit SZ9141 (k) is in the backward connection mode, the transmitting circuit unit TX111 (k) is connected so as to correspond to the output unit Y2 (k) so that the transmitting circuits TX111 (k, 1) to TX111 (k, n) are connected so as to correspond to the output terminals Y2 (k, 1) to Y2 (k, n), respectively.

<Terminal Arrangement>

Next, a description will be given to the terminal arrangement of the input unit X1 (k), the output unit Y1 (k) and Y2 (k) and the power source units P131 (k) and P132 (k). The input unit X1 (k) and the output units Y1 (k) and Y2 (k) are arranged so that the input unit X1 (k) is arranged between the output units Y1 (k) and Y2 (k) at the periphery of the k-th display drive device D101 (k) or D201 (k). At this time, the output unit Y1 (k), the input unit X1 (k) and the output unit Y2 (k) are aligned in this order.

In addition, in the input terminals X1 (k, 1) to X1 (k, n) of the input unit X1 (k), the output terminals Y1 (k, 1) to Y1 (k, n) of the output unit Y1 (k), and the output terminals Y2 (k, 1) to Y2 (k, n) of the output unit Y2 (k), the input terminals X1 (k, 1) to X1 (k, n) are arranged in the order of the input terminals X1 (k, 1), X1 (k,2), . . . , X1 (k, n) at the periphery of the k-th display drive device D101 (k) or D201 (k). The output terminals Y1 (k, 1) to Y1 (k, n) are arranged in the order of the output terminal Y1 (k, 1), Y1 (k,2), . . . , Y1 (k, n) from the close side of the input terminal X1 (k, 1) along the above periphery, and the output terminals Y2 (k, 1) to Y2 (k, n) are arranged in the order of output terminals Y2 (k, n), Y2 (k, n−1), . . . , Y2 (k, 1) from the close side of the input terminal X1 (k, n) along the above periphery.

The k-th display drive device D101 (k) or D201 (k) comprises power source units P131 (k) and P132 (k). The power source unit P131 (k) is arranged between the input unit X1 (k) and the output unit Y1 (k) at the periphery of the display drive device. The power source unit P132 (k) is arranged between the input unit X1 (k) and the output unit Y2 (k) at the periphery of the display drive device. The power source units P131 (k) and P132 (k) are connected to each other inside the display drive device.

<Cascade Connection>

Next, a description will be given to a display signal transfer device that comprises a plurality of display drive devices and cascade-connects them to sequentially transfer display data. In the following description, it is assumed that the connection in which a signal is transferred from the first display drive device in the display signal transfer device is the forward connection mode and the connection in which a signal is transferred from the M-th display drive device in the display signal transfer device is the backward connection mode. According to this embodiment, one input unit and two output units are provided, and the forward connection mode and the backward connection mode are set by these input and output units and two connecting means.

<Forward Connection Mode>

In the forward connection mode, the transfer signals N1 to Nn sent from the (k−1) th display drive device in the previous stage are inputted to the input terminals X1 (k, 1) to X1 (k, n) of the k-th display drive device D101 (k) or D201 (k) as shown in FIGS. 1, 3 and 5. Then, the output terminals Y1 (k, 1) to Y1 (k, n) of the output unit Y1 (k) and the input terminals X1 (k+1, 1) to X1 (k+1, n) of the input unit X1 (k+1) of the (k+1)th display drive device D101 (k+1) or D201 (k+1) are connected, respectively. In the (k+2)th display drive device also, an input unit X1 (k+2) and an output unit Y1 (k+2) are sequentially cascade-connected similarly, whereby the display signal transfer device is constituted.

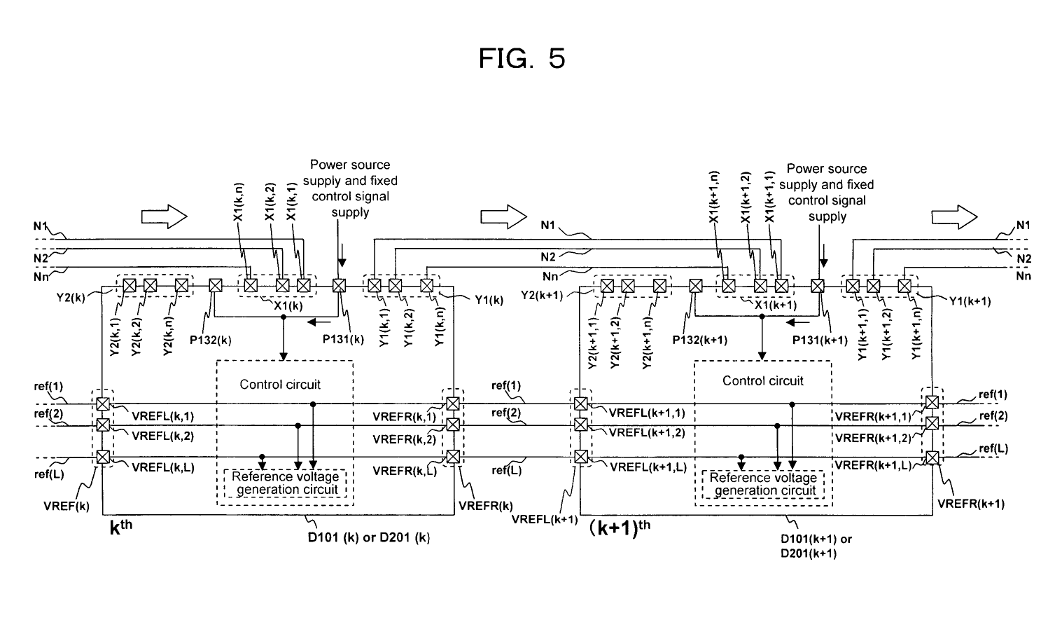

In addition, as shown in FIG. 5, according to the display signal transfer device in which the plurality of display drive devices are cascade-connected in the forward connection mode, though a wiring connection for power supply is provided in the power source unit P131 (k), a wiring connection for power supply is not provided in the power source unit P132 (k).

<Backward Connection Mode>

In the backward connection mode, connection constitution is formed so that the transfer signals N1 to Nn sent from the (k+2)th display drive device in the previous stage are inputted to the input terminals X1 (k+1, 1) to X1 (k+1, n) of the input unit X1 (k+1) of the (k+1) th display drive device D101 (k+1) or D201 (k+1) as shown in FIGS. 2, 4 and 6. Then, the output terminals Y2 (k+1, 1) to Y2 (k+1, n) of the output unit Y2 (k+1) and the input terminals X1 (k, 1) to X1 (k, n) of the input unit X1 (k) of the k-th display drive device D101 (k) or D201 (k) are connected, respectively. In the (k−1)th display drive device also, an input unit X1 (k−1) and an output unit Y2 (k−1) are sequentially cascade-connected similarly, whereby the display signal transfer device is constituted.

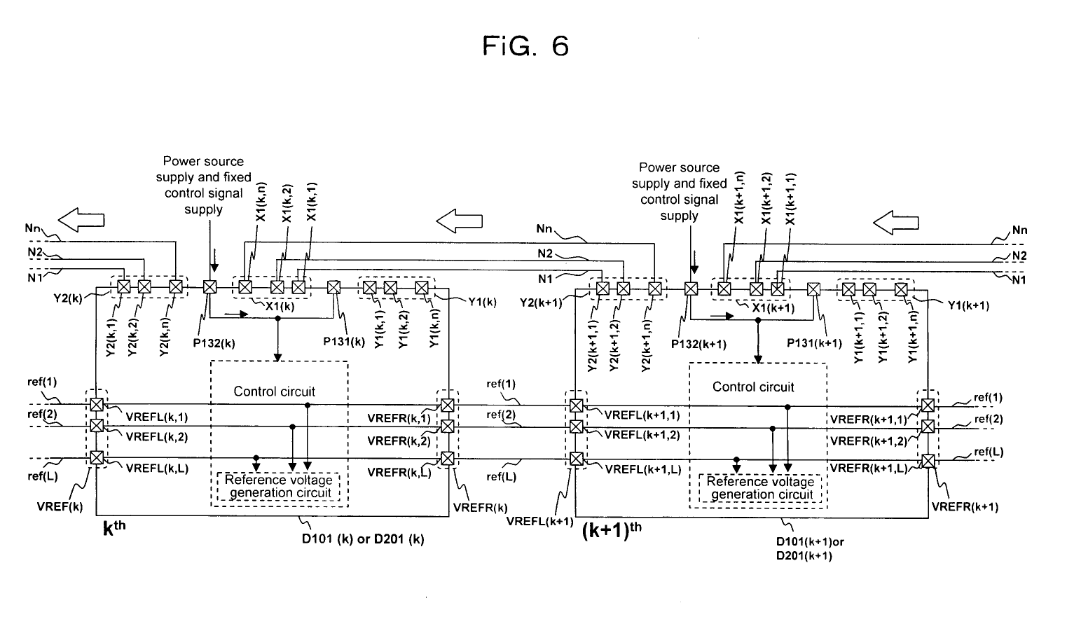

In addition, as shown in FIG. 6, in the display signal transfer device in which the plurality of display drive devices are cascade-connected in the backward connection mode, a wiring connection for power supply is provided in the power source unit P132 (k) but a wiring connection for power supply is not provided in the power source unit P131 (k).

<Operation>

Next, operations of the display drive device and the display signal transfer device shown in FIGS. 1 to 6 will be described. Here, a description will be given to the operation in which transfer signals N1 to Nn such as a clock or display data or the control signal outputted from the control LSI of a display device are inputted to the first-stage display drive device of the display signal transfer device and they are sequentially transferred.

<An Individual Constitution of Transmitting Circuit>

Next, a detailed description will be made of the forward connection mode and the backward connection mode in the display drive device having the individual constitution of transmitting circuit.

<Forward Connection Mode>

In the forward connection mode, according to the display signal transfer device in which the transfer signal is transferred from the first-stage display drive device to the last-stage M-th display drive device, as shown in FIG. 1, in the k-th display drive device D101 (k), the transfer signals N1 to Nn transmitted from the output unit of the previous-stage (k−1)th display drive device are inputted to the input terminals X1 (k, 1) to X1 (k, n) of the input unit X1 (k), respectively and then received by the receiving circuits RX111 (k, 1) to RX111 (k, n) of the receiving circuit unit RX111 (k).

The received transfer signals N1 to Nn are sent to the control circuit C120 (k), and in the transfer signals N1 to Nn, the latch processing of the display data with clocks and the controlling operation of the control signal are carried out. In order to transfer them to the (k+1) th display drive device D101 (k+1), the control circuit C120 (k) sends the transfer signals N1 to Nn to the transmitting circuits TX111 (k, 1) to TX111 (k, n) of the transmitting circuit unit TX111 (k). At this time, according to the constitution in which the output selection switchover circuit is provided in the control circuit C120 (k), the transfer signals N1 to Nn are sent so as to correspond to the transmitting circuit unit TX111 (k). The transfer signals N1 to Nn are outputted from the output terminals Y1 (k, 1) to Y1 (k, n) of the output unit Y1 (k) to the outside of the display drive device D101 (k).

The transfer signals N1 to Nn outputted from the output terminals Y1 (k, 1) to Y1 (k, n) of the output unit Y1 (k) of the display drive device D101 (k) are inputted to the input terminals X1 (k+1, 1) to X1 (k+1, n) of the input unit X1 (k+1) of the (k+1)th display drive device D101 (k+1). The inputted transfer signals N1 to Nn are received by receiving circuits RX111 (k+1, 1) to RX111 (k+1, n) of the receiving circuit unit RX111 (k+1) of the display drive device D101 (k+1), respectively. The signals are sequentially transferred between the following display drive devices in the similar manner as described above.

According to the forward latching process, while the latch processing of the transfer signal is made in the k-th display drive device D101 (k), the transmitting operation of the transmitting circuit unit TX111 (k) of the display drive device D101 (k) is stopped and the receiving operation of the receiving circuit unit RX111 (k+1) of the (k+1) th display drive device D101 (k+1) is stopped so that the signal is not transmitted to the (k+1) th display drive device and the following display drive devices. Then, at a period immediately before the latching process of the transfer signals is completed in the k-th display drive device D101 (k), the transmission of the transmitting circuit unit TX111 (k) is activated and at a period immediately before the latching operation of the transfer signal is started in the (k+1)th display drive device D101 (k+1), the receiving operation of the receiving circuit unit RX111 (k+1) of the (k+1)th display drive device D101 (k+1) is activated.

According to the backward latching process, while the latch processing of the transfer signal is made in the (k+1)th display drive device D101 (k+1), the transmitting operation of the transmitting circuit unit TX111 (k) of the display drive device D101 (k) is activated so that the signal is transmitted in the display drive devices preceding the (k+1)th display drive device. In addition, the receiving operation of the receiving circuit unit RX111 (k+1) of the (k+1) th display drive device D101 (k+1) is activated. Thus, in a period after the latching process of the signal in the (k+1)th display drive device D101 (k+1), the receiving circuit unit RX111 (k+1) is stopped and in synchronization with it, the transmitting circuit unit TX111 (k) of the k-th display drive device D101 (k) is stopped. At this time, further, the transmitting operation of the transmitting circuits TX112 (k, 1) to TX112 (k, n) of the transmitting circuit unit TX112 (k) are stopped on a steady basis.

Furthermore, the operations of the receiving circuit and the transmitting circuit arranged on at least one path for transferring the common clock signal or a common control signal to the display drive device are activated full-time, and the operations of the receiving circuit and the transmitting circuit involving the transfer of the signal other than the above signals are all stopped. Furthermore, in the final-stage M-th display drive device, the transmitting operation of the transmitting circuit TX111 (M) is stopped on a steady basis.

The transmitting circuit in which the signal transfer is stopped is in a high-impedance output state or a fixed signal transmitting state. For example, according to the constitution of the transmitting circuit shown in FIG. 41, the single-end signals Vin1 and Vin2 are separated. According to the constitution of the transmitting circuit shown in FIG. 42, the high-impedance output state is provided by an enable signal. According to the constitution of the transmitting circuit shown in FIG. 43, the signal-end signal Vout becomes a fixed signal based on the control signal.

<Backward Connection Mode>

In the backward connection mode, the signal is transferred in the direction opposite to that in the forward connection mode. More specifically, in the display signal transfer device in which the transfer signal is transferred along a direction from the first stage to the final stage in the final M-th display drive device and the signal is transferred along a direction from the first stage to the final stage in the first display drive device, as shown in FIG. 2, the transfer signals N1 to Nn transmitted from the (k+2) th display drive device are inputted to the input terminals X1 (k+1, 1) to X1 (k+1, n) of the input unit X1 (k+1) of the (k+1)th display drive device D101 (k+1) respectively and then received by the receiving circuits RX111 (k+1, 1) to RX111 (k+1, n) of the receiving circuit unit RX111 (k+1).

The received transfer signals N1 to Nn are sent to the control circuit C120 (k+1) in which latch processing of the display data by clocks and the control treatment of the control signal are carried out. In order to transfer them to the k-th display drive device D101 (k), the control circuit C120 (k+1) sends the transfer signals N1 to Nn to the transmitting circuits TX112 (k+1, 1) to TX112 (k+1, n) of the transmitting circuit unit TX112 (k+1) respectively. At this time, according to the constitution in which the control circuit C120 (k) is provided with an output selection switchover circuit, the transfer signals N1 to Nn are sent so as to correspond to the transmitting circuit unit TX112 (k). The transfer signals N1 to Nn are outputted from the output terminals Y2 (k+1, 1) to Y2 (k+1, n) of the output unit Y2 (k+1) to the outside of the display drive device D101 (k+1).

The transfer signals N1 to Nn outputted from the output terminals Y2 (k+1, 1) to Y2 (k+1, n) of the output unit Y2 (k+1) of the display drive device D101 (k+1) are inputted to the input terminals X1 (k, 1) to X1 (k, n) of the input unit X1 (k) of the k-th display drive device D101 (k). The inputted transfer signals N1 to Nn are received by the receiving circuits RX111 (k, 1) to RX111 (k, n) of the receiving circuit unit RX111 (k) of the display drive device D101 (k) respectively. The signals are sequentially transferred in a similar manner as described above between the following display drive devices.

Additionally, in a period when latch processing is carried out to the transfer signal treated in the (k+1)th display drive device D101 (k+1), the transmitting operation of the transmitting circuit unit TX112 (k+1) of the display drive device D101 (k+1) is stopped so that the signal is not transmitted and received in the k-th and following display drive devices, and then the receiving operation of the receiving circuit unit RX111 (k) of the k-th display drive device D101 (k) is stopped. The transmitting circuit and the receiving circuit stopped at this time are in a high-impedance output state or a fixed signal output state.

Then, at a period immediately before the latching process is completed in the (k+1) th display drive device D101 (k+1), the transmission action of the transmitting circuit unit TX112 (k+1) is activated and at a period immediately before the latching process in the k-th display drive device D101 (k) is started, the receiving operation of the receiving circuit unit RX111 (k) of the k-th display drive device D101 (k) is activated.

Meanwhile, in the backward latching process, while the latch processing is carried out to the transfer signal treated in the k-th display drive device D101 (k), the transmitting operation of the transmitting circuit unit TX112 (k+1) of the display drive device D101 (k+1) is activated and the receiving operation of the receiving circuit unit RX111 (k) of the k-th display drive device D101 (k) is activated so that the signal is transferred in the k-th and previous display drive devices. Thus, in a period after the latching process of the signal in the k-th display drive device D101 (k) is completed, the receiving operation of the receiving circuit unit RX111 (k) is stopped and in synchronization with it, the transmitting operation of the transmitting circuit unit TX112 (k+1) of the (k+1)th display drive device D101 (k+1) is stopped. At this time, further, the transmitting operations of the transmitting circuits TX111 (k, 1) to TX111 (k, n) of the transmitting circuit unit TX111 (k) are stopped on a steady basis.

Furthermore, the operations of the receiving circuit and the receiving circuit arranged on at least one path relevant to the clock signal or a control signal which is common to the display drive device are activated full-time, and the operations of the receiving circuit and the transmitting circuit involving the transmission of the signal other than the above signals are all stopped. Furthermore, in the first display drive device in a final-stage, the transmitting operation of the transmitting circuit TX112 (1) is stopped on a steady basis.

The transmitting circuit in which the signal transfer is stopped is in a high-impedance output state or a fixed signal transmitting state. Namely, in a period when the signal transfer is stopped, for example, according to the constitution of the transmitting circuit shown in FIG. 41, the single-end signals Vin1 and Vin2 are separated. According to the constitution of the transmitting circuit shown in FIG. 42, the high-impedance output state is provided by an enable signal. According to the constitution of the transmitting circuit shown in FIG. 43, the signal-end signal Vout becomes a fixed signal by the control signal.

<Transmitting Circuit Common Constitution>

Next, a description will be given in detail to the forward connection mode and the backward connection mode in a constitution where the transmitting circuit is commonly used in the display drive device and a part different from the individual constitution of the transmitting circuit.

<Forward Connection Mode>

As shown in FIG. 3, the control circuit C220 (k) transmits the transfer signals N1 to Nn to the transmitting circuits TX111 (k, 1) to TX111 (k, n) of the transmitting circuit unit TX111 (k) respectively. The output selection switchover circuits SZ9141 (k, 1) to SZ9141 (k, n) of the output selection switchover circuit SZ9141 (k) relate the transmitting circuits TX111 (k, 1) to TX111 (k, n) of the transmitting circuit unit TX111 (k) to the output terminals Y1 (k, 1) to Y1 (k, n) of the output unit Y1 (k) so that the transfer signals N1 to Nn are outputted from the output terminals Y1 (k, 1) to Y1 (k, n) of the k-th display drive device D201 (k) to the (k+1)th display drive device D201 (k+1). The signals are sequentially transferred in a similar manner as described above between the following display drive devices.

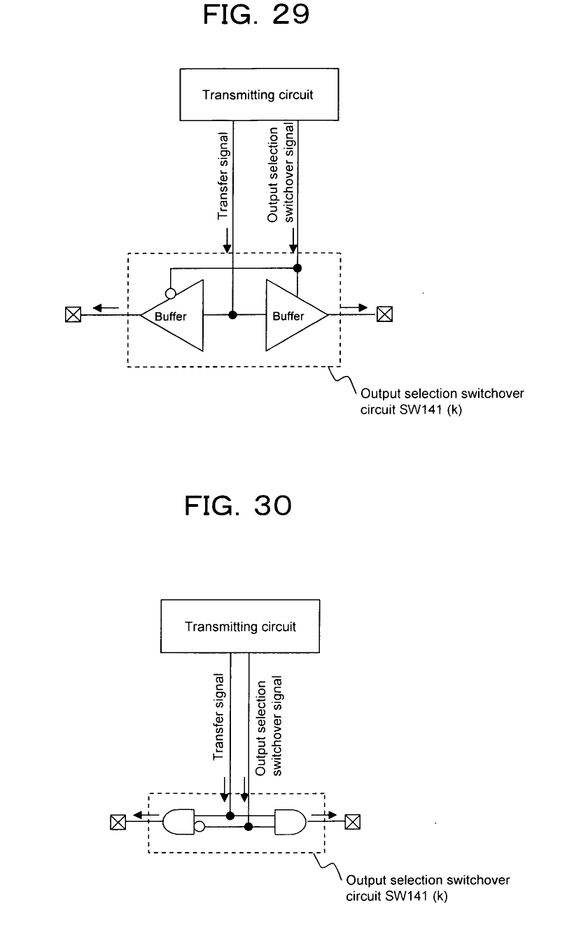

The output unit Y2 (k) that is not used in the signal transfer is in the high-impedance output state or the fixed signal output state. That is, while the signal transfer is stopped, one of the output selection switchover circuits connected to the output terminal by the output selection switchover signal becomes high-impedance output state in the circuit constitutions shown in FIGS. 28 and 29, and the fixed signal output state is provided by the control signal in the circuit constitution shown in FIG. 30.

<Backward Connection Mode>

As shown in FIG. 4, the control circuit C220 (k+1) transmits the transfer signals N1 to Nn to the transmitting circuits TX111 (k+1, 1) to TX111 (k+1, n) of the transmitting circuit unit TX111 (k+1) respectively. The output selection switchover circuits SZ9141 (k+1, 1) to SZ9141 (k+1, n) of the output selection switchover circuit SZ9141 (k+1) relate the transmitting circuits TX111 (k+1, 1) to TX111 (k+1, n) of the transmitting circuit unit TX111 (k+1) to the output terminals Y2 (k+1, 1) to Y2 (k+1, n) of the output unit Y2 (k+1) so that the transfer signals N1 to Nn are outputted from the output terminals Y2 (k+1, 1) to Y2 (k+1, n) of the output unit Y2 (k+1) of the (k+1) th display drive device D201 (k+1) to the k-th display drive device D201 (k). The signals are sequentially transferred in a similar manner as described above between the following display drive devices.

The output unit Y1 (k) that is not used in the signal transfer is made to be the high-impedance output state or the fixed signal output state. That is, while the signal transfer is stopped, one of the output selection switchover circuits connected to the output terminal by the output selection switchover signal becomes high-impedance output state in the circuit constitution shown in FIGS. 28 and 29, and the fixed signal output state is provided by the control signal in the circuit constitution shown in FIG. 30.

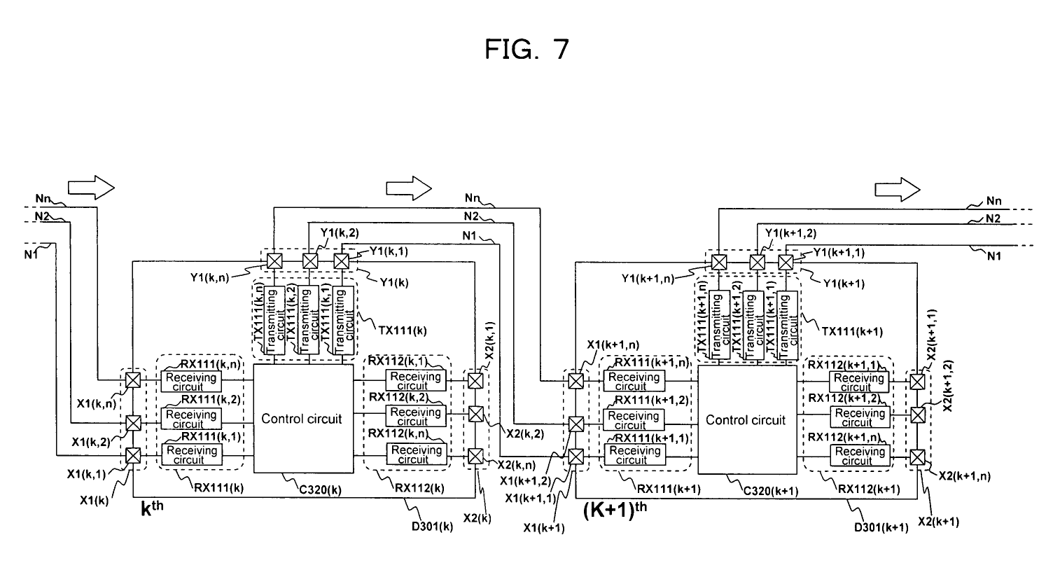

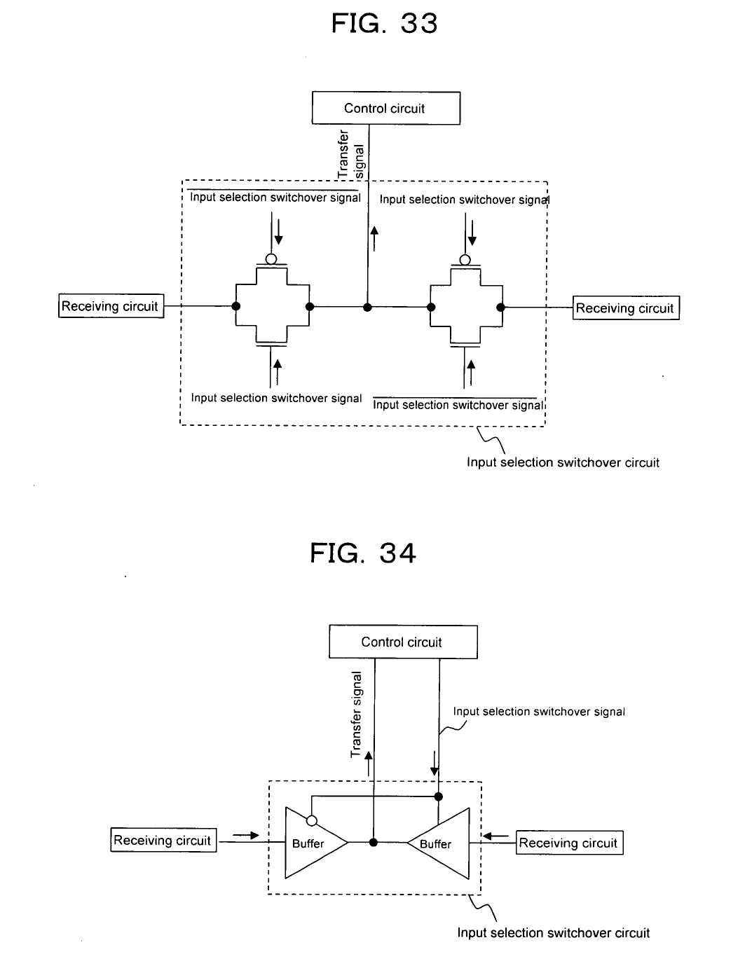

According to the first embodiment, the display drive device having one input unit and two output units comprises one receiving circuit unit and two transmitting circuit units, or comprises one transmitting circuit unit and output selection switchover circuit, so as to correspond to them. However, as shown in FIGS. 7 to 12, there is another embodiment that is different from the above embodiment in that the input and the output are reversed. According to this embodiment, the display drive device having two input units and one output unit comprises two receiving circuit units or one receiving circuit unit, an input selection switchover circuit, and one transmitting circuit unit correspondingly. FIGS. 33, 34, 35 and 36 show the constitution example of the input selection switchover circuit.

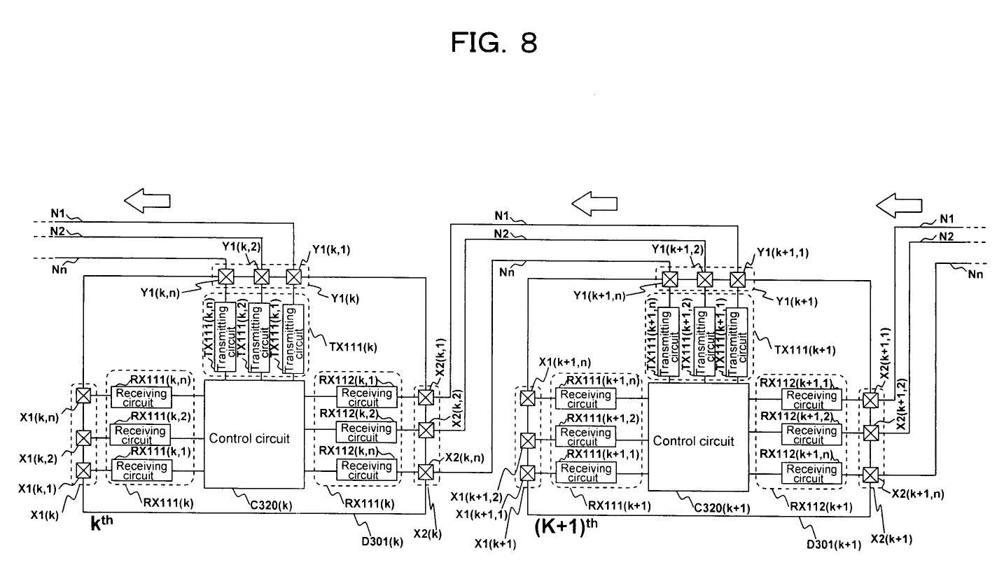

FIG. 7 shows a display drive device comprising two receiving circuit units corresponding to two input units. The display drive device is a display signal transfer device in the forward connection mode wherein the first input unit and the first output unit are sequentially connected to transfer the signal. A control circuit C320 (k) comprises an input selection switchover circuit to relate two receiving circuits to one transmitting circuit. In the control circuit C320 (k), similar to the above control circuit, the latch processing of the display data and the control treatment of the control signal are carried out with the clocks. FIG. 8 shows the display signal transfer device in the backward connection mode opposite to the one in FIG. 7. The display signal transfer device has a constitution in which a second input unit and a first output unit are connected sequentially to transmit the signal.

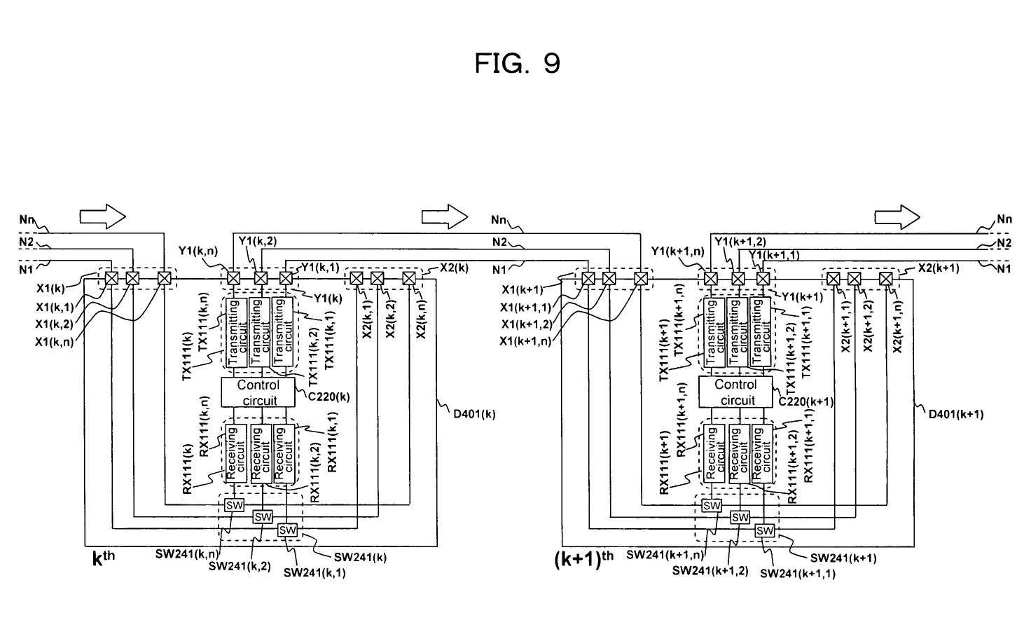

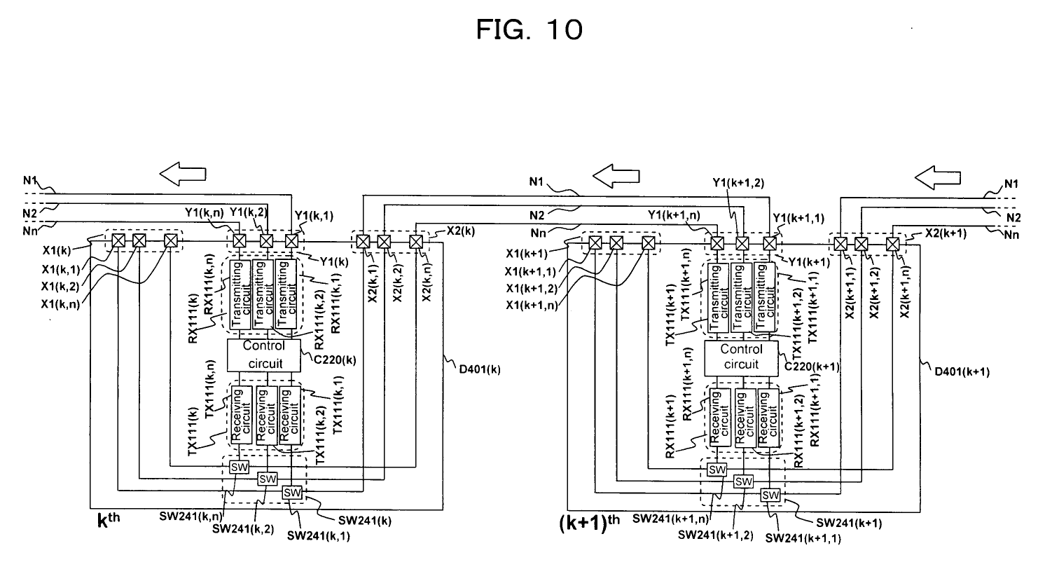

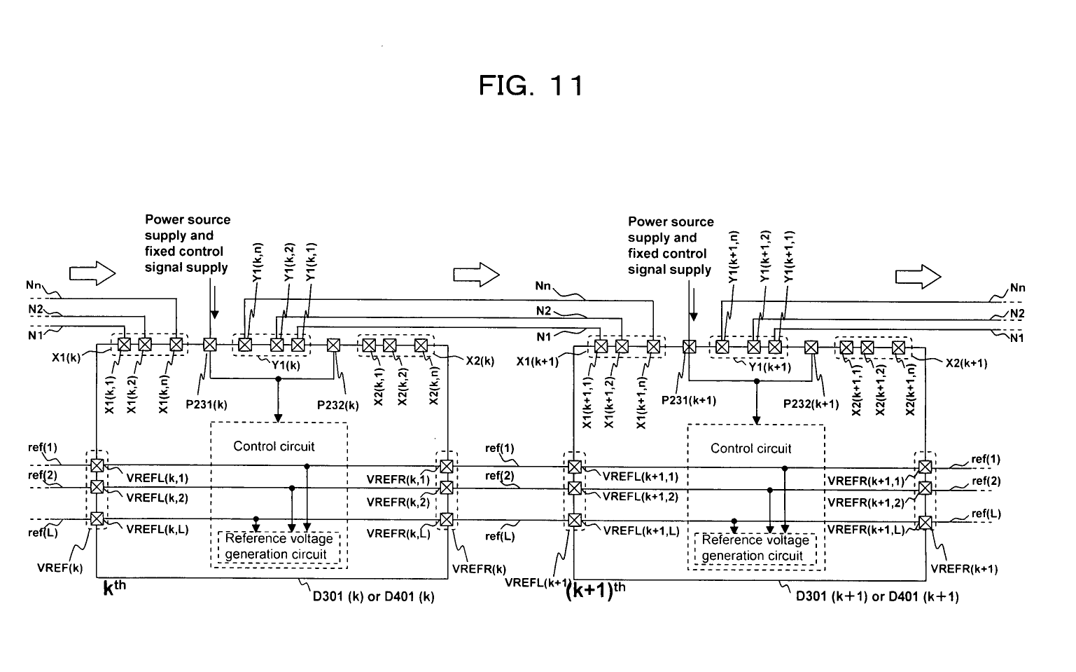

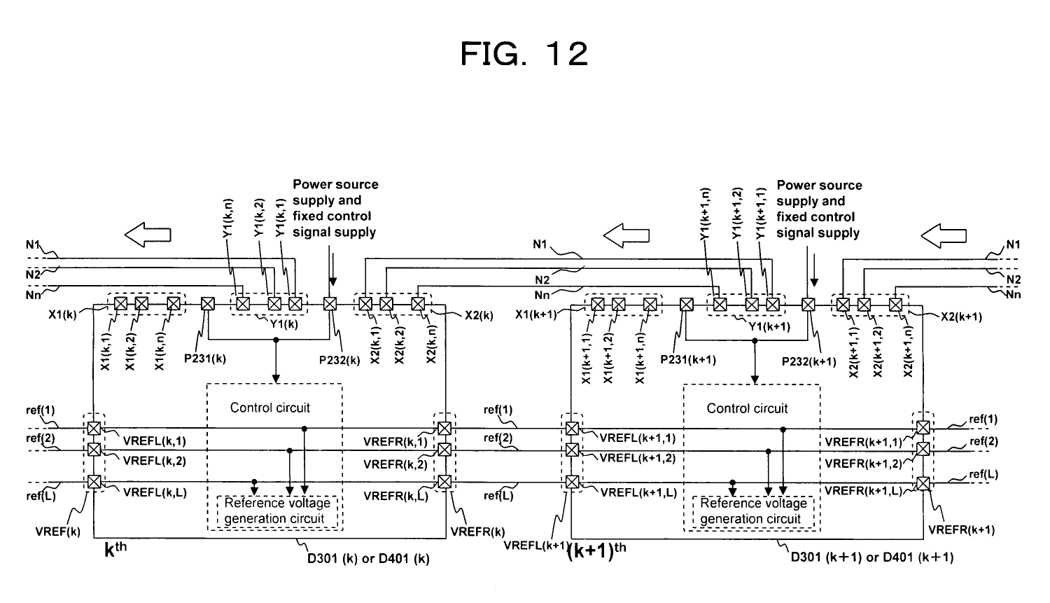

FIG. 9 shows a display drive device comprising one receiving circuit unit corresponding to two input units and an input selection switchover circuit relating the two input units to the control circuit. The display drive device is a display signal transfer device in the forward connection mode in which the first input unit and the first output unit are sequentially connected to transfer the signal. FIG. 10 shows the display drive device in the backward connection mode opposite to the one in FIG. 9. This display drive device comprises a constitution in which the second input unit and the first output unit are sequentially connected to transfer the signal. In addition, FIGS. 11 and 12 show constitution examples in which a power source is connected in the forward connection mode and the backward connection mode respectively.

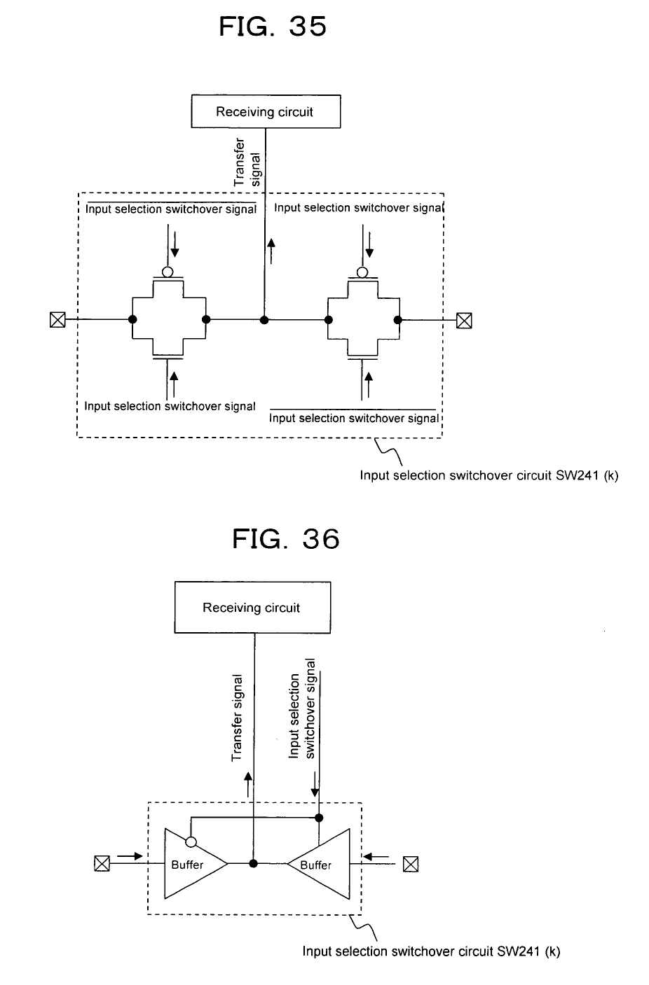

FIGS. 33 and 34 show constitution examples of an input selection switchover circuit provided in the control circuit C320 (k). In these examples, one of two receiving circuits is selected based on the input selection switchover circuit and the signal received in the selected receiving circuit is outputted to the control circuit as a transfer signal. FIGS. 35 and 36 show the constitution examples of the input selection switchover circuit SZ9241 (k) shown in FIGS. 9 and 10, and in these constitutions, one of two input units and the receiving circuit are related.

<Effect>

As described above, according to the display drive device and the display signal transfer device in this embodiment, since one input unit and two output units are provided, connections of the plurality of display drive devices can be changed depending on the transfer direction. Thus, the signal can be transmitted in the cascade connection in both directions similar to the conventional technique and by sharing the receiving circuit unit, the setting area of the receiving circuit unit can be reduced by half. Furthermore, by sharing the transmitting circuit unit, the setting area of the receiving circuit unit and the transmitting circuit can be reduced by half. As a result, the const is reduced, and the power consumption is also reduced.

Furthermore, it is possible to control the display signal transfer device more effectively based on the following operation,

by constantly stopping the transmitting operation of the last-stage transmitting circuit in the display signal transfer device,

by transmitting a signal in a transmitting circuit comprising a function to stop the signal involving the next-stage and following display drive devices,

by receiving the signal with the receiving circuit comprising a function to stop the operation of the signal involving the relevant display drive device,

by controlling the function to stop all of the circuits constituting the display drive device based on the control signal, and

by providing a constitution in which a clock signal and the like, that is common to each display drive device, is transferred from the first stage to the last stage constantly.

Furthermore, by arranging the input unit, the output unit and the power source unit at the above-described positions, the plurality of display drive devices can be connected to the power source unit without crossing the transfer signal wirings that cascade-connect the plurality of display drive devices to each other. Moreover, the power source supplying wirings can be connected to each other without intersecting with the transfer signal wirings. As a result, the plurality of transfer signals and the power source supplying wirings can be arranged in a single-layer state instead of a multilayer state. Thus, according to this embodiment, the display signal transfer device comprising a display drive device having the above-described terminal arrangement can be brought down costs.

### Second Embodiment

<Constitution>

FIG. 46 shows constitutions of a display signal transfer device, and k-th and (k+1) th display drive devices according to a second embodiment. The display signal transfer device according to this embodiment comprises M pieces of display drive devices. The k-th display drive device D701 (k) comprises input/output units Z1 (k) and Z2 (k), a receiving circuit unit RX111 (k) corresponding to the input/output unit Z1 (k) or Z2 (k), a transmitting circuit unit TX111 (k) corresponding to the input/output unit Z1 (k), a transmitting circuit unit TX112 (k) corresponding to the input/output unit Z2 (k), and a control circuit C420 (k). The input/output units Z1 (k) and Z2 (k) comprise n pieces of input/output terminals Z1 (k, 1) to Z1 (k, n) and Z2 (k, 1) to Z2 (k, n) respectively. The receiving circuit unit RX111 (k) comprises n receiving circuits RX111 (k, 1) to RX111 (k, n). The transmitting circuit unit TX111 (k) comprises n pieces of transmitting circuits TX111 (k, 1) to TX111 (k, n). The transmitting circuit unit TX112 (k) comprises n pieces of transmitting circuits TX112 (k, 1) to TX112 (k, n). In addition, the display drive device comprises a power source unit P331 (k) for power supply. The power source unit P331 (k) supplies electricity of a power source or a fixed control signal to the receiving circuit, transmitting circuit and the control circuit that constitute the device. The input/output units Z1 (k) and Z2 (k) are arranged on one side in the periphery of the k-th display drive device D701 (k), and the power source unit P331 (k) is arranged between the input/output unit Z1 (k) and the input/output unit Z2 (k) at the periphery. Each of the receiving circuit unit RX111 (k), and transmitting circuit unit TX111 (k) and TX112 (k) are connected to the control circuit C420 (k).

The display drive device D701 (k) comprises a reception selection switch over circuit unit SWR141 (k), a transmission selection switchover circuit unit SWT241 (k) and a transmission selection switchover circuit unit SWT242 (k). The reception selection switchover circuit unit SWR141 (k) corresponds the receiving circuit unit RX111 (k) to the input/output unit Z1 (k) or Z2 (k). The transmission selection switchover circuit unit SWT241 (k) connects the input/output unit Z1 (k) to the transmitting circuit unit TX111 (k). The transmission selection switchover circuit unit SWT242 (k) corresponds the input/output unit Z2 (k) to the transmitting circuit unit TX112 (k).

The receiving circuit unit RX111 (k, 1) is connected to the reception selection switchover circuit SWR141 (k, 1). The reception selection switchover circuit SWR141 (k, 1) is connected to the input/output terminals Z1 (k, 1) and Z2 (k, 1). The receiving circuit RX111 (k, 2) is connected to the reception selection switchover circuit SWR141 (k, 2). The reception selection switchover circuit SWR141 (k, 2) is connected to the input/output terminals Z1 (k, 2) and Z2 (k, 2). The receiving circuit RX111 (k, n) is connected to the reception selection switchover circuit SWR141 (k, n). The switchover circuit SWR141 (k, n) is connected to the input/output terminals Z1 (k, n) and Z2 (k, n). The transmitting circuit TX111 (k, 1) is connected to the transmission selection switchover circuit SWT241 (k, 1). The transmission selection switchover circuit SWT 241 (k, 1) is connected to the input/output terminal Z1 (k, 1). The transmitting circuit TX111 (k, 2) is connected to the transmission selection switchover circuit SWT 241 (k, 2). The transmission selection switchover circuit SWT241 (k, 2) is connected to the input/output terminal Z1 (k, 2). The transmitting circuit TX111 (k, n) is connected to the transmission selection switchover circuit SWT241 (k, n). The transmission selection switchover circuit SWT241 (k, n) is connected to the input/output terminal Z1 (k, n). The transmitting circuit TX112 (k, 1) is connected to the transmission selection switchover circuit SWT242 (k, 1). The transmission selection switchover circuit SWT242 (k, 1) is connected to the input/output terminal Z2 (k, 1). The transmitting circuit TX112 (k, 2) is connected to the transmission selection switchover circuit SWT242 (k, 2). The transmission selection switchover circuit SWT242 (k, 2) is connected to the input/output terminal Z2 (k, 2). The transmitting circuit TX112 (k, n) is connected to the transmission selection switchover circuit SWT242 (k, n). The transmission selection switchover circuit SWT242 (k, n) is connected to the input/output terminal Z2 (k, n).

The reception selection switchover circuit SWR141 (k) and the transmission selection switchover circuits SWT241 (k) and SWT242 (k) have connection configurations such as a forward connection mode and a backward connection mode. According to the forward connection mode, the receiving circuit unit RX111 (k) and the input/output unit Z1 (k) are connected so as to correspond to each other by the reception selection switchover circuit SWR141 (k). According to the backward connection mode, the receiving circuit unit RX111 (k) and the input/output unit Z2 (k) are connected so as to correspond to each other. In addition, in the forward connection mode, the transmitting circuit unit TX112 (k) and the input/output unit Z2 (k) are connected so as to correspond to each other by the transmission selection switchover circuit SWT242 (k). In the backward connection mode, the transmitting circuit unit TX111 (k) and the input/output unit Z1 (k) are connected so as to correspond to each other by the transmission selection switchover circuit SWT241 (k).

An input/output unit Z1 (k+1) in a (k+1)th display drive device D701 (k+1) corresponds to the input/output unit Z1 of the k-th display drive device D701 (k). Similarly, an input/output unit Z2 (k+1), a receiving circuit unit RX111 (k+1), a transmitting circuit unit TX111 (k+1) or TX112 (k+1), a control circuit C420 (k+1), a power source unit P131 (k+1), a reception selection switchover circuit SWR141 (k+1), and transmission selection switchover circuits SWT241 (k+1) and SWT242 (k+1) in the (k+1)th display drive device D701 (k+1) correspond to the input/output unit Z2 (k), the receiving circuit unit RX111 (k), the transmitting circuit unit TX111 (k) or TX112 (k), the control circuit C420 (k), the power source unit P131 (k), the reception selection switchover circuit SWR141 (k), and the transmission selection switchover circuits SWT241 (k) and SWT242 (k) in the k-th display drive device D701 (k).

<Receiving Circuit Unit>

In the receiving circuit unit RX111 (k), the receiving circuits RX111 (k, 1) to RX111 (k, n) of the receiving circuit unit TX111 (k) corresponding to the input/output terminals Z1 (k, 1) to Z1 (k, n) and Z2 (k, 1) to Z2 (k, n) receive transfer signals N1 to Nn from the input/output terminals Z1 (k, 1) to Z1 (k, n) of the input/output unit Z1 (k) or the input/output terminals Z2 (k, 1) to Z2 (k, n) of the input/output unit Z2 (k). The transfer signals N1 to Nn received by the receiving circuits RX111 (k, 1) to RX111 (k, n) are sent to the control circuit C420 (k). The receiving circuits RX111 (k, 1) to RX111 (k, n) perform receiving operations and reception stopping operations based on the control signal.

FIGS. 38 to 40 show the constitution examples of the receiving circuit unit. The receiving circuit unit is arranged at the middle portion of the longitudinal side in the periphery of the display drive device. In addition, it is preferable that the two input/output units of the receiving circuit unit are arranged so as to be symmetrical with each other.

<Control Circuit>

The transfer signals N1 to Nn received by the receiving circuit unit RX111 (k) are inputted to the control circuit C420 (k). The control circuit C420 (k) sends the transfer signals N1 to Nn to the transmitting circuit unit TX111 (k) or TX112 (k) in order to output them to the outside of the display drive device D701 (k). The control circuit C420 (k) comprises an output selection switchover circuit shown in FIG. 23 to send the transfer signals N1 to Nn from the control circuit C420 (k) to the transmitting circuit unit TX111 (k) or TX112 (k).

FIGS. 25 to 27 show the constitution examples of the transmission selection switchover circuit. The control circuit C420 (k) sends the transfer signals N1 to Nn to the transmitting circuit unit TX111 (k) or TX112 (k) based on the control signal of the output selection switchover signal. At this time, there are a forward connection mode and a backward connection mode as the connection mode (shape). The control circuit C420 (k) sends the transfer signals N1 to Nn to the transmitting circuit unit TX112 (k) in the forward connection mode and sends the transfer signals N1 to Nn to the transmitting circuit unit TX111 (k) in the backward connection mode.

<Transmitting Circuit Unit>

The transmitting circuit unit TX111 (k) is provided so as to correspond to the input/output unit Z1 (k), and the transmitting circuit unit TX112 (k) is provided so as to correspond to the input/output unit Z2 (k). The n pieces of transfer signals N1 to Nn outputted from the control circuit C420 (k) are inputted to the transmitting circuit unit TX111 (k) or TX112 (k). The transmitting circuit unit TX111 (k) transmits the transfer signals N1 to Nn from the transmitting circuits TX111 (k, 1) to TX111 (k, n) to the transmission selection switchover circuits SWT241 (k, 1) to SWT241 (k, n) of the transmission selection switchover circuit unit SWT241 (k). In addition, the transmitting circuit unit TX112 (k) transmits the transfer signals N1 to Nn from the transmitting circuits TX112 (k, 1) to TX112 (k, n) to the transmission selection switchover circuit SWT242 (k, 1) to SWT242 (k, n) of the transmission selection switchover circuit unit SWT242 (k). The transmitting circuits TX111 (k, 1) to TX111 (k, n) and the transmitting circuits TX112 (k, 1) to TX112 (k, n) perform transmitting operations and transmission stopping operations based on the control signal.

FIGS. 41 to 43 show the constitution examples of the transmitting circuit. It is preferable that the transmitting circuits are provided symmetrically with respect to the receiving circuit unit and the control circuit in the vicinity of their input/output units.

<Reception Selection Switchover Circuit>

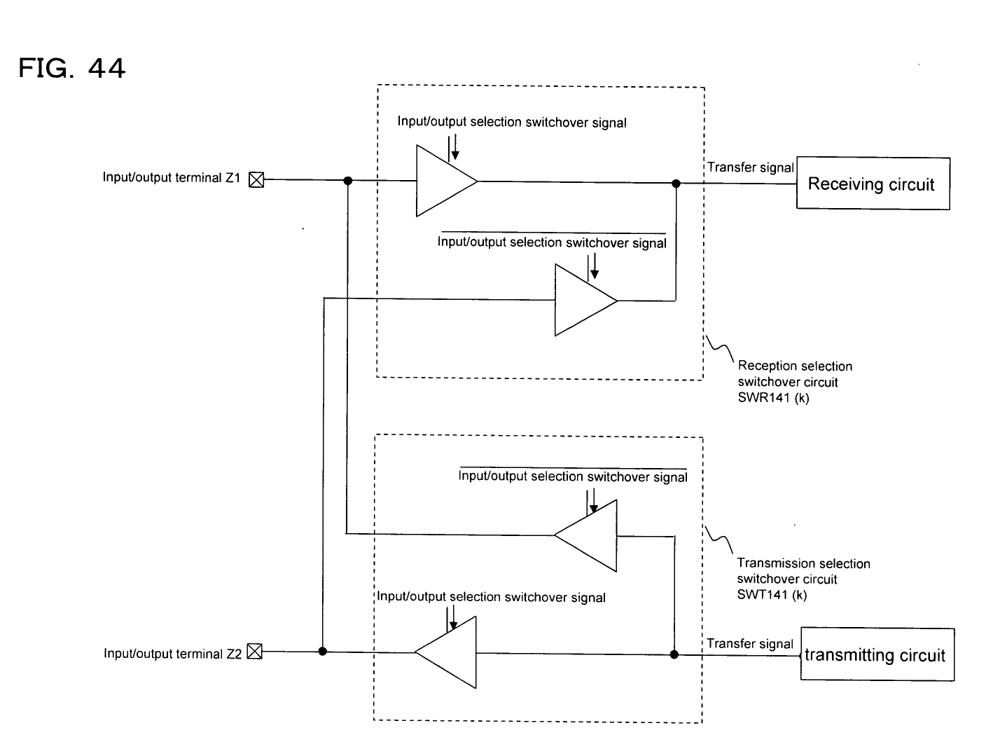

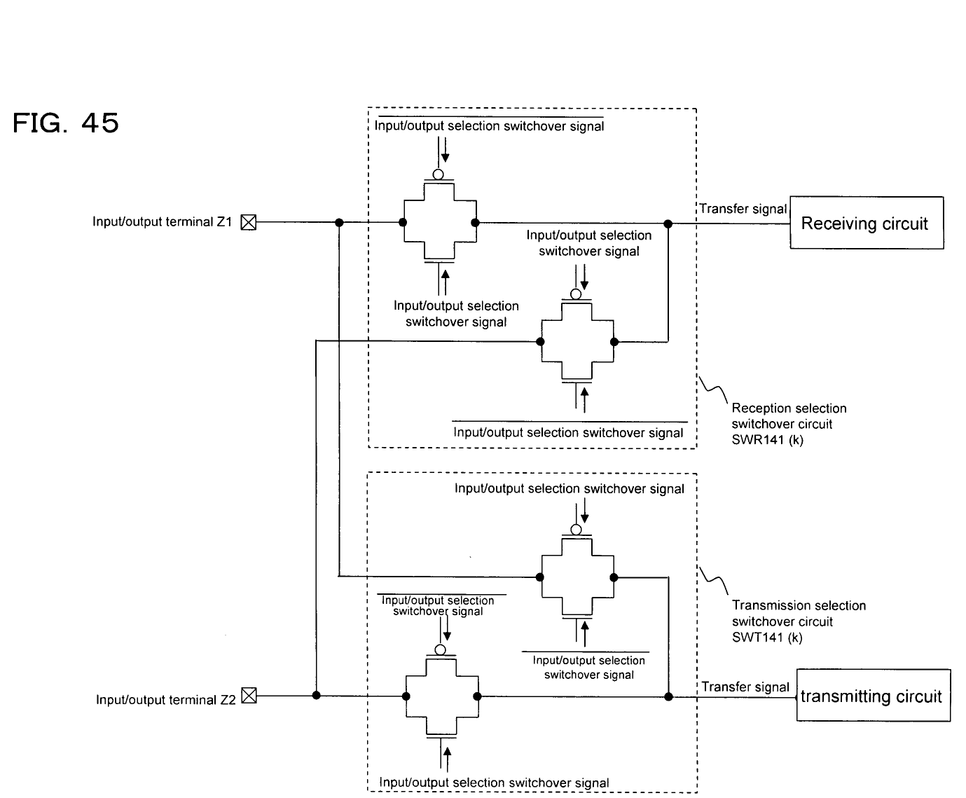

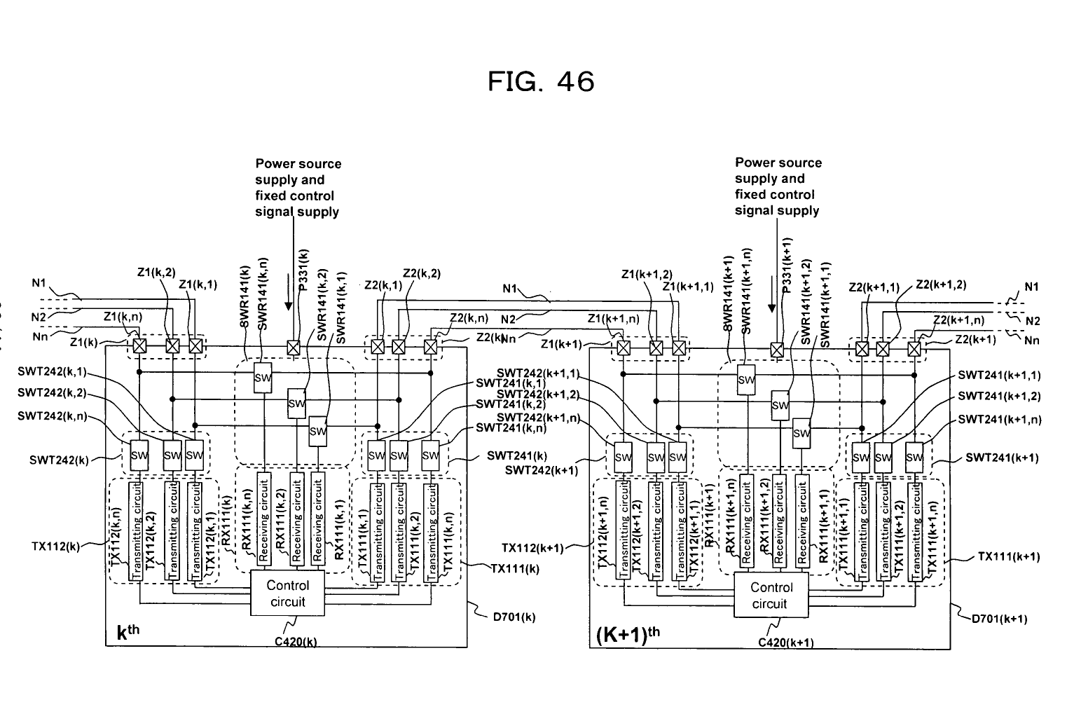

FIGS. 44 and 45 show constitution examples of the reception selection switchover circuit. The reception selection switchover circuit has a forward connection mode and a backward connection mode based on the control signal as an operation mode.

<Forward Connection Mode>

When the reception selection switchover circuit SWR141 (k) is in the forward connection mode in the display drive device D701 (k), the receiving circuit unit RX111 (k) is connected so as to correspond to the input/output Z1 (k) and the receiving circuits RX111 (k, 1) to RX111 (k, n) are connected so as to correspond to the input/output terminals Z1 (k, 1) to Z1 (k, n), respectively.

<Backward Connection Mode>

When the reception selection switchover circuit SWR141 (k) is in the backward connection mode, the receiving circuit unit RX111 (k) is connected so as to correspond to the input/output Z2 (k) and the receiving circuits RX111 (k, 1) to RX111 (k, n) are connected so as to correspond to the input/output terminals Z2 (k, 1) to Z2 (k, n), respectively.

<Transmission Selection Switchover Circuit>

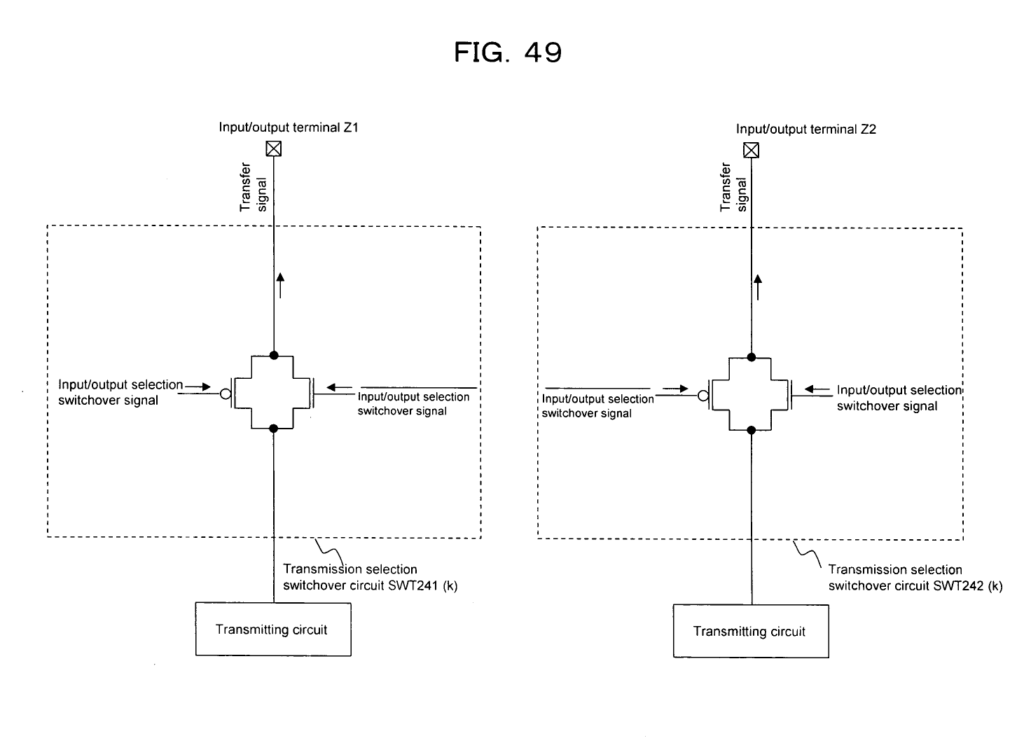

FIG. 49 shows the constitution example of the transmission selection switchover circuit. Similar to the reception selection switchover circuit, the transmission selection switchover circuit has a forward connection mode and a backward connection mode based on the control signal.

<Forward Connection Mode>

When the display drive device D701 (k) is in the forward connection mode, the transmission selection switchover circuit SWT242 (k) correspondingly connects the transmitting circuit unit TX112 (k) and the input/output unit Z2 (k) and the transmitting circuits TX112 (k, 1) to TX112 (k, n) are correspondingly connected to the input/output terminals Z2 (k, 1) to Z2 (k, n), respectively. At this time, the transmission selection switchover circuit SWT241 (k) is not connected so as to correspond to the input/output unit Z1 (k) and the transmission selection switchover circuit SWT241 (k) becomes high impedance in view of the input/output unit Z1 (k).

<Backward Connection Mode>

When the display drive device D701 (k) is in the backward connection mode, the transmission selection switchover circuit SWT241 (k) correspondingly connects the transmitting circuit unit TX111 (k) and the input/output unit Z1 (k) and the transmitting circuits TX111 (k, 1) to TX111 (k, n) are correspondingly connected to the input/output terminals Z1 (k, 1) to Z1 (k, n), respectively. At this time, the transmission selection switchover circuit SWT242 (k) is not correspondingly connected to the input/output unit Z2 (k) and the transmission selection switchover circuit SWT242 (k) becomes high impedance in view of the input/output unit Z2 (k).

<Terminal Arrangement>

The input/output units Z1 (k) and Z2 (k) are arranged on one side in the periphery of the k-th display drive device D701 (k). In addition, the power source unit P331 (k) is arranged between the input/output unit Z1 (k) and the input/output unit Z2 (k) at the above periphery. At this time, the input/output unit Z1 (k), the power source unit P331 (k), and the input/output unit Z2 are aligned in this order.

In addition, the input/output terminals Z1 (k, 1) to Z1 (k, n) of the input/output unit Z1 (k) and the input/output terminals Z2 (k, 1) to Z2 (k, n) of the input/output unit Z2 (k), having n pieces of units respectively, are arranged in the order of input/output terminal Z1 (k, 1), Z1 (k, 2), . . . , Z1 (k, n) in the periphery of the k-th display drive device D701 (k). Thus, the input/output terminals Z2 (k, 1) to Z2 (k, n) are arranged in the order of the input/output terminals Z2 (k, 1), Z2 (k, 2), . . . , Z2 (k, n) from the side close to the input/output terminal Z1 (k, 1) along the periphery.

<Cascade Connection>

Next, a description will be given in detail to a display signal transfer device that comprises the plurality of display drive devices so as to transfer a signal sequentially by cascade-connecting them to each other. As shown in FIG. 46, in order to transfer the transfer signals N1 to Nn between the respective display drive devices, the input/output terminals Z2 (k, 1) to Z2 (k, n) of the input/output unit Z2 (k) of the k-th display drive device D701 (k) and the input/output terminals Z1 (k+1, 1) to Z1 (k+1, n) of the input/output unit Z1 (k+1) of the (k+1) th display drive device D701 (k+1) are connected by wiring. In the (k+2)th display drive device also, the cascade connection is sequentially implemented in input/output units Z1 (k+2) and Z2 (k+2) similarly, whereby the following display signal transfer device is constituted.

<Operation>

Next, the operations of the display drive device and the display signal transfer device shown in FIG. 46 will be described.

<Forward Connection Mode>

In the forward connection mode, according to the display signal transfer device in which the transfer signal is transferred from the first-stage display drive device to the last-stage M-th display drive device, the transfer signals N1 to Nn transmitted from the previous-stage (k−1) th display drive device are inputted to the input/output terminals Z1 (k, 1) to Z1 (k, n) of the input/output unit Z1 (k) of the k-th display drive device D701 (k) respectively and then the transfer signals N1 to Nn are received by the receiving circuits RX111 (k, 1) to RX111 (k, n) of the receiving circuit unit RX111 (k). At this time, the reception selection switchover circuit SWR141 (k) connects so as to correspond the receiving circuit unit RX111 (k) to the input/output unit Z1 (k).

The received transfer signals N1 to Nn are sent to the control circuit C420 (k), and here a latch processing of the display data and a control treatment of the control signal are carried out based on clocks. In order to transfer them to the (k+1)th display drive device D701 (k+1), the control circuit C420 (k) sends the transfer signals N1 to Nn to the transmitting circuits TX112 (k, 1) to TX112 (k, n) of the transmitting circuit unit TX112 (k). At this time, the transmission selection switchover circuit SWT242 (k) corresponds the transmitting circuit unit TX112 (k) to the input/output unit Z2 (k) and the transfer signals N1 to Nn are outputted from the input/output terminals Z2 (k, 1) to Z2 (k, n) of the output unit Z2 (k) to the outside of the display drive device D701 (k). In addition, at this time, the transmitting circuit unit TX111 (k) and the input/output unit Z2 (k) are not connected by the transmission selection switchover circuit SWT241 (k), and the transmitting circuits TX111 (k, 1) to TX111 (k, n) of the transmitting circuit unit TX111 (k) become high impedance in view of the input/output terminals Z1 (k, 1) to Z1 (k, n) of the input/output unit Z1 (k).

The transfer signals N1 to Nn outputted from the input/output terminals Z2 (k, 1) to Z2 (k, n) of the input/output unit Z2 (k) of the display drive device D701 (k) are inputted to the input/output terminals Z1 (k+1, 1) to Z1 (k+1, n) of the input/output unit Z1 (k+1) of the (k+1) th display drive device D701 (k+1). The inputted transfer signals N1 to Nn are received by receiving circuits RX111 (k+1, 1) to RX111 (k+1, n) of the receiving circuit unit RX111 (k+1) of the display drive device D701 (k+1) respectively. At this time, the reception selection switchover circuit SWR141 (k+1) corresponds the receiving circuit unit TX111 (k+1) to the input/output unit Z1 (k+1).

In addition, while a latch processing of the transfer signals N1 to Nn are carried out in the k-th display drive device D701 (k), the transmitting operation of the transmitting circuit unit TX112 (k) of the display drive device D701 (k) is stopped and additionally the receiving operation of the receiving circuit unit RX111 (k+1) of the (k+1) th display drive device D701 (k+1) is stopped so that the transfer signals N1 to Nn are not transmitted to the (k+1)th and following display drive devices. Then, in a period immediately before the latching process of the transfer signals N1 to Nn is completed in the k-th display drive device D701 (k), the transmission of the transmitting circuit unit TX112 (k) is activated. In a period immediately before the latching operation is started in the (k+1)th display drive device D701 (k+1), the receiving operation of the receiving circuit unit RX111 (k+1) of the (k+1)th display drive device D701 (k+1) is activated. While a latch processing of the transfer signals N1 to Nn are carried out in the (k+1)th display drive device D701 (k+1), the transmitting operation of the transmitting circuit unit TX112 (k) of the display drive device D701 (k) is activated and additionally the receiving operation of the receiving circuit unit RX111 (k+1) of the (k+1) th display drive device D701 (k+1) is activated so that the signal is transmitted in the display drive device preceding the (k+1) th display drive device. Thus, in a period after the latching process of the transfer signals in the (k+1) th display drive device D701 (k+1) is completed, the receiving operation of the receiving circuit unit RX111 (k+1) is stopped and in synchronization with it, the transmitting circuit unit TX112 (k) of the k-th display drive device D701 (k) is stopped. Thus, the signal is sequentially transmitted between the following display drive devices in a similar manner as described above.

Furthermore, the operations of the receiving circuit and the transmitting circuit in which at least one path of the clock signal or the control signal that are common to the display drive device is arranged are constantly activated, and the operations of the receiving circuit and the transmitting circuit involving the transfer of the signal other than the above signals are all stopped. Furthermore, in the last-stage M-th display drive device, the transmitting operation of the transmitting circuit TX112 (M) is constantly stopped.

The transmitting circuit in which the signal transfer is stopped is in a high-impedance output state or a fixed signal transmitting state. For example, while the signal transfer is stopped, the single-end signals Vin1 and Vin2 are separated in FIG. 41, and the high-impedance output state is provided by an enable signal in FIG. 42, and the signal-end signal Vout becomes a fixed signal by the control signal in FIG. 43.

<Backward Connection Mode>

In the backward connection mode, the signal is transferred in the direction opposite to that in the forward connection mode. According to the display signal transfer device in which the transfer signal is transferred from its first stage to the last stage in the display drive devices, the transfer signals N1 to Nn are inputted to the input/output terminals Z2 (k+1, 1) to Z2 (k+1, n) of the input/output unit Z2 (k+1) of the (k+1) th display drive device D701 (k+1) from the M-th display drive device, respectively and then received by the receiving circuits RX111 (k+1, 1) to RX111 (k+1, n) of the receiving circuit unit RX111 (k+1). At this time, the reception selection switchover circuit SWR141 (k+1) corresponds the receiving circuit unit RX111 (k+1) to the input/output unit Z2 (k+1).

The received transfer signals N1 to Nn are sent to the control circuit C420 (k+1), and a latch processing of the display data and a control treatment of the control signal are carried out based on clocks in the control circuit C420 (k+1). In order to transfer them to the k-th display drive device D701 (k), the control circuit C420 (k+1) sends the transfer signals N1 to Nn to the transmitting circuits TX111 (k+1, 1) to TX111 (k+1, n) of the transmitting circuit unit TX111 (k+1). At this time, the transmission selection switchover circuit SWT241 (k+1) corresponds the transmitting circuit unit TX111 (k+1) to the input/output unit Z1 (k+1). The transfer signals N1 to Nn are outputted from the input/output terminals Z1 (k+1, 1) to Z2 (k+1, n) of the output unit Z1 (k+1) to the outside of the display drive device D701 (k+1).

In addition, at this time, the transmitting circuit unit TX112 (k+1) and the input/output unit Z2 (k+1) are not connected by the transmission selection switchover circuit SWT242 (k+1), and the transmitting circuits TX112 (k+1, 1) to TX112 (k+1, n) of the transmitting circuit unit TX112 (k+1) become high impedance in view of the input/output terminals Z2 (k+1, 1) to Z1 (k+1, n) of the input/output unit Z2 (k+1).

The transfer signals N1 to Nn outputted from the input/output terminals Z1 (k+1, 1) to Z1 (k+1, n) of the input/output unit Z1 (k+1) of the display drive device D701 (k+1) are inputted to the input/output terminals Z2 (k, 1) to Z2 (k, n) of the input/output unit Z2 (k) of the k-th display drive device D701 (k). The inputted transfer signals N1 to Nn are received by the receiving circuits RX111 (k, 1) to RX111 (k, n) of the receiving circuit unit RX111 (k) of the display drive device D701 (k) respectively. At this time, the reception selection switchover circuit unit SWR141 (k) corresponds the receiving circuit unit TX111 (k) to the input/output unit Z2 (k).

In addition, when a latch processing is carried out to the transfer signals treated in the (k+1)th display drive device D701 (k+1), the transmitting operation of the transmitting circuit unit TX111 (k+1) of the display drive device D701 (k+1) is stopped and the receiving operation of the receiving circuit unit RX111 (k) of the k-th display drive device D701 (k) is stopped so that the transfer signals N1 to Nn are not transmitted to the k-th and following display drive devices. Then, in a period immediately before the latching process of the transfer signals, that is treated in the (k+1)th display drive device D701 (k+1), is completed, the transmission of the transmitting circuit unit TX111 (k+1) is activated and at a time immediately before the latching operation is started in the k-th display drive device D701 (k), the receiving operation of the receiving circuit unit RX111 (k) of the k-th display drive device D701 (k) is activated.

While a latch processing is carried out to the transfer signal treated in the k-th display drive device D701 (k), the transmitting operation of the transmitting circuit unit TX111 (k+1) of the display drive device D701 (k+1) is activated and the receiving operation of the receiving circuit unit RX111 (k) of the k-th display drive device D701 (k) is activated so that the signal is transmitted in the display drive device preceding the k-th display drive device. Thus, in a period after the latching process of the transfer signals treated in the k-th display drive device D701 (k) is completed, the receiving operation of the receiving circuit unit RX111 (k) is stopped and in synchronization with it, the transmitting circuit unit TX111 (k+1) of the (k+1) th display drive device D701 (k+1) is stopped. Thus, the signal is sequentially transmitted between the following display drive devices in a similar manner as described above.

Furthermore, the operations of the receiving circuit and the transmitting circuit, in which at least one path of the clock signal or the control signal that is common to the display drive device is arranged, are constantly activated, and the operations of the receiving circuit and the transmitting circuit involving the transfer of the signal other than the above signals are all stopped based on the control signal. Furthermore, in the last-stage first display drive device, the transmitting operation of the transmitting circuit TX111 (1) is constantly stopped.

The transmitting circuit in which the signal transfer is stopped is in a high-impedance output state or a fixed signal transmitting state. For example, while the signal transfer is stopped, the single-end signals Vin1 and Vin2 are separated in FIG. 41, and the high-impedance output state is provided by the enable signal in FIG. 42, and the signal-end signal Vout becomes a fixed signal transmitting state by the control signal in FIG. 43.

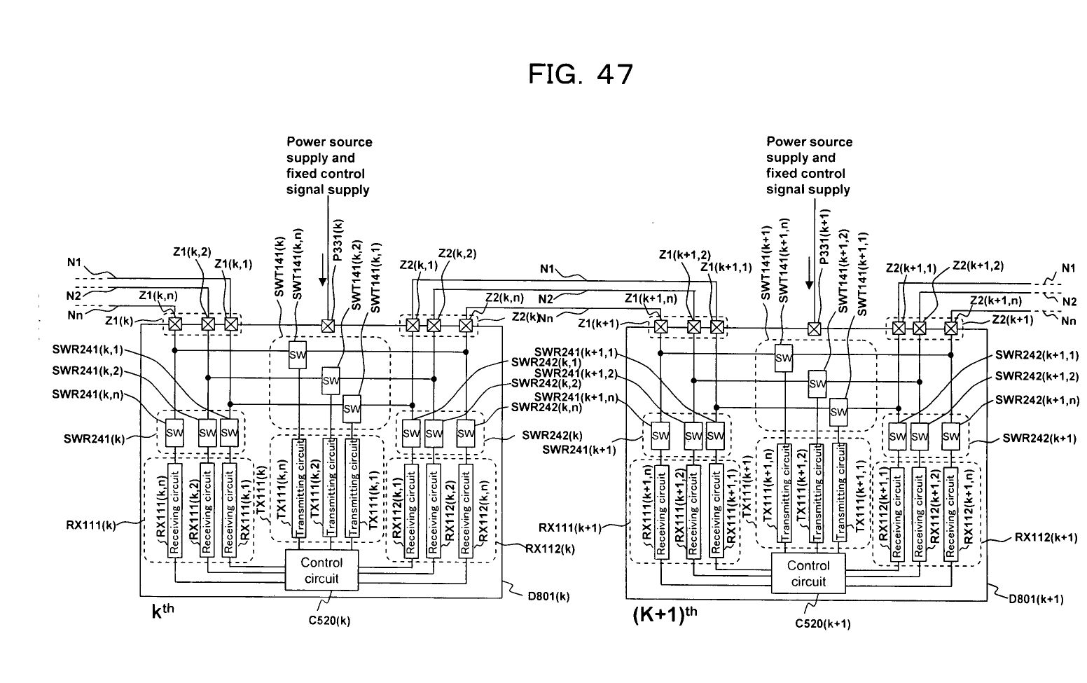

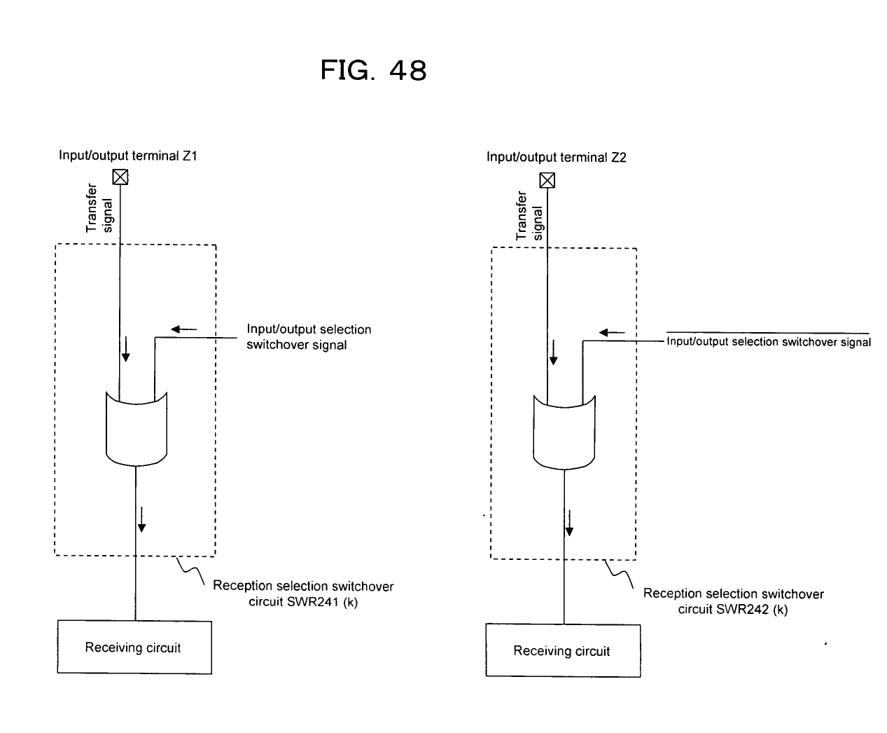

According to the second embodiment, the display drive device with two input/output units comprises one receiving circuit unit, two transmitting circuit units (corresponding to the receiving circuit unit), one reception selection switchover circuit, and two transmission selection switchover circuits. Meanwhile, FIG. 47 shows the constitution example a display drive device with two input/output units and comprising two receiving circuit units, one transmitting circuit unit (corresponding to the receiving circuit units), two reception selection switchover circuits and one transmission selection switchover circuit in a display drive device with two input/output units, as an embodiment in which the receiving circuit and the transmitting circuit are reversed. FIG. 48 shows the constitution example of the reception selection switchover circuit.

FIG. 47 shows the k-th display drive device comprising two receiving circuit units RX111 (k) and RX112 (k) corresponding to the two input/output units Z1 (k) and Z2 (k), in which the input/output units Z1 (k) and Z2 (k) are sequentially connected to transfer signals. In a control circuit C520 (k), a latch processing of the transfer signal (display data) or a control treatment of the control signal is carried out with clocks in a similar manner to the above-described control circuit. The display drive device comprises a reception selection switchover circuit SWR241 (k) corresponding the input/output unit Z1 (k) to the receiving circuit unit RX111 (k), a reception selection switchover circuit SWR242 (k) corresponding the input/output unit Z2 (k) to the receiving circuit unit RX112 (k), and a transmission selection switchover circuit SWT141 (k) corresponding the input/output unit Z1 (k) or Z2 (k) to the transmitting circuit TX111 (k).

In the forward connection mode in which the signal is transferred from the k-th display drive device to the (k+1) th display drive device, the input/output unit Z1 (k) and the reception selection switchover circuit SWR241 (k) are corresponded so that the receiving circuit unit RX111 (k) receives the transfer signals N1 to Nn. In order to transfer them to the (k+1) th display drive device, the control circuit D520 (k) sends the transfer signals N1 to Nn to the transmitting circuit unit TX111 (k). The transmitting circuit unit TX111 (k) and the input/output unit Z2 (k) are corresponded by the transmission selection switchover circuit SWT141 (k). At this time, the receiving operation of the receiving circuit unit RX112 (k) is not stopped or the input/output unit Z2 (k) and the receiving circuit unit RX112 (k) are not corresponded. The signal is sequentially transferred in the (k+1)th and following display drive devices.

In the backward connection mode in which the signal is transferred from the (k+1)th display drive device to the k-th display drive device, the input/output unit Z2 (k+1) and the reception selection switchover circuit SWR242 (k+1) are corresponded so that the receiving circuit unit RX112 (k) receives the transfer signals N1 to Nn. In order to transfer them to the k-th display drive device, the control circuit D520 (k+1) sends the transfer signals N1 to Nn to the transmitting circuit unit TX111 (k+1). The transmitting circuit unit TX111 (k+1) and the input/output unit Z1 (k+1) are corresponded by the transmission selection switchover circuit SWT141 (k+1). At this time, the receiving operation of the receiving circuit unit RX111 (k+1) is not stopped and additionally the input/output unit Z1 (k+1) and the receiving circuit unit RX111 (k+1) are not corresponded. The signal is sequentially transferred in the device on and after the k-th display drive devices.

<Effect>

As described above, according to the display drive device and the display signal transfer device in this embodiment, since correspondence between the two input/output units, and transmitting circuit and the receiving circuit can be changed with the reception selection switchover circuit and the transmission selection switchover circuit in accordance with the signal transfer direction, the area of the receiving circuit or the transmitting circuit can be reduced. As a result, reduction of the cost and the power consumption can be achieved.

Furthermore, similar to the first embodiment, the display signal transfer device can be more effectively controlled and the power consumption can be reduced through taking a countermeasure as described below.

by constantly stopping the transmitting operation of the last-stage transmitting circuit in the display signal transfer device,

by transmitting the signal with the transmitting circuit comprising the function to stop the signal involving the display drive devices on and after next-stage,

by receiving the signal in the receiving circuit comprising the function to stop the operation of the signal involving the relevant display drive device,

by controlling the function to stop all of the circuits constituting the display drive device based on the control signal, and

by providing the constitution in which the clock signal and the like common to each display drive device is transferred from the first stage to the last stage constantly.

Furthermore, by arranging the input unit, the output unit and the power source unit at the above-described positions, a plurality of transfer signal wirings that cascade-connect the plurality of display drive devices can be connected to the power source unit without intersecting with each other. Moreover, power source supplying wirings can be connected to each other without intersecting with the transfer signal wirings. As a result, the plurality of transfer signal wirings and the power source supplying wirings can be arranged in a single-layer state instead of a multilayer state. Thus, according to this embodiment, the display signal transfer device comprising the display drive devices having the above-described terminal arrangements can be provided at low cost.

According to the second embodiment, the number of terminals and the device area and the power consumption are reduced more than those of the first embodiment, so that the mounting cost can be lowered. It is preferable that the second embodiment providing the above effect is implemented in the constitution in which the cascade connection wirings are not changed based on the signal transfer direction.

### Third Embodiment

<Constitution>

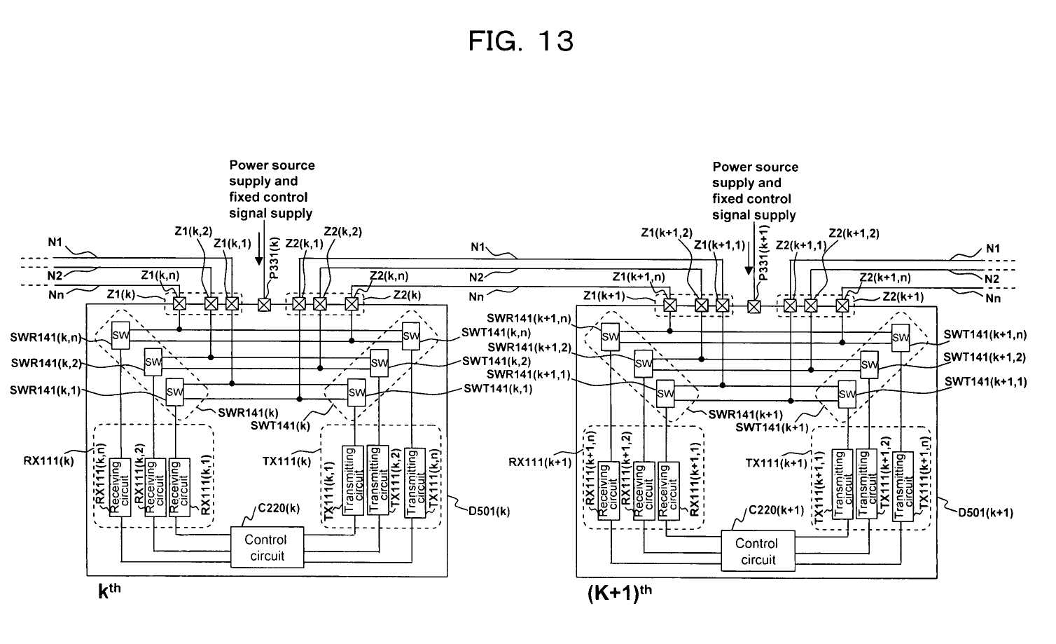

FIG. 13 shows constitutions of a display signal transfer device, and k-th and (k+1) th display drive devices according to a third embodiment. The display signal transfer device according to this embodiment comprises M pieces of display drive devices. The k-th display drive device D501 (k) comprises input/output units Z1 (k) and Z2 (k), a receiving circuit unit RX111 (k) corresponding to the input/output unit Z1 (k) or Z2 (k), a transmitting circuit unit TX111 (k), and a control circuit C220 (k). The input/output units Z1 (k) and Z2 (k) comprise n pieces of input/output terminals Z1 (k, 1) to Z1 (k, n) and Z2 (k, 1) to Z2 (k, n) respectively. The receiving circuit unit RX111 (k) comprises n receiving circuits RX111 (k, 1) to RX111 (k, n). The transmitting circuit unit TX111 (k) comprises n pieces of transmitting circuits TX111 (k, 1) to TX111 (k, n). In addition, the display signal transfer device comprises a power source unit P331 (k). The power source unit P331 (k) supplies electricity of a power source or a fixed control signal to the receiving circuit, the transmitting circuit and the control circuit that constitute the device. The input/output units Z1 (k) and Z2 (k) are arranged on one side in the periphery of the k-th display drive device D501 (k), and the power source unit P331 (k) is arranged between the input/output unit Z1 (k) and the input/output unit Z2 (k) at the periphery.

Each of the receiving circuit unit RX111 (k) and transmitting circuit unit TX111 (k) are connected to the control circuit C220 (k). The display drive device further comprises a reception selection switchover circuit unit SWR141 (k) and a transmission selection switchover circuit unit SWT432 (k). The reception selection switchover circuit unit SWR141 (k) and the transmission selection switchover circuit unit SWT432 (k) connects the receiving circuit unit RX111 (k), the transmitting circuit unit TX111 (k) and the input/output units Z1 (k) and Z2 (k) to each other.

The receiving circuit unit RX111 (k, 1) is connected to the reception selection switchover circuit SWR141 (k, 1). The reception selection switchover circuit SWR141 (k, 1) is connected to the input/output terminals Z1 (k, 1) and Z2 (k, 1). Similarly, the receiving circuit RX111 (k, 2) is connected to the reception selection switchover circuit SWR141 (k, 2). The reception selection switchover circuit SWR141 (k, 2) is connected to the input/output terminals Z1 (k, 2) and Z2 (k, 2). The receiving circuit RX111 (k, n) is connected to the reception selection switch over circuit SWR141 (k, n). The reception selection switchover circuit SWR141 (k, n) is connected to the input/output terminals Z1 (k, n) and Z2 (k, n). The transmitting circuit TX111 (k, 1) is connected to the transmission selection switchover circuit SWT141 (k, 1). The transmission selection switchover circuit SWT141 (k, 1) is connected to the input/output terminals Z2 (k, 1) and Z1 (k, 1). Similarly, the transmitting circuit TX111 (k, 2) is connected to the transmission selection switchover circuit SWT141 (k, 2). The transmission selection switchover circuit SWT141 (k, 2) is connected to the input/output terminals Z2 (k, 2) and Z1 (k,2). The transmitting circuit TX111 (k, n) is connected to the transmission selection switchover circuit SWT141 (k, n). The transmission selection switchover circuit SWT141 (k, n) is connected to the input/output terminals Z2 (k, n) and Z1 (k, n).

An input/output unit Z1 (k+1) in a (k+1)th display drive device D501 (k+1) corresponds to the input/output unit Z1 (k) of the k-th display drive device D501. Similarly, an input/output unit Z2 (k+1), a receiving circuit unit RX111 (k+1), a transmitting circuit unit TX111 (k+1), a control circuit C220 (k+1), a power source unit P331 (k+1), a reception selection control circuit unit SWR141 (k+1), and a transmission selection control circuit unit SWT141 (k+1) in the (k+1)th display drive device D501 (k+1) correspond to the input/output unit Z2 (k), the receiving circuit unit RX111 (k), the transmitting circuit unit TX111 (k), the control circuit C220 (k), the power source unit P331 (k), the reception selection control circuit unit SWR141 (k), and the transmission selection control circuit unit SWT141 (k) in the k-th display drive device D501 (k).

<Receiving Circuit Unit>

The receiving circuits RX111 (k, 1) to RX111 (k, n) of the receiving circuit unit TX111 (k) receive the transfer signals N1 to Nn inputted from one of the input/output terminals Z1 (k, 1) to Z1 (k, n) of the input/output unit Z1 (k) and the input/output terminals Z2 (k, 1) to Z2 (k, n) of the input/output unit Z2 (k). The inputted transfer signals N1 to Nn are sent to the control circuit C220 (k). In addition, the receiving circuits RX111 (k, 1) to RX111 (k, n) perform receiving operations and reception stopping operations based on the control signal.

FIGS. 38 to 40 show the constitution examples of the receiving circuit unit. The receiving circuit is arranged in the center of the display drive device. It is preferable that the two input/output units Z1 (k) and Z2 (k) are arranged so as to be symmetrical with each other.

<Control Circuit>

Similar to the control circuit C220 (k) in the first embodiment, the transfer signals N1 to Nn received by the receiving circuit unit RX111 (k) are inputted to the control circuit C220 (k). The control circuit C220 (k) sends the transfer signals N1 to Nn to the transmitting circuit unit TX111 (k) to output them to the outside.

<Transmitting Circuit>

The transmitting circuit unit TX111 (k) transmits the transfer signals N1 to Nn, that is sent from the control circuit C220 (k), from the transmitting circuits TX111 (k, 1) to TX111 (k, n) of the transmitting circuit unit TX111 (k) respectively in order to output them from the input/output terminal Z1 (k, 1) to Z1 (k, n) of the input/output unit Z1 (k) or the input/output terminals Z2 (k, 1) to Z2 (k, n) of the input/output unit Z2 (k). Correspondence to the input/output unit Z1 (k) or Z2 (k) is performed by the reception selection control circuit SWR141 (k) and the transmission selection control circuit SWT141 (k). The transmitting circuits TX111 (k, 1) to TX111 (k, n) perform transmitting operations and transmission stopping operations based on the control signal.

FIGS. 41 to 43 show the constitution examples of the transmitting circuit. The transmitting circuit unit is arranged in the center of the display drive device similar to the receiving circuit unit. It is preferable that the input/output unit Z1 (k) and the input/output unit Z2 (k) are arranged so as to be symmetrical with each other.

<Terminal Arrangement>

The input/output units Z1 (k) and Z2 (k) are arranged on one side in the periphery of the k-th display drive device D501 (k). In addition, the power source unit P331 (k) is arranged between the input/output unit Z1 (k) and the input/output unit Z2 (k) at the above periphery. At this time, the input/output unit Z1 (k), the power source unit P331 (k), and the input/output unit Z2 are aligned in this order.

In addition, the input/output terminals Z1 (k, 1) to Z1 (k, n) of the input/output unit Z1 (k) and the input/output terminals Z2 (k, 1) to Z2 (k, n) of the input/output Z2 (k) are arranged as follows. That is, the input/output terminals Z1 (k, 1) to Z1 (k, n) a rearranged at the periphery of the display drive device D501 (k) in the order of input/output terminals Z1 (k, 1), Z1 (k, 2), . . . , Z1 (k, n). Thus, the input/output terminals Z2 (k, 1) to Z2 (k, n) are also arranged in the order of Z2 (k, 1), Z2 (k, 2), . . . , Z2 (k, n) at the periphery of the display drive unit D501 (k). Here, it is to be noted that the arrangement orders of the input/output terminals Z1 (k, 1) to Z1 (k, n) and the input/output terminals Z2 (k, 1) to Z2 (k, n) are reversed to each other. That is, in the input/output terminals Z1 (k, 1) to Z1 (k, n), the terminal number is increased toward the left and meanwhile, in the input/output terminals Z2 (k, 1) to Z2 (k, n), the terminal number is increased toward the right in the drawing. The input/output terminal Z1 (k, 1) and the input/output terminal Z2 (k, 1) are adjacent to each other across the power source unit P331 (k).

<Reception Selection Switchover Circuit and Transmission Selection Switchover Circuit>

The reception selection switchover circuit SWR141 (k) and the transmission selection switchover circuit SWT141 (k) have a forward connection mode and a backward connection mode so as a switchover mode.

<Forward Connection Mode>

When the display drive device D501 (k) shown in FIG. 13 is in the forward connection mode, the reception selection switchover circuit SWR141 (k) corresponds the receiving circuit unit RX111 (k) to the input/output unit Z1 (k). Thus, receiving circuits RX111 (k, 1) to RX111 (k, n) are correspondingly connected to the input/output terminals Z1 (k, 1) to Z1 (k, n) respectively based on such correspondence. In addition, the transmission selection switchover circuit SWR141 (k) corresponds the transmitting circuit unit TX111 (k) to the input/output unit Z2 (k). Thus, transmitting circuits TX111 (k, 1) to TX111 (k, n) are correspondingly connected to the input/output terminals Z2 (k, 1) to Z2 (k, n) respectively based on such correspondence.

<Backward Connection Mode>

When the display drive device D501 (k) shown in FIG. 10 is in the backward connection mode, the reception selection switchover circuit SWR141 (k) corresponds the receiving circuit unit RX111 (k) to the input/output unit Z2 (k). Thus, the receiving circuits RX111 (k, 1) to RX111 (k, n) are connected to the input/output terminals Z2 (k, 1) to Z2 (k, n), respectively based on such correspondence. In addition, the transmission selection switchover circuit SWR141 (k) corresponds the transmitting circuit unit TX111 (k) to the input/output unit Z1 (k). Thus, transmitting circuits TX111 (k, 1) to TX111 (k, n) are connected to the input/output terminals Z1 (k, 1) to Z1 (k, n) respectively based on such correspondence.

FIGS. 44 and 45 show constitution examples of the reception selection switchover circuit and the transmission selection switchover circuit. One of two input/output units is connected to the receiving circuit and the other input/output unit is connected to the transmitting circuit based on the input/output selection switchover signal.

<Cascade Connection>

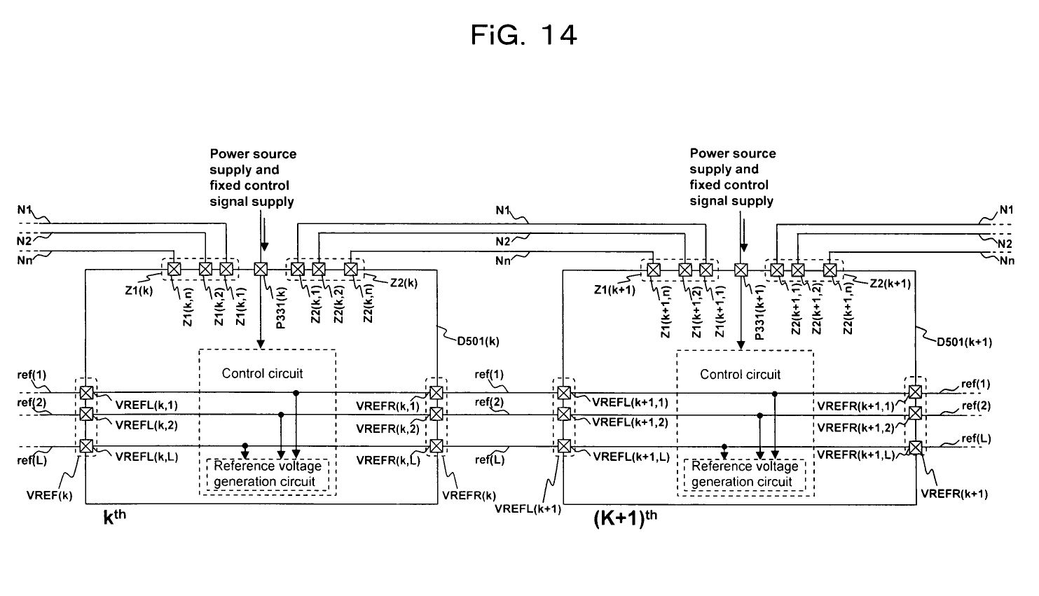

Next, a description will be given in detail to a display signal transfer device that comprises a plurality of display drive devices so as to cascade-connects them to sequentially transfer display data. As shown in FIGS. 13 and 14, in order to transfer the transfer signals N1 to Nn between the display drive device, the input/output terminals Z2 (k, 1) to Z2 (k, n) of the input/output unit Z2 (k) of the k-th display drive device D501 (k) and the input/output terminals Z1 (k+1, 1) to Z1 (k+1, n) of the input/output unit Z1 (k+1) of the (k+1)th display drive device D501 (k+1) are connected through wiring. In the (k+2)th display drive device also, the cascade connection is sequentially implemented in input/output units Z1 (k+2) and Z2 (k+2) similarly, whereby the subsequent display signal transfer device is constituted.

<Operation>

<Forward Connection Mode>

In the forward connection mode, in the display signal transfer device where the transfer signal is transferred along the direction from the first-stage first display drive device to the last-stage M-th display drive device, the transfer signals N1 to Nn transmitted from the previous stage are inputted to the input/output terminals Z1 (k, 1) to Z1 (k, n) of the input/output unit Z1 (k) of the k-th display drive device D501 (k) respectively and then received by the receiving circuits RX111 (k, 1) to RX111 (k, n) of the receiving circuit unit RX111 (k). At this time, the reception selection switchover circuit unit SWR141 (k) corresponds the receiving circuit unit RX111 (k) to the input/output unit Z1 (k).

The received transfer signals N1 to Nn are sent to the control circuit C220 (k) in which a latch processing of the display data and a control treatment of the control signal based on clocks. In order to transfer them to the (k+1) th display drive device D501 (k+1), the control circuit C220 (k) sends the transfer signals N1 to Nn to the transmitting circuits TX111 (k, 1) to TX111 (k, n) of the transmitting circuit unit TX111 (k) respectively. At this time, the transmission selection switchover circuit SWT141 (k) corresponds the transmitting circuit unit TX111 (k) to the input/output unit Z2 (k). The transfer signals N1 to Nn are outputted from the input/output terminals Z2 (k, 1) to Z2 (k, n) of the input/output unit Z2 (k) to the outside of the display drive device D501 (k).

The transfer signals N1 to Nn outputted from the input/output terminals Z2 (k, 1) to Z2 (k, n) of the input/output unit Z2 (k) of the display drive device D501 (k) are inputted to the input/output terminals Z1 (k+1, 1) to Z1 (k+1, n) of the input/output unit Z1 (k+1) of the (k+1)th display drive device D501 (k+1). The inputted transfer signals N1 to Nn are received by receiving circuits RX111 (k+1, 1) to RX111 (k+1, n) of the receiving circuit unit RX111 (k+1) of the display drive device D501 (k+1) respectively. At this time, the reception selection switchover circuit unit SWR141 (k+1) corresponds the receiving circuit unit TX111 (k+1) to the input/output unit Z1 (k+1).

In addition, in a period when a latch processing is carried out to the transfer signals N1 to Nn that is treated in the k-th display drive device D501 (k), the transmitting operation of the transmitting circuit unit TX111 (k) of the display drive device D501 (k) is stopped and the receiving operation of the receiving circuit unit RX111 (k+1) of the (k+1) th display drive device D501 (k+1) is stopped so that the transfer signals N1 to Nn are not transmitted to the display drive devices on and after (k+1)th.

Then, in a period immediately before the latching process of the transfer signals N1 to Nn is completed in the k-th display drive device D501 (k), the transmission of the transmitting circuit unit TX111 (k) is activated. In a period immediately before the latching operation is started in the (k+1)th display drive device D501 (k+1), the receiving operation of the receiving circuit unit RX111 (k+1) of the (k+1)th display drive device D501 (k+1) is activated.

In a period when the latching process of the transfer signal is carried out in the (k+1)th display drive device D501 (k+1), the transmitting operation of the transmitting circuit unit TX111 (k) of the display drive device D501 (k) is activated and the receiving operation of the receiving circuit unit RX111 (k+1) of the (k+1) th display drive device D501 (k+1) is activated so that the signal is transmitted in the display drive device preceding the (k+1)th display drive device.

Thus, in a period after the latching process of the transfer signals in the (k+1)th display drive device D501 (k+1) is completed, the receiving circuit unit RX111 (k+1) is stopped and in conjunction with it, the transmitting circuit unit TX111 (k) of the k-th display drive device D501 (k) is stopped. Thus, the signal is sequentially transmitted in the sequent display drive devices in a similar manner as described above.

Furthermore, the operations of the receiving circuit and the transmitting circuit arranged on at least one path wherein the clock signal and the control signal that is common to the display drive device are transmitted, are constantly activated, and the operations of the receiving circuit and the transmitting circuit arranged on a path involving the transfer of the signal other than the above signals are all stopped. Furthermore, in the last-stage M-th display drive device, the transmitting operation of the transmitting circuit TX112 (M) is constantly stopped.

The transmitting circuit in which the signal transfer is stopped is in a high-impedance output state or a fixed signal transmitting state. More specifically, while the signal transfer is stopped, For example, the single-end signals Vin1 and Vin2 are separated in the constitution shown in FIG. 41, and the high-impedance output state is provided by the enable signal in the constitution shown in FIG. 42, and the signal-end signal Vout becomes a fixed signal based on the control signal in the constitution shown in FIG. 43.

<Backward Connection Mode>

In the backward connection mode, the signal is transferred in the direction opposite to that in the forward connection mode. In the display signal transfer device in which the transfer signal is transferred along the direction from the first stage of the display signal transfer device in M-th display drive device to the last stage of the display signal transfer device in the first display drive device, the transfer signals N1 to Nn are inputted to the input/output terminals Z2 (k+1, 1) to Z2 (k+1, n) of the input/output unit Z2 (k+1) of the (k+1) th display drive device D501 (k+1) respectively and then received by the receiving circuits RX111 (k+1, 1) to RX111 (k+1, n) of the receiving circuit unit RX111 (k+1). At this time, the reception selection switchover circuit SWR141 (k+1) connects the receiving circuit unit RX111 (k+1) to the input/output unit Z2 (k+1).

The received transfer signals N1 to Nn are sent to the control circuit C220 (k+1) in which the latch processing of the display data and the control treatment of the control signal controls are carried out based on clocks. In order to transfer the transfer signals N1 to Nn to the k-th display drive device D501 (k), the control circuit C220 (k+1) sends the transfer signals N1 to Nn to the transmitting circuits TX111 (k+1, 1) to TX111 (k+1, n) of the transmitting circuit unit TX111 (k+1) respectively. At this time, the transmission selection switchover circuit unit SWT141 (k+1) corresponds the transmitting circuit unit TX111 (k+1) to the input/output unit Z1 (k+1). The transfer signals N1 to Nn are outputted from the input/output terminals Z1 (k+1, 1) to Z1 (k+1, n) of the output unit Z1 (k+1) to the outside of the display drive device D501 (k+1).

The transfer signals N1 to Nn outputted from the input/output terminals Z1 (k+1, 1) to Z1 (k+1, n) of the input/output unit Z1 (k+1) of the display drive device D501 (k+1) are inputted to the input/output terminals Z2 (k, 1) to Z2 (k, n) of the input/output unit Z2 (k) of the k-th display drive device D501 (k) respectively. The inputted transfer signals N1 to Nn are received by receiving circuits RX111 (k, 1) to RX111 (k, n) of the receiving circuit unit RX111 (k) of the display drive device D501 (k) respectively.

At this time, the reception selection switchover circuit unit SWR141 (k) corresponds the receiving circuit unit TX111 (k) to the input/output unit Z2 (k).

In addition, when the transfer signals N1 to Nn are latched in the (k+1)th display drive device D501 (k+1), the transmitting circuit unit TX111 (k+1) of the display drive device D501 (k+1) is stopped and the receiving circuit unit RX111 (k) of the k-th display drive device D501 (k) is stopped so that the transfer signals N1 to Nn are not transmitted to the k-th and sequent display drive devices.

Then, in a period immediately before the latching process of the transfer signals is completed in the (k+1) th display drive device D501 (k+1), the transmitting operation of the transmitting circuit unit TX111 (k+1) is activated and in a period immediately before the latching operation is started in the k-th display drive device D501 (k), the receiving operation of the receiving circuit unit RX111 (k) of the k-th display drive device D501 (k) is activated.

While the transfer signal is latch-processed in the k-th display drive device D501 (k), the transmitting operation of the transmitting circuit unit TX111 (k+1) of the display drive device D501 (k+1) is activated and the receiving operation of the receiving circuit unit RX111 (k) of the k-th display drive device D501 (k) is activated so that the transfer signals N1 to Nn are transmitted to the display drive device preceding the k-th display drive device. Thus, in a period after the latching process of the transfer signals N1 to Nn are completed in the k-th display drive device D501 (k), the receiving operation of the receiving circuit unit RX111 (k) is stopped and in synchronization with it, the transmitting operation of the transmitting circuit unit TX111 (k+1) of the (k+1)th display drive device D501 (k+1) is stopped. Thus, the transfer signals N1 to Nn are transmitted in the sequent display drive devices in a similar manner as described above.

Furthermore, the operations of the receiving circuit and the transmitting circuit provided on at least one path through which the clock signal or the control signal, that is common to the display drive device, are transmitted, are constantly activated, and the receiving circuit and the transmitting circuit involving the transfer of the signal other than the above signals are all stopped. Furthermore, in the last-stage first display drive device, the transmitting operation of the transmitting circuit TX111 (1) is constantly stopped.

The transmitting circuit in which the signal transfer is stopped is in a high-impedance output state or a fixed signal transmitting state. Specifically, in a period of the signal transfer termination, for example, the single-end signals Vin1 and Vin2 are separated in a constitution shown in FIG. 41, and the high-impedance output state is provided by the enable signal in a constitution shown in FIG. 42, and the signal-end signal Vout is made to be a fixed signal based on the control signal in a constitution shown in FIG. 43.

<Effect>

As described above, according to the display drive device and the display signal transfer device in this embodiment, since connections between the two input/output units, and transmitting circuit and the receiving circuit can be changed in accordance with the signal transfer direction by using the reception selection switchover circuit and the transmission selection switchover circuit, the area of the receiving circuit and the transmitting circuit can be reduced by half. As a result, the cost is lowered, and the power consumption is also reduced.

Furthermore, similar to the above embodiments, the display signal transfer device can be more effectively controlled and the power consumption can be reduced through being constituted as follows.

constantly stopping the transmitting operation of the last-stage transmitting circuit in the display signal transfer device,

transmitting the transfer signal through the transmitting circuit with the function to stop the operation for transmitting the transfer signal to the next-stage and sequent display drive devices,

receiving the signal through the receiving circuit with the function to stop the operation for receiving the transfer signal in the relevant display drive device,

controlling the function to stop all of the circuits constituting the display drive device based on the control signal, and

transferring the clock signal and the like common to each display drive device from the first stage to the last stage constantly.

Furthermore, by arranging the input unit, the output unit, the terminals constituting the input unit and the output unit, and the power source unit at the above-described positions, a plurality of transfer signal wirings that cascade-connect the plurality of display drive devices can be connected to each other without being crossed. Similarly, the power source unit and the power source supplying wirings can be connected without intersecting with the transfer signal wirings. As a result, the plurality of transfer signal wirings and the power source supplying wirings can be arranged in a single-layer state instead of a multilayer state. Thus, according to this embodiment, the display signal transfer device comprising the display drive devices having the above-described terminal arrangements can be provided at low cost. It is preferable that the third embodiment is implemented in the constitution that requires reduction in setting area, power consumption and mounting cost more than the above-described embodiments.

### Fourth Embodiment

<Constitution>

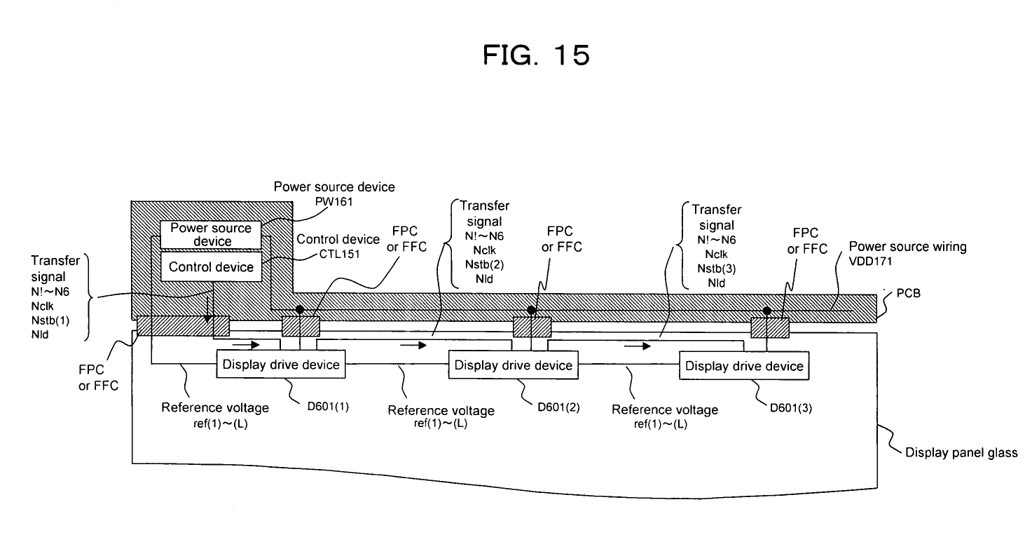

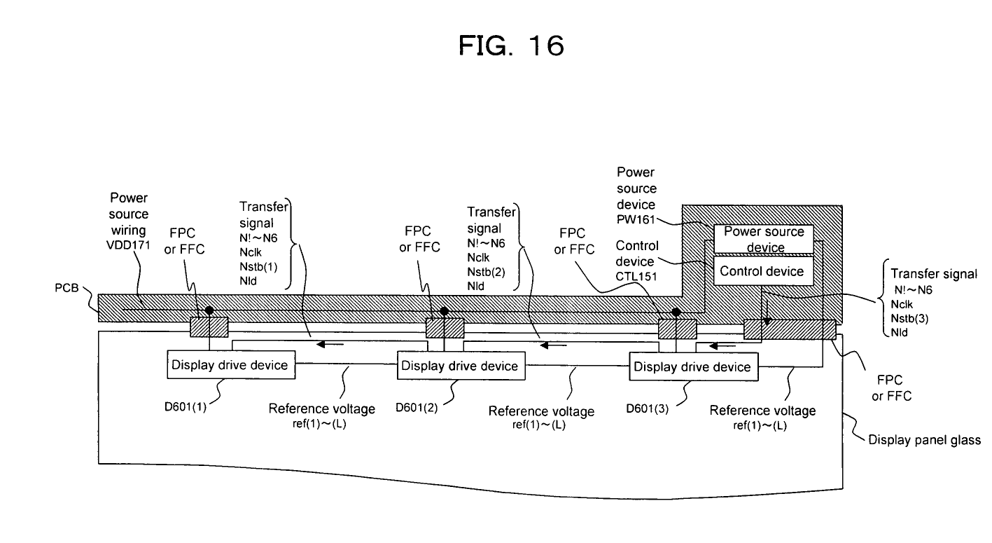

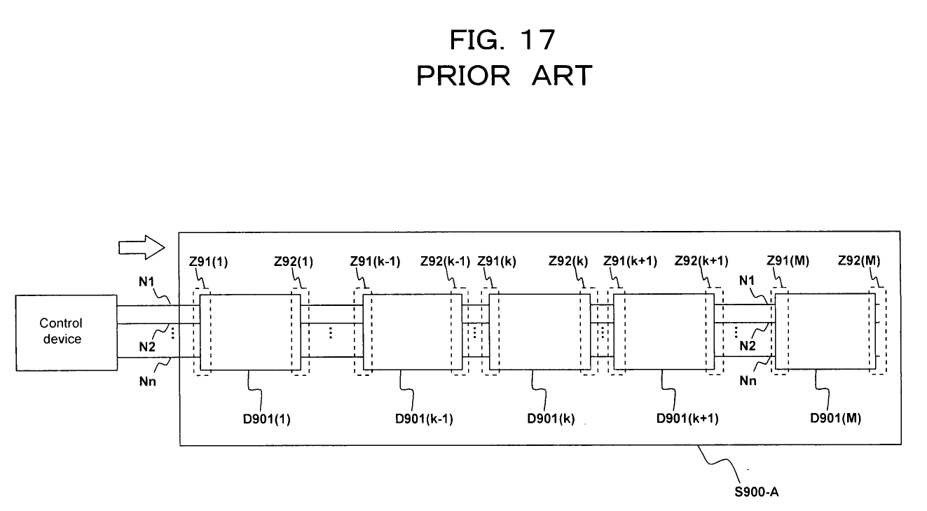

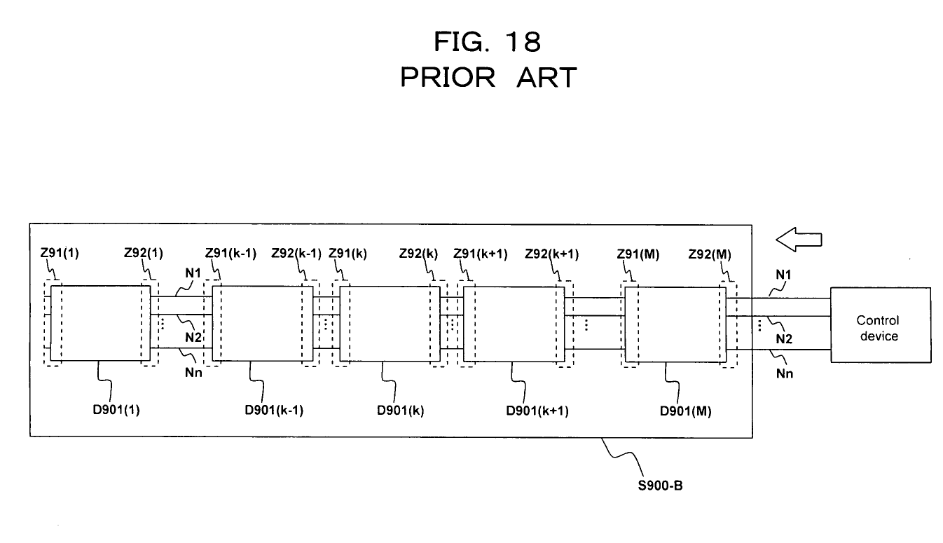

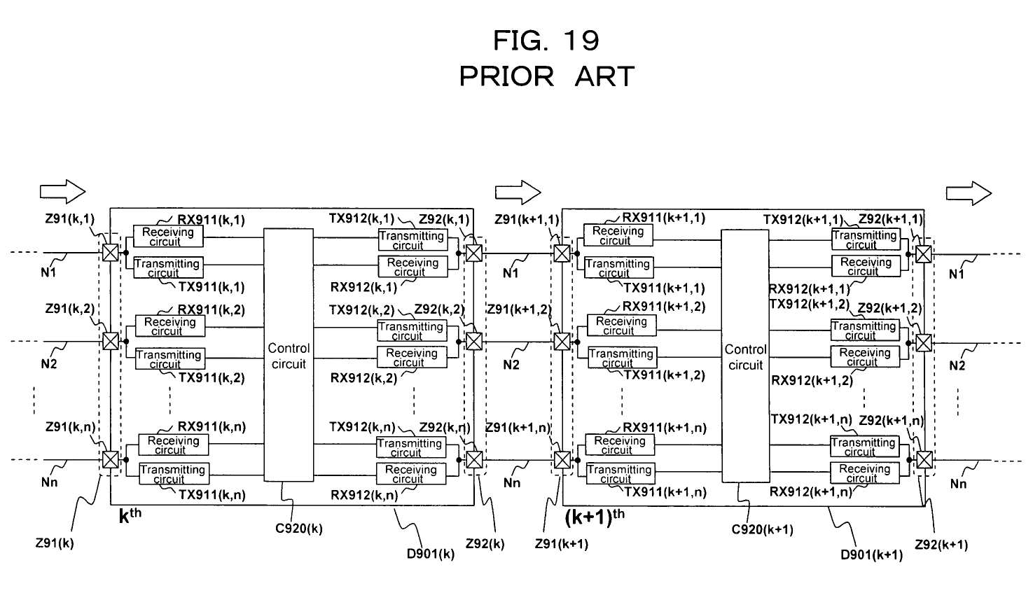

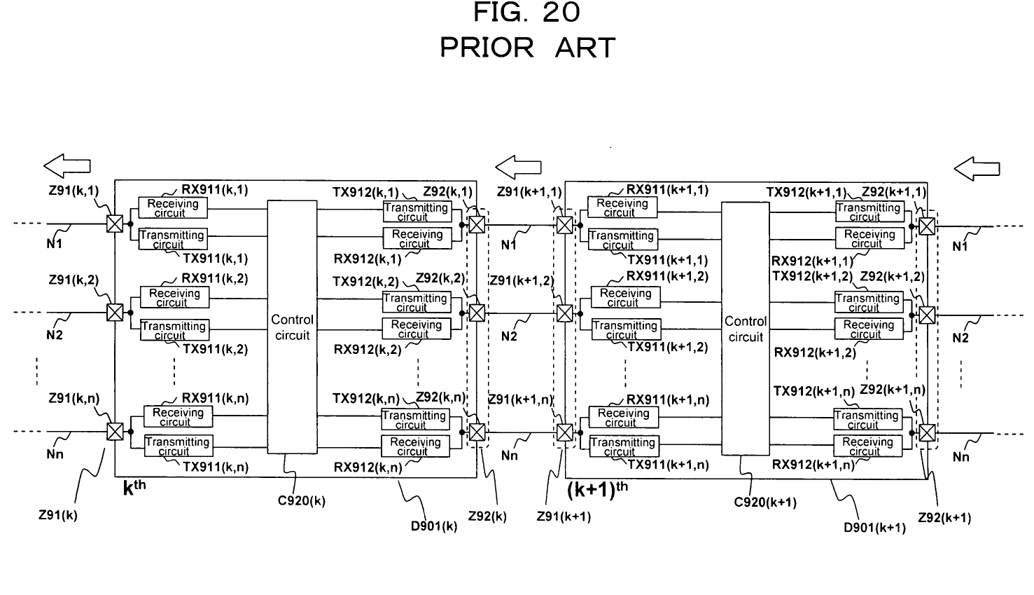

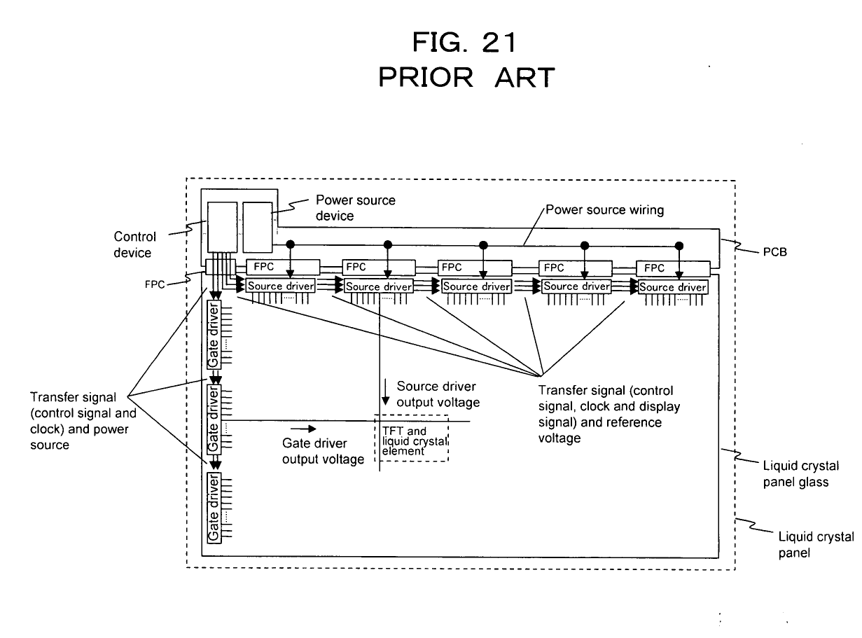

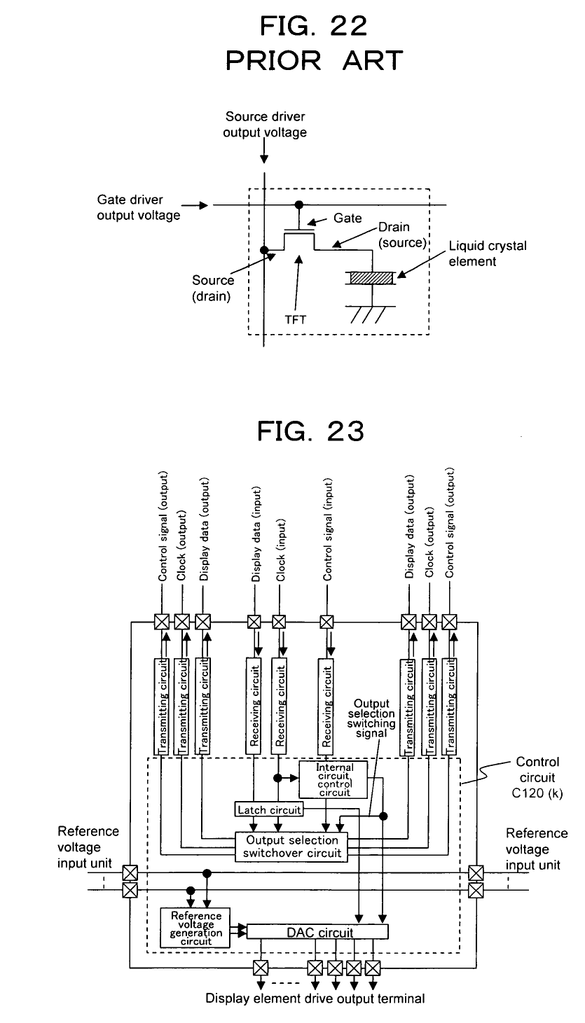

FIGS. 15 and 16 show the constitution examples of the display device according to a fourth embodiment. According to this embodiment, three display drive devices outputting an electrical signal for driving a display element are provided. According to the transfer direction of the transfer signals, the direction from the display drive device D601 (1) to the display drive device D601 (3) is set as the forward direction and its connection mode when the transfer signals are transferred along this direction is set as a forward connection mode. Meanwhile, the direction from the display drive device D601 (3) to the display drive device D601 (1) is set as the backward direction and its connection mode when the transfer signals are transferred along this direction is set as a backward connection mode.

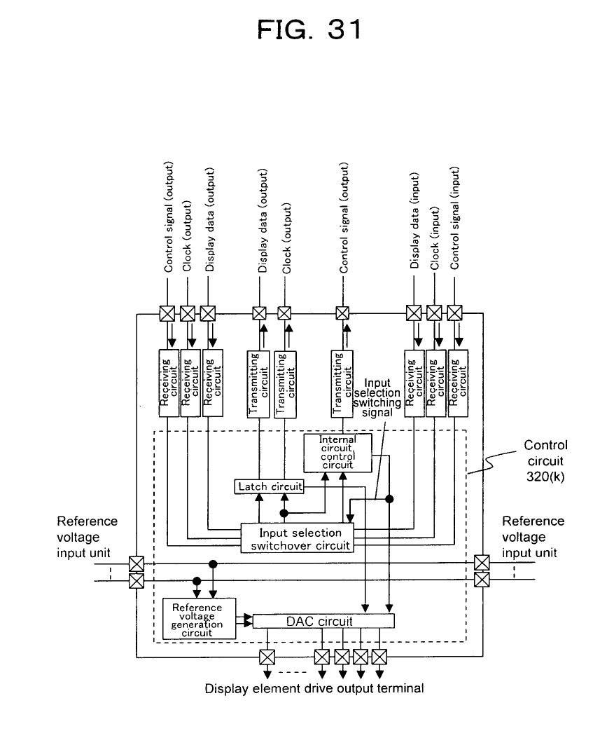

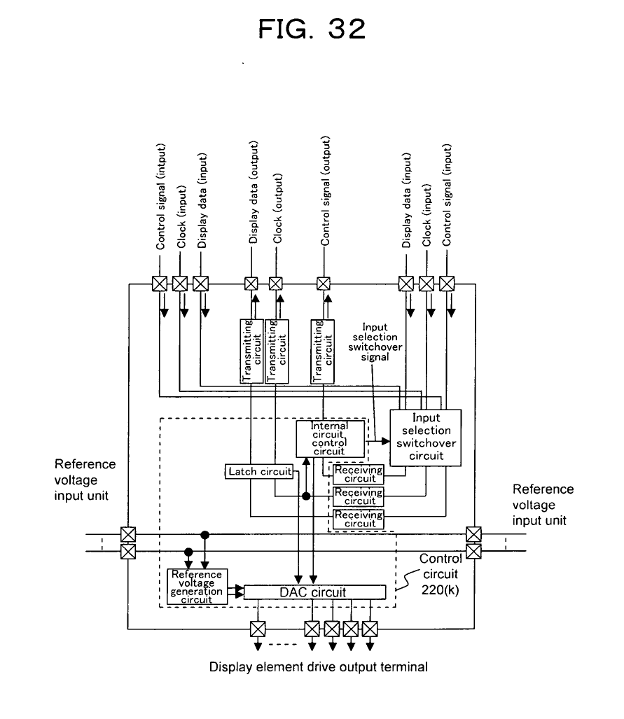

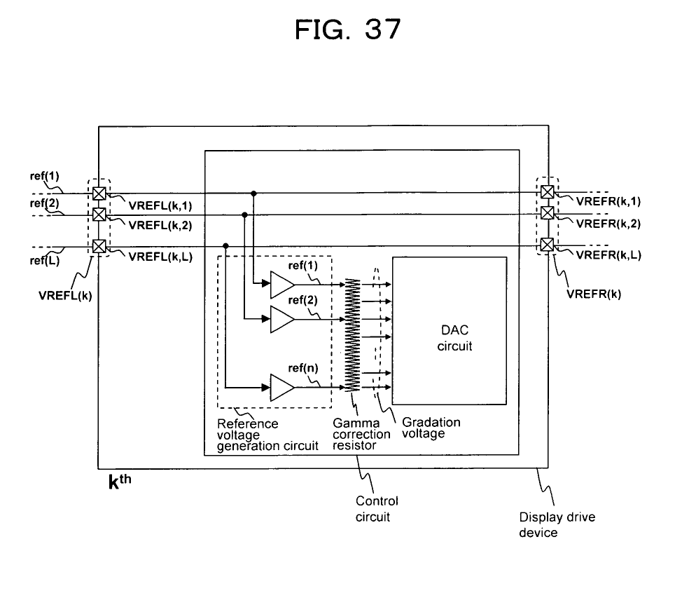

FIG. 15 is a view showing one example in the forward connection mode and FIG. 16 is a view showing one example in the backward connection mode. The display drive devices D601 (1) to D601 (3) correspond to any of the display drive devices D101 (k) to D501 (k), D701 (k), or D801 (k). The display drive devices D601 (1) to D601 (3) are shown in FIGS. 1 to 7, 46 and 47. FIGS. 23, 24, 31 and 32 show constitution examples of the control circuit including a reference voltage generation circuit in the display drive devices D101 to D501 or D701 (k) or D801 (k). FIG. 37 shows the constitution example of the reference voltage generation circuit. The reference voltage generation circuit generates a gradation voltage to be applied to the display element (liquid crystal element and the like) that is driven based on an impressed voltage signal.

The display device according to this embodiment comprises a display signal transfer device. The display signal transfer device comprises a plurality of display drive devices D101 (k) to D501 (k), D701 (k), and D801 (k). The display drive devices D101 (k) to D501 (k), D701 (k), and D801 (k) are provided on a panel glass of the display device having a plurality of pixels. The display drive devices D101 (k) to D501 (k), D701 (k), and D801 (k) are cascade-connected to each other. The number of the display drive devices D101 (k) to D501 (k), D701 (k), and D801 (k) is determined in accordance with the resolution of the display device.

The display device comprises a control device CTL151. The control device CTL151, for example, comprises a control LSI of the display device. Transfer signals N1 to Nn are inputted to the control device CTL151. The control device CTL151 transfers the inputted transfer signals N1 to Nn. The control device CTL151 is connected to the display drive device D601 (1) in the forward connection mode and connected to the display drive device D601 (3) in the backward connection mode. For example, display data, a clock and a control signal are inputted to the control device CTL151 as the transfer signals N1 to Nn. The display data is an electric signal to be applied to a display element that constitutes each pixel of the display device, the clock is a signal used when a latching process or a control process is performed in the control circuit of the display drive device, and the control signal is a signal for executing a processing when the latch-processed display data is outputted to the display element and the like. Here, the control circuit described here corresponds to the control circuits C120 to C320 (k) in each of the aforementioned embodiments. The power supply to the control circuit carried out, for example, with a power source unit and a fixed control signal supplying unit. The fixed control signal described here is a control signal used when the transfer signal direction and the like is determined in the cascade connection. In addition, the fixed control signal supplying unit described here corresponds to the power source units P131 (k) to P331 (k) in each of the aforementioned embodiments.

In the constitution examples shown in FIGS. 15 and 16, the power source is supplied to the display drive device and the like as follows. That is, the power source is transmitted from a power source device PZ9161 to a power source wiring VDD171 formed on a circuit board (PCB) and transmitted between the printed circuit board and the display panel glass through a flexible printed circuit (FPC) or a flexible flat cable (FFC) so as to be supplied to the display drive device. In addition, the power source may be supplied to the display drive device and the like through the FPC and the FFC only without using the PCB, or the power source may be supplied to the display drive device and the like by combining the FPC and FFC.

Furthermore, as shown in FIGS. 5, 6, 11, 12 and 14, the input terminal, output terminal and power source unit for the transfer signals N1 to Nn are arranged on one side in the periphery of the display drive device and a reference voltage input unit Vref (k) of the reference voltage generation circuit is arranged on the other side (for example, both sides that intersect with the side on which the input terminal and the output terminal are arranged, or one of them). In addition, the reference voltage generation circuit is a circuit that generates a reference voltage to drive the display element electrically. The L pieces of reference voltage input terminals Vref (k, 1) to Vref (k, L) (L is a positive integer satisfying that L≧2) of the reference voltage input unit Vref (k) are connected without intersecting with each other in the different display drive devices.

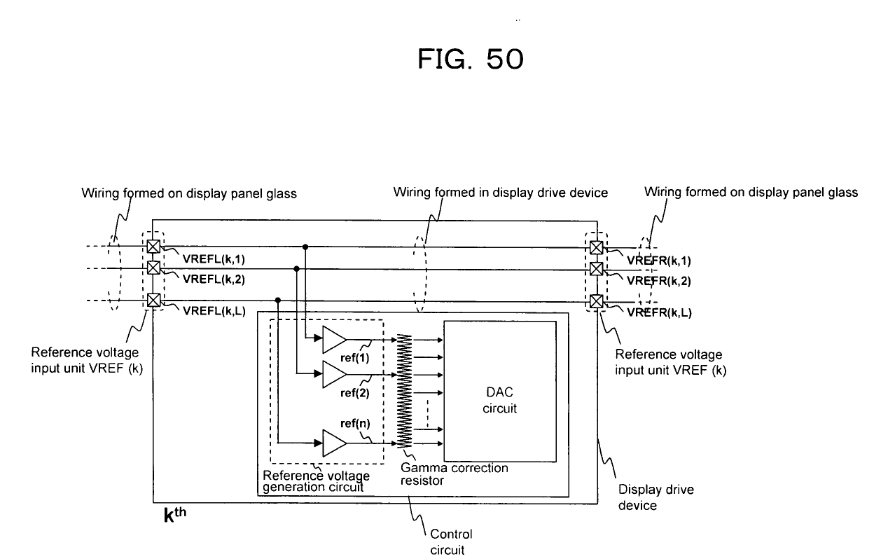

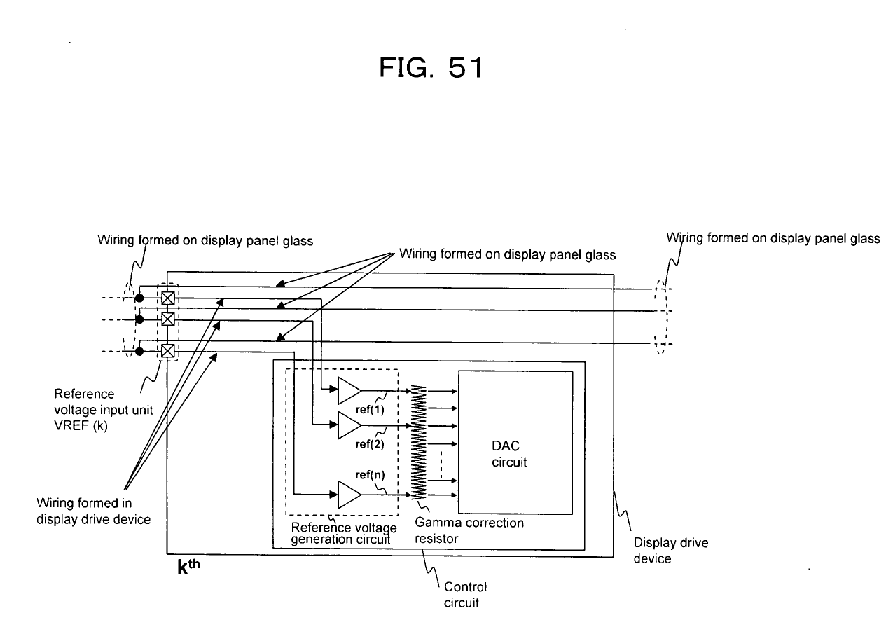

One end of the reference voltage input unit Vref (k) in the first-stage display drive device is connected to the power device PZ9161. In addition, the other end of the reference voltage input unit Vref (k) is cascade-connected to the reference voltage input unit of each of the display drive device so as not to intersect with other wirings. FIGS. 50 and 51 show the connection examples of the reference voltage input unit of the display drive device. FIG. 50 shows the constitution example in which the reference voltage input unit is provided respectively on an other side that intersects with the side on which the input terminal and the output terminal are arranged, and the side opposed to the other side, and these reference voltage input units are cascade-connected. FIG. 51 shows the constitution example in which the reference voltage input unit is provided on one of the side that intersects with the side on which the input terminal and the output terminal are arranged, and the side opposed to the relevant other side so as to connect this reference voltage input unit to each other.

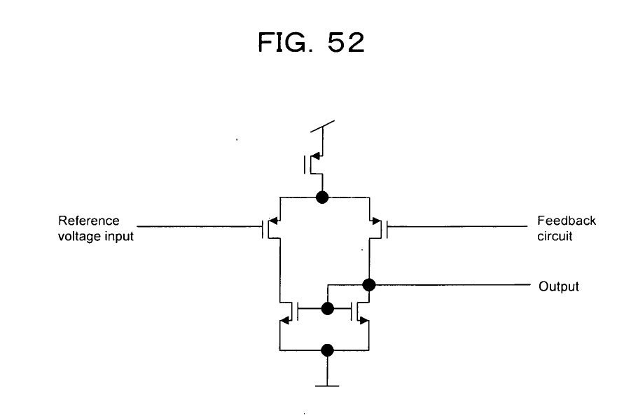

As shown in FIG. 52, when the input constitution of the reference voltage generation circuit is like the constitution of a differential amplifier circuit, a current does not flow to the gate of a transistor that becomes the input unit of the reference voltage generation circuit. Therefore, voltage does not drop at the wiring of the reference voltage and even when the wiring of the reference voltage input unit shown in FIG. 51 is formed on the panel glass outside the display drive device and sequentially connected, the reference voltage can be commonly supplied to the plurality of display drive devices. Thus, since it is not necessary to arrange the wiring of the reference voltage in the display drive device, the display drive device can be constituted compactly. In this case, it is desirable that the display drive device is constituted in the atmosphere in which the wiring for supplying the reference voltage is not likely to be affected by a noise (electric influence) from the outside.

The voltage device PZ9161 that is the voltage supply source of the reference voltage input unit Vref (k) of the first-stage display drive device is connected to the display drive device D601 (1) in the forward connection mode or connected to the display drive device D601 (3) in the backward connection mode.

<Operation>

Next, the operation in the display device shown in FIGS. 15 and 16 will be described. Here, the description will be given to a case where the transfer signal comprises display data N1 to N6, a clock Nclk, an output control signal to a display element Nstb, and latch process control signals Nsta (1) to (3), and the reference voltage is made to be reference voltages ref (1) to (L). In addition, the latch process control signal Nsta (1) is the signal inputted to the display drive device D601 (1) and the latch process control signal Nsta (2) is the signal inputted to the display drive device 601 (2) and the latch process control signal Nsta (3) is the signal inputted to the display drive device 601 (3).

<Forward Connection Mode>

A description will be made of the operation of the display device having the display signal transfer device shown in FIG. 15 in the forward connection mode. The display device in the forward connection mode comprises the display signal transfer device in which the transfer signals are transferred along a direction from the first (first-stage) display drive device D601 (1) to the third (last-stage) display drive device D601 (3). The control device CTL151 supplies the display data N1 to N6, the latch process control signal Nsta (1) and the clock Nclk to the first display drive device D601 (1). These signals are received with the display drive device D601 (1). In the control circuit of the display drive device D601 (1), the display data N1 to N6 are latch-processed according to the latch process control signal Nsta (1). The latching process is performed based on the clock Nclk. In synchronization with the period when the latching process in the display drive device D601 (1) is completed, the transfer circuit of the display drive device D601 (1) transfers the latching process control signal Nsta (2) and the display data N1 to N6 to the display drive device D601 (2).

Similar to the display drive device D601 (1), in the control circuit in the display drive device D601 (2), the display data N1 to N6 are latch-processed according to the latch process control signal Nsta (2). In synchronization with the period when the latching process in the display drive device D601 (2) is completed, the transfer circuit of the display drive device D601 (2) transfers the latching process control signal Nsta (3) and the display data N1 to N6 to the display drive device D601 (3).

Similar to the display drive devices D601 (1) and D601 (2), in the control circuit in the display drive device D601 (3), the display data N1 to N6 are latch-processed according to the latching process control signal Nsta (3). The transmitting operation is not performed in a transmitting circuit in the last-stage display drive device D601 (3).

After lapse of the sufficient duration to perform latch processing of the display data until the last-stage display drive device D601 (3), the control device CTL 151 supplies the output control signal Nstb of the display element to the first display drive device D601 (1). The output control signal Nstb supplied to the display drive device D601 (1) is sequentially transferred through the display drive device D601 (1) to D601 (3) in this order.

In conjunction with the output control signal Nstb, an electric signal corresponding to the display data latch-processed in each of the display drive devices D601 (1) to D601 (3) is applied to the display element and then the display operation is performed in the display device. More specifically, in synchronization with the output control signal Nstb, the latch-processed display data is sent to a plurality of DAC circuits. The DAC circuit outputs a gradation voltage corresponding to the display data to the display element through the plurality of display element drive output terminals of the display drive device to drive the display element. The electric signal of the gradation voltage is generated as follows. Based on the reference voltages ref (1) to (L) generated in the reference voltage generation circuit, gamma correction resistance generates the plurality of gradation voltages and supplies them to the DAC circuit. The DAC circuit selects the graduation voltage corresponding to the display data among the plurality of supplied graduation voltages and outputs it to the display element. The reference voltages ref (1) to (L) are supplied from the voltage device PW601 to the reference voltage input unit Vref (1) of the display drive device D601 (1). The reference voltages ref (1) to (L) are supplied from the display drive device D601 (1) to the display drive device D601 (2) and then supplied from the display drive device D601 (2) to the display drive device D601 (3).

Furthermore, the operations of the receiving circuit and the transmitting circuit arranged on at least one path through which the clock signal and the control signal common to the display drive device are constantly activated, and the receiving circuit, the transmitting circuit and the control circuit, that are arranged on the paths involving the transfer of the signal other than the above signals, are all stopped.

<Backward Connection Mode>

When the operation mode is the backward connection mode as shown in FIG. 16, the signal is transferred in the direction opposite to the direction in the forward connection mode. That is, the display device in the backward connection mode comprises the display signal transfer device in which the transfer signals are transferred along the direction from the third (first-stage) display drive device D601 (3) to the first (last-stage) display drive device D601 (1). The control device CTL151 supplies the display data N1 to N6, the latch-processed control signal Nsta (3) and the clock Nclk to the third display drive device D601 (3). These signals are received with the display drive device D601 (3). In the control circuit of the display drive device D601 (3), the display data N1 to N6 are latch-processed according to the latch-processed control signal Nsta (3). The latching process is performed based on the clock Nclk. In synchronization with the period when the latching process in the display drive device D601 (3) is completed, the display drive device D601 (3) transfers the latching process control signal Nsta (2) and the display data N1 to N6 to the display drive device D601 (2).

Similar to the display drive device D601 (3), in the control circuit of the display drive device D601 (2), the display data N1 to N6 are latch-processed according to the latch process control signal Nsta (2). In synchronization with the period when the latching process in the display drive device D601 (2) is completed, the transmitting circuit of the display drive device D601 (2) transfers the latching process control signal Nsta (1) and the display data N1 to N6 to the display drive device D601 (1).

Similar to the display drive devices D601 (3) and D601 (2), in the control circuit of the display drive device D601 (1), the display data N1 to N6 are latch-processed according to the latching process control signal Nsta (1). The transmitting operation is not performed with a transmitting circuit in the last-stage display drive device D601 (1).

After lapse of the sufficient duration for latch-processing the display data until the last-stage display drive device D601 (1), the control device CTL 151 supplies the output control signal Nstb of the display element to the third display drive device D601 (3). The output control signal Nstb supplied to the display drive device D601 (3) is transferred through the display drive device D601 (3) to D601 (1) in this order.

Similar to the operation of the control circuit in each of the display drive devices in the forward connection mode, in conjunction with the output control signal Nstb, an electric signal corresponding to the display data latch-processed in each of the display drive devices D601 (1) to D601 (3) is applied to the display element and thereby the display operation is performed in the display device. More specifically, after the reference voltages ref (1) to (L) has been supplied from the voltage device PW601 to the reference voltage input unit Vref (3) of the display drive device D601 (3), the reference voltages ref (1) to (L) are supplied from the display drive device D601 (3) to the display drive device D601 (2) and further supplied from the display drive device D601 (2) to the display drive device D601 (1).

Although the display signal transfer device comprises three display drive devices is described in FIGS. 15 and 16, this embodiment can be similarly implemented in the display device constituted with the display signal transfer device comprises two or, four or more display drive devices. In addition, although the six display data from N1 to N6 are transferred to the plurality of display drive devices here, in this case, the number of terminals for transmission in the previous-stage display drive device and the number of the terminals for reception in the next-stage display drive device may not be the same. Furthermore, although the direction of the transfer signal from the control device and the direction to supply the reference voltage are the same here, it is no problem that the transfer signal is in the forward connection mode and the reference voltage supplied direction is in the backward connection mode, and vice versa.

<Effect>

As described above, the display signal transfer device of the display device according to this embodiment comprises the display drive device in which the area of the receiving circuit and the transmitting circuit is reduced more than the conventional one. Therefore, the power consumption can be reduced and the setting area of the display drive device can be also reduced. Furthermore, since the connection wiring such as the transfer signal wiring and the power source unit supplying wiring in each of the display drive device and the wiring of the reference voltage input unit wiring can be made a single layer, the display device can be provided at low cost.

In addition, even when the device specification is changed from the circuit constitution in FIG. 15 to the circuit constitution in FIG. 16, it is not necessary to change the display drive device. Therefore, while the power consumption and cost are reduced, the same bidirectional signal transfer as the conventional example can be realized.

Although the most preferred embodiments of the present invention have been described in detail, the combination and arrangement of the components in the preferred embodiments may be variously varied without departing from the spirit and scope of the present invention claimed below.

What is claimed is:

1. A display drive device comprising:
an input unit to which one or plural first signals involving display are inputted from the outside;
a receiving circuit for receiving the first signal from the input unit;
first and second output units for outputting one or plural second signals relevant to the first signal;
a first transmitting circuit for transmitting the second signal from the first output unit; and
a second transmitting circuit for transmitting the second signal from the second output unit.

2. The display drive device according to claim 1, further comprising a control circuit, wherein
the control circuit outputs the second signal from the first output unit, and at the same time stops the transmitting operation of the second transmitting circuit and then puts the output state of the second transmitting circuit into the fixed signal output state or a high-impedance output state, or the control circuit outputs the second signal from the second output unit, and at the same time stops the transmitting operation of the first transmitting circuit and then puts the output state of the first transmitting circuit into the fixed signal output state or the high-impedance output state

3. The display drive device according to claim 1, wherein
the input unit and the first and second output units are provided in the periphery of the display drive device,
the input unit is provided between the first output unit and the second output unit, and
the physical distance between the first output unit and the second output unit is larger than the physical distance between the input unit and the first output unit and the physical distance between the input unit and the second output unit.

4. The display drive device according to claim 3, wherein
the input unit comprises a plurality of input terminals,
the first output unit comprises a plurality of first output terminals,
the second output unit comprises a plurality of second output terminals, wherein
the input terminals and the first output terminals and the second output terminals are arranged respectively along the periphery of the display drive device, and
the arrangement order of the input terminals and the arrangement order of the first and second output terminals are opposed to each other.

5. The display drive device according to claim 3, wherein
a first power source unit for supplying a power source to the display drive device is provided between the input unit and the first output unit, and
a second power source unit for supplying a power source to the display drive device is provided between the input unit and the second output unit.

6. A display drive device comprising:
an input unit to which one or plural first signals involving display are inputted from the outside;
a receiving circuit for receiving the first signal with the input unit;
first and second output units for outputting one or plural second signals relevant to the first signal in parallel to each other;
a transmitting circuit for transmitting the second signal from the first output unit or the second output unit; and
an output selection switchover circuit for connecting one of the first output unit and the second output unit to the transmitting circuit.

7. The display drive device according to claim 6, wherein
the input unit and the first and second output units are provided in the periphery of the display drive device,
the input unit is provided between the first output unit and the second output unit,
the physical distance between the first output unit and the second output unit is larger than the physical distance between the input unit and the first output unit and the physical distance between the input unit and the second output unit.

8. The display drive device according to claim 7, wherein
the input unit comprises a plurality of input terminals,
the first output unit comprises a plurality of first output terminals,
the second output unit comprises a plurality of second output terminals,
the input terminals and the first output terminals and the second output terminals are arranged respectively along the periphery of the display drive device, and
the arrangement order of the input terminals and the arrangement order of the first and second output terminals are opposed to each other.

9. The display drive device according to claim 7, wherein
a first power source unit for supplying a power source to the display drive device is provided between the input unit and the first output unit, and
a second power source unit for supplying a power source to the display drive device is provided between the input unit and the second output unit.

10. A display drive device comprising:
a first input/output unit through which one or plural first signals involving display are inputted or outputted between the input/output unit and the outside;
a second input/output unit through which the first signal is inputted or outputted between the input/output unit and the outside;
a receiving circuit for receiving the first signal with one of the first input/output unit and the second input/output unit;
a first transmitting circuit for outputting one or plural second signals relevant to the first signal from the first input/output unit;
a second transmitting circuit for outputting the second signal from the second input/output unit;
a reception selection switchover circuit for connecting one of the first input/output unit and the second input/output unit to the receiving circuit;
a first transmission selection switchover circuit for connecting the first input/output unit to the first transmitting circuit in conjunction with the connection operation of the reception selection switchover circuit; and
a second transmission selection switchover circuit for connecting the second input/output unit to the second transmitting circuit in conjunction with the connection operation of the reception selection switchover circuit.

11. The display drive device according to claim 10, wherein
a power source unit for supplying a power source to the display drive device is provided between the first input/output unit and the second input/output unit.

12. A display drive device comprising:
a first input/output unit through which one or plural first signals involving display are inputted or outputted;
a second input/output unit through which the first signal is inputted or outputted;
a receiving circuit for receiving the first signal with one of the first input/output unit and the second input/output unit;
a transmitting circuit for outputting one or plural second signals relevant to the first signal from the other of the first input/output unit and the second input/output unit;
a reception selection switchover circuit for connecting one of the first input/output unit and the second input/output unit to the receiving circuit; and
a transmission selection switchover circuit for connecting the other of the first input/output unit and the second input/output unit to the transmitting circuit in synchronization with the connection operation of the reception selection switchover circuit.

13. The display drive device according to claim 12, wherein
a power source unit for supplying a power source to the display drive device is provided between the first input/output unit and the second input/output unit.

14. A display signal transfer device having a plurality of display drive devices cascade-connected to each other, wherein
each of the display drive devices comprises:
a transmitting circuit for receiving one or plural first signals involving display from the previous-stage display drive device;
a transmitting circuit for transmitting one or plural second signals relevant to the first signal to the next-stage display drive device; and
a control circuit, wherein
the control circuit performs or terminates a receiving operation of the receiving circuit in synchronization with the switching between the transmitting operation and the transmission stopping operation of the transmitting circuit, and at the same time performs or terminates a transmitting operation of the transmitting circuit in synchronization with the switchover between the receiving operation and the reception stopping operation of the transmitting circuit.

15. The display signal transfer device according to claim 14, wherein
the first signal and the second signal contain a control signal and a clock,
the control circuit of the last-stage display drive device constantly stops the transmitting operation of the transmitting circuit in the last-stage display drive device, and
the control circuit in the other display drive device except for the display drive device in which at least one of the control signal and the clock that is used in the plurality of display drive devices in common is received or transmitted, stops the receiving circuit and the transmitting circuit in the relevant other display drive device.

16. A display device comprising a plurality of pixels and displaying by impressing an electric signal relevant to display data to a display element that constitutes each pixel, wherein the display device comprising a plurality of display drive devices provided corresponding to the pixels,
the display drive device comprises an input unit to which a transfer signal containing the display data is inputted from another display drive device, an output unit for outputting the transfer signal to yet another display drive device, a power source unit for supplying a power source to the display drive device, and a reference voltage input unit to which a reference voltage that drives the display element is inputted,
the input unit and the output unit and the power source unit are provided on one side in the periphery of the display drive device, and the reference voltage input unit is provided on at least one of the first another side in the periphery different from the above one side and the second another side opposed to the first another side, and
the input unit, the output unit, the power source unit and the reference voltage input unit are cascade-connected in the same layer between the plurality of display drive devices.
